(19) United States
(12) Patent Application Publication
(10) Pub. No.: US 2026/0333102 A1
(43) Pub. Date: Oct. 22, 2026

(54) ENERGY-EFFICIENT MOBILITY IN CONNECTED MODE OPERATION

(71) Applicant: Samsung Electronics Co., Ltd., Suwon-si (KR)

(72) Inventors: Ebrahim MolavianJazi, San Jose, CA (US); Aristides Papasakellariou, Houston, TX (US); Hongbo Si, Allen, TX (US)

(21) Appl. No.: 19/578,726

(22) Filed: Mar. 25, 2026

Related U.S. Application Data
(60) Provisional application No. 63/788,397, filed on Apr. 14, 2025.

(51) Int. Cl. H04W 24/10; H04B 17/318; H04L 5/00; H04W 56/00; H04W 74/0833

(52) U.S. Cl. CPC H04W 24/10; H04B 17/328; H04L 5/0051; H04W 56/0045; H04W 74/0833

(57) ABSTRACT

Apparatuses and methods for energy-efficient mobility in connected mode operation. A method performed by a user equipment includes receiving, on a first cell, first information for on-demand reference signals (OD-RSs) on second cells, second information for determining measurements reports based on the OD-RSs, and third information for a set of trigger states corresponding to a set of measurement reports; receiving, on the first cell, a first indication for a trigger state from the set of trigger states; receiving, on the second cells, the OD-RSs after receiving the first indication. The method further includes determining, according to the second information and the trigger state, first measurement reports based on the OD-RSs; transmitting, on the first cell, a channel that includes the first measurement reports; and receiving, on the first cell, a second indication for a handover from the first cell to a second cell of the second cells.

### CROSS-REFERENCE TO RELATED AND CLAIM OF PRIORITY

The present application claims priority under 35 U.S.C. § 119 (e) to U.S. Provisional Patent Application No. 63/788,397 filed on Apr. 14, 2025, which is hereby incorporated by reference in its entirety.

### TECHNICAL FIELD

The present disclosure relates generally to wireless communication systems and, more specifically, the present disclosure is related to energy-efficient mobility in connected mode operation.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to energy-efficient mobility in connected mode operation.

In one embodiment, a method for a user equipment (UE) is provided. The method includes receiving, on a first cell, first information for on-demand reference signals (OD-RSs) on second cells, second information for determining measurements reports based on the OD-RSs, and third information for a set of trigger states corresponding to a set of measurement reports; receiving, on the first cell, a first indication for a trigger state from the set of trigger states; receiving, on the second cells, the OD-RSs after receiving the first indication. The method further includes determining, according to the second information and the trigger state, first measurement reports based on the OD-RSs; transmitting, on the first cell, a channel that includes the first measurement reports; and receiving, on the first cell, a second indication for a handover from the first cell to a second cell of the second cells.

In another embodiment, a UE is provided. The UE includes a transceiver configured to receive, on a first cell, first information for OD-RSs on second cells, second information for determining measurements reports based on the OD-RSs, and third information for a set of trigger states corresponding to a set of measurement reports; receive, on the first cell, a first indication for a trigger state from the set of trigger states; and receive, on the second cells, the OD-RSs after reception of the first indication. The UE further includes a processor operably coupled to the transceiver, the processor configured to determine, according to the second information and the trigger state, first measurement reports based on the OD-RSs. The transceiver is further configured to transmit, on the first cell, a channel that includes the first measurement reports and receive, on the first cell, a second indication for a handover from the first cell to a second cell of the second cells.

In yet another embodiment, a base station is provided. The base station includes a transceiver configured to transmit, on a first cell, first information for OD-RSs on second cells, second information for determining measurements reports based on the OD-RSs, and third information for a set of trigger states corresponding to a set of measurement reports; transmit, on the first cell, a first indication for a trigger state from the set of trigger states; transmit, on the second cells, the OD-RSs after transmission of the first indication; and receive, on the first cell from a UE, a channel that includes first measurement reports, wherein the first measurement reports are based on the OD-RSs. The base station includes a processor operably coupled to the transceiver. The processor is configured to determine, according to the second information and the trigger state, the first measurement reports. The transceiver is further configured to transmit, on the first cell, a second indication for a handover from the first cell to a second cell of the second cells.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure; and

FIG. 5 illustrates a method performed by a UE according to embodiments of the present disclosure.

### DETAILED DESCRIPTION

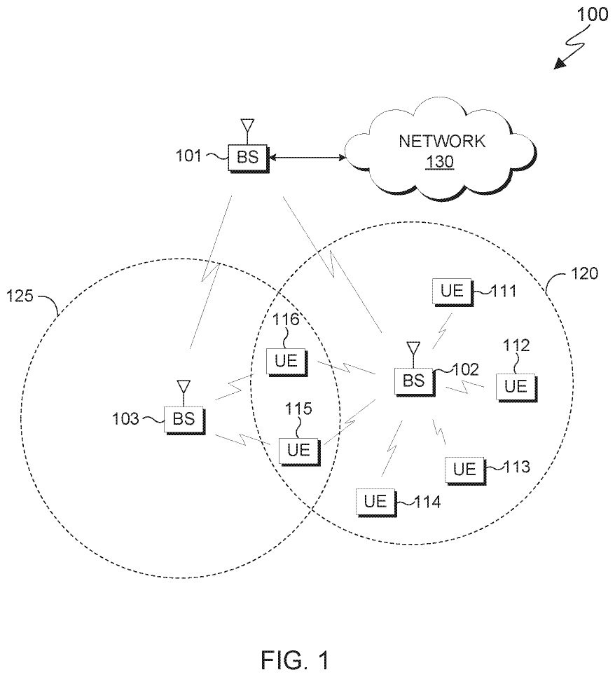

FIGS. 1-5 discussed below, and the various, non-limiting embodiments used to describe the prinCIples of the present disclosure in this patent document are by way of illustration only and should not be construed in any way to limit the scope of the disclosure. Those skilled in the art will understand that the prinCIples of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 Rel-18 v18.6.0, “NR; Physical channels and modulation” (herein, “REF 1”); 3GPP TS 38.212 Rel-18 v18.6.0, “NR; Multiplexing and channel coding” (herein, “REF 2”); 3GPP TS 38.213 Rel-18 v18.6.0, “NR; Physical layer procedures for control” (herein, “REF 3”); 3GPP TS 38.214 Rel-18 v18.6.0, “NR; Physical layer procedures for data” (herein, “REF 4”); 3GPP TS 38.215 Rel-18 v18.6.0, “NR; Physical layer measurements” (herein, “REF 5”); 3GPP TS 38.321 Rel-18 v18.5.0, “NR; Medium Access Control (MAC) protocol specification” (herein, “REF 6”); 3GPP TS 38.331 Rel-18 v18.5.0, “NR; Radio Resource Control (RRC) protocol specification” (herein, “REF 7”); 3GPP TS 38.300 Rel-18 v18.5.0, “NR; NR and NG-RAN Overall Description; Stage 2” (herein, “REF 8”); and 3GPP TS 38.304 Rel-18 v18.5.0, “NR; User Equipment (UE) procedures in Idle mode and in RRC Inactive state” (herein, “REF 9”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for supporting energy-efficient mobility in connected mode operation. In certain embodiments, one or more of the BSs 101-103 include circuitry, programing, or a combination thereof to support energy-efficient mobility in connected mode operation.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

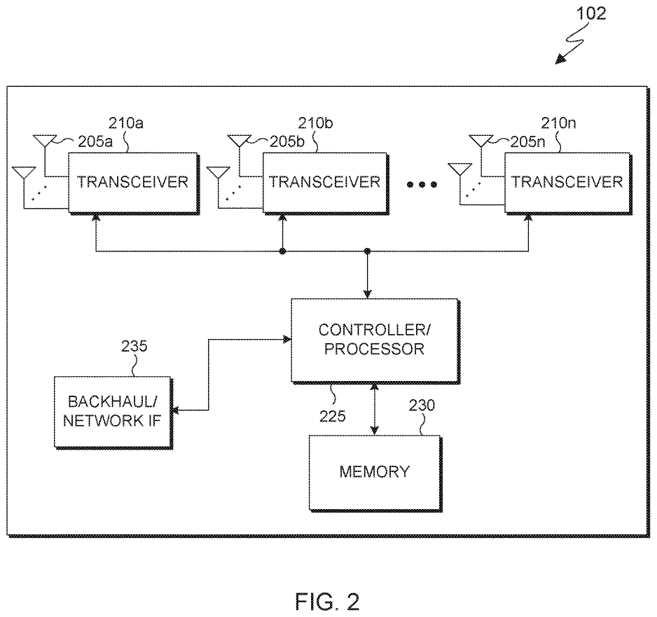

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known prinCIples. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting energy-efficient mobility in connected mode operation. Any of a wide variety of other functions could be supported in the BS 102 by the controller/processor 225.

The controller/processor 225 is also capable of executing programs and other processes resident in the memory 230, such as processes to support energy-efficient mobility in connected mode operation. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

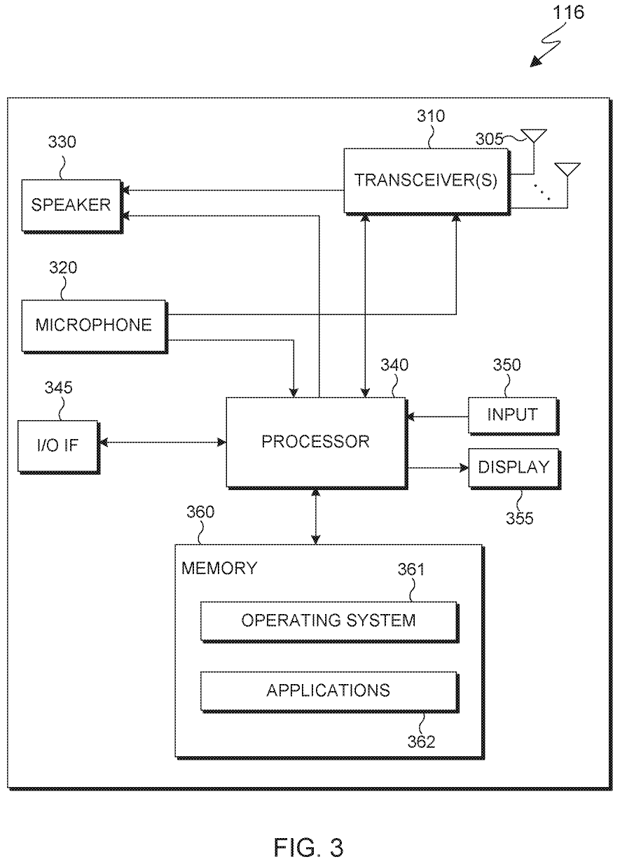

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known prinCIples. In some embodiments, the processor 340 includes at least one microprocessor or microcontroller.

The processor 340 is also capable of executing other processes and programs resident in the memory 360. For example, the processor 340 may execute processes for supporting energy-efficient mobility in connected mode operation as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

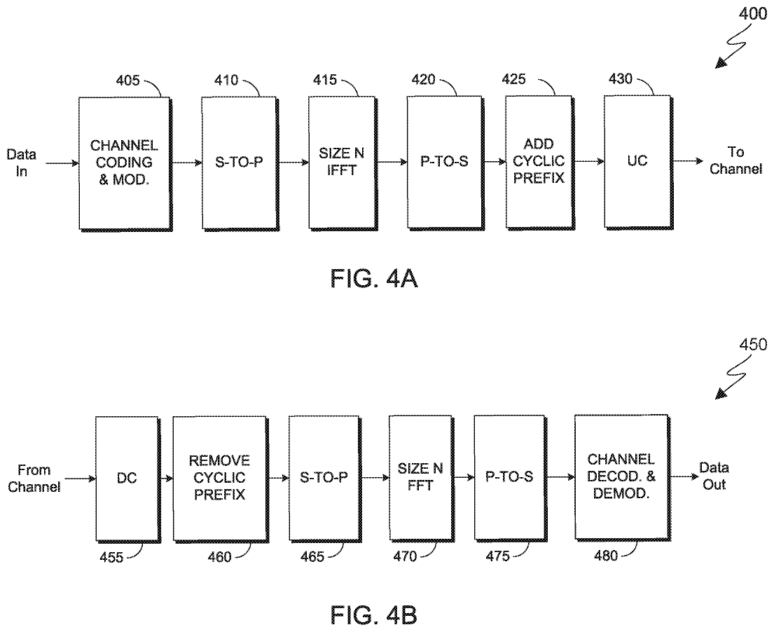

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting energy-efficient mobility in connected mode operation as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In the present disclosure, unless otherwise noted, a parameter referenced in italics is provided by higher layers such as by RRC.

As introduced above, a communication system can include a DL that refers to transmissions from a base station (such as the BS 102) or one or more transmission points to UEs (such as the UE 116) and an UL that refers to transmissions from UEs (such as the UE 116) to a base station (such as the BS 102) or to one or more reception points.

For purposes of the present disclosure, a time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For the sake of brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission prinCIple, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In some examples, the term “beam” is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

Various embodiments of the present disclosure may be implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the present disclosure, unless otherwise noted, providing a parameter value by higher layers includes providing the parameter value by MIB or a system information block (SIB), such as a SIB1, or by a common RRC signaling, or by UE-specific RRC signaling.

In the present disclosure, for the sake of brevity, the higher layer provided TDD UL-DL frame configuration refers to tdd-UL-DL-ConfigurationCommon for RRC common configuration, for example, and/or tdd-UL-DL-ConfigurationDedicated for UE-specific configuration, for example. The UE determines a common TDD UL-DL frame configuration of a serving cell by receiving a SIB such as a SIB1 when accessing the cell from RRC_IDLE or by RRC signaling when the UE is configured with SCells or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the present disclosure, for the sake of brevity, SFI refers to a slot format indicator that, for example, is indicated using higher layer provided IEs such as slotFormatCombination or slotFormatCombinationsPerCell and which is indicated to the UE by group common DCI format such as DCI F2_0 where slotFormats are defined in REF 3.

The Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The PCIs of SSBs transmitted in different frequency locations do not have to be unique, i.e. different SSBs in the frequency domain can have different PCIs. However, when an SSB is associated with an RMSI, the SSB is referred to as a Cell-Defining SSB (CD-SSB). A PCell is associated to a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry their own frequency-multiplexed DMRS. QPSK modulation is used for PBCH.

Measurement time resource(s) for SSB-based RSRP measurements may be confined within a SSB Measurement Time Configuration (SMTC). The SMTC configuration provides a measurement window periodicity/duration/offset information for UE RRM measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for RSSI are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to all groups of resource blocks belonging to the same L2 PDU scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) consists of a MIB and a number of SIBs, which are divided into Minimum SI and Other SI (OSI):
Minimum SI comprises basic information required for initial access and information for acquiring any other SI. Minimum SI consists of:
   MIB contains cell barred status information and essential physical layer information of the cell required to receive further system information, e.g. CORESET #0 configuration. MIB is periodically broadcast on BCH.
   SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI (OSI) encompasses all SIBs not broadcast in the Minimum SI. Those SIBs can either be periodically broadcast on DL-SCH, broadcast on-demand on DL-SCH (i.e. upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI). Other SI consists of:
   SIB2 contains cell re-selection information, mainly related to the serving cell;
   oSIB3 contains information about the serving frequency and intra-frequency neighbouring cells relevant for cell re-selection (including cell re-selection parameters common for a frequency as well as cell specific re-selection parameters);
   SIB4 contains information about other NR frequenCIes and inter-frequency neighbouring cells relevant for cell re-selection (including cell re-selection parameters common for a frequency as well as cell specific re-selection parameters), which can also be used for NR idle/inactive measurements;
   oSIB5 contains information about E-UTRA frequenCIes and E-UTRA neighbouring cells relevant for cell re-selection (including cell re-selection parameters common for a frequency as well as cell specific re-selection parameters);
   SIB6 contains an ETWS primary notification;
   SIB7 contains an ETWS secondary notification;
   SIB8 contains a CMAS warning notification;
   SIB9 contains information related to GPS time and Coordinated Universal Time (UTC);
   SIB10 contains the Human-Readable Network Names (HRNN) of the NPNs listed in SIB1;
   SIB11 contains information related to idle/inactive measurements;
   SIB15 contains information related to disaster roaming;
   SIB16 contains slice-based cell reselection information;
   SIB17 contains information related to TRS configuration for UEs in RRC_IDLE/RRC_INACTIVE;
   SIBpos contains positioning assistance data as defined in 3GPP TS 37.355 and REF 7;
   SIB18 contains information related to the Group IDs for Network selection (GINs) associated with SNPNs listed in SIB1.
   IB19 in TN contains NTN-specific parameters for NTN neighbour cells as defined in REF 7.

For a cell/frequency that is considered for camping by the UE, the UE is not required to acquire the contents of the minimum SI of that cell/frequency from another cell/frequency layer. This does not preclude the case in which the UE applies stored SI from previously visited cell(s).

If the UE cannot determine the full contents of the minimum SI of a cell by receiving from that cell, the UE shall consider that cell as barred.

In the case of broadcast allocation (BA), the UE only acquires SI on the active BWP. If the UE is configured with inter cell beam management:
The UE is not required to acquire the SI from the serving cell while the UE is receiving DL-SCH from a TRP with PCI different from serving cell's PCI.

In the present disclosure, the synchronization and cell search procedures are provided as follows.

Cell search is the procedure for a UE to acquire time and frequency synchronization with a cell and to detect the physical layer Cell ID of the cell.

A UE receives the following synchronization signals (SS) in order to perform cell search: the primary synchronization signal (PSS) and secondary synchronization signal (SSS) as defined in REF 1.

A UE assumes that reception occasions of a physical broadcast channel (PBCH), PSS, and SSS are in consecutive symbols, as defined in REF 1, and form a SS/PBCH block. The UE assumes that SSS, PBCH DM-RS, and PBCH data have same EPRE. The UE may assume that the ratio of PSS EPRE to SSS EPRE in a SS/PBCH block is either 0 dB or 3 dB. If the UE has not been provided dedicated higher layer parameters, the UE may assume that the ratio of PDCCH DMRS EPRE to SSS EPRE is within −8 dB and 8 dB when the UE monitors PDCCHs for a DCI format 1_0 with CRC scrambled by SI-RNTI, P-RNTI, or RA-RNTI, or for a DCI format 2_7, or for a DCI format 4_0.

For a half frame with SS/PBCH blocks, the first symbol indexes for candidate SS/PBCH blocks are determined according to the SCS of SS/PBCH blocks as follows, where index 0 corresponds to the first symbol of the first slot in a half-frame.
In Case A—15 kHz SCS: the first symbols of the candidate SS/PBCH blocks have indexes of {2,8}+14·n.
   or operation without shared spectrum channel access:
      For carrier frequenCIes smaller than or equal to 3 GHz, n=0,1.
      For carrier frequenCIes within FR1 larger than 3 GHZ, n=0,1,2,3.
   For operation with shared spectrum channel access, as described in REF 3, n=0, 1, 2, 3, 4.
In Case B—30 kHz SCS: the first symbols of the candidate SS/PBCH blocks have indexes {4,8,16,20}+28·n. For carrier frequenCIes smaller than or equal to 3 GHZ, n=0. For carrier frequenCIes within FR1 larger than 3 GHZ, n=0,1.
In Case C—30 kHz SCS: the first symbols of the candidate SS/PBCH blocks have indexes {2,8}+14·n.
   or operation without shared spectrum channel access
      For paired spectrum operation
         For carrier frequenCIes smaller than or equal to 3 GHZ, n=0,1. For carrier frequenCIes within FR1 larger than 3 GHZ, n=0,1,2,3.
      For unpaired spectrum operation
         For carrier frequenCIes smaller than 1.88 GHZ, n=0,1. For carrier frequenCIes within FR1 equal to or larger than 1.88 GHz, n=0,1,2,3.
   For operation with shared spectrum channel access, n=0, 1, 2, 3, 4, 5, 6, 7, 8, 9.
In Case D—120 kHz SCS: the first symbols of the candidate SS/PBCH blocks have indexes {4,8,16,20}+28·n. For carrier frequenCIes within FR2, n=0, 1, 2, 3, 5, 6, 7, 8, 10, 11, 12, 13, 15, 16, 17, 18.
In Case E—240 kHz SCS: the first symbols of the candidate SS/PBCH blocks have indexes {8,12,16,20,32,36,40,44}+56·n. For carrier frequenCIes within FR2-1, n=0, 1, 2, 3, 5, 6,7,8.
In Case F—480 kHz SCS: the first symbols of the candidate SS/PBCH blocks have indexes {2,9}+14·n. For carrier frequenCIes within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.
In Case G-960 KHz SCS: the first symbols of the candidate SS/PBCH blocks have indexes {2,9}+14·n. For carrier frequenCIes within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.

From the above cases, if the SCS of SS/PBCH blocks is not provided by ssbSubcarrierSpacing, the applicable cases for a cell depend on a respective frequency band, as provided in 3GPP TS 38.101-1 and 3GPP TS 38.101-2. A same case applies for all SS/PBCH blocks on the cell. If a 30 kHz SS/PBCH block SCS is indicated by ssbSubcarrierSpacing, Case B applies for frequency bands with only 15 kHz SS/PBCH block SCS as specified in 3GPP TS 38.101-1, and the case specified for 30 kHz SS/PBCH block SCS in 3GPP TS 38.101-1 applies for frequency bands with 30 kHz SS/PBCH block SCS or both 15 kHz and 30 kHz SS/PBCH block SCS as specified in 3GPP TS 38.101-1. For a UE configured to operate with carrier aggregation over a set of cells in a frequency band of FR2 or with frequency-contiguous carrier aggregation over a set of cells in a frequency band of FR1, if the UE is provided SCS values by ssbSubcarrierSpacing for receptions of SS/PBCH blocks on any cells from the set of cells, the UE expects the SCS values to be same.

The candidate SS/PBCH blocks in a half frame are indexed in an ascending order in time from 0 to L̅ₘₐₓ−1, where L̅ₘₐₓ is determined according to SS/PBCH block patterns for Cases A through G. Lₘₐₓ is a maximum number of SS/PBCH block indexes in a cell, and the maximum number of transmitted SS/PBCH blocks within a half frame is Lₘₐₓ.
For operation without shared spectrum channel access in FR1 and FR2, and for operation with shared spectrum channel access in FR2-2, Lₘₐₓ=L̅ₘₐₓ
For operation with shared spectrum channel access in FR1, Lₘₐₓ=8 for L̅ₘₐₓ=10 and 15 kHz SCS of SS/PBCH blocks and for L̅ₘₐₓ=20 and 30 kHz SCS of SS/PBCH blocks

For L̅ₘₐₓ=4, a UE determines the 2 LSB bits of a candidate SS/PBCH block index per half frame from a one-to-one mapping with an index of the DM-RS sequence transmitted in the PBCH as described in REF 1.

For L̅ₘₐₓ>4, a UE determines the 3 LSB bits of a candidate SS/PBCH block index per half frame from a one-to-one mapping with an index of the DM-RS sequence transmitted in the PBCH as described in REF 1.
For L̅ₘₐₓ=10, the UE determines the 1 MSB bit of the candidate SS/PBCH block index from PBCH payload bit ā_{A+7} as described in REF 2.
For L̅ₘₐₓ=20, the UE determines the 2 MSB bits of the candidate SS/PBCH block index from PBCH payload bits ā_{Ā+6}, ā_{Ā+7} as described in REF 2.
For L̅ₘₐₓ=64, the UE determines the 3 MSB bits of the candidate SS/PBCH block index from PBCH payload bits ā_{Ā+5}, ā_{Ā+6,} ā_{Ā+7} as described in REF 2.

A UE can be provided per serving cell by ssb-periodicityServingCell a periodicity of the half frames for reception of the SS/PBCH blocks for the serving cell. If the UE is not configured a periodicity of the half frames for receptions of the SS/PBCH blocks, the UE assumes a periodicity of a half frame. A UE assumes that the periodicity is same for all SS/PBCH blocks in the serving cell.

For initial cell selection, a UE may assume that half frames with SS/PBCH blocks occur with a periodicity of 2 frames.

For operation without shared spectrum channel access, an SS/PBCH block index is same as a candidate SS/PBCH block index.

For operation without shared spectrum channel access in FR2-2, a UE expects a MIB in a SS/PBCH block to provide subCarrierSpacingCommon=‘scs30or120’.

Upon detection of a SS/PBCH block, the UE determines from MIB that a CORESET for Type0-PDCCH CSS set, as described in clause 13, is present if k_{SSB}<24 [4, REF 1] for FR1 or if k_{SSB}<12 for FR2. The UE determines from MIB that a CORESET for Type0-PDCCH CSS set is not present if k_{SSB}>23 for FR1 or if k_{SSB}>11 for FR2; the CORESET for Type0-PDCCH CSS set may be provided by PDCCH-ConfigCommon.

For a serving cell without transmission of SS/PBCH blocks, a UE acquires time and frequency synchronization with the serving cell based on receptions of SS/PBCH blocks on the PCell, or on the PSCell, or on an SCell if applicable as described in 3GPP TS 38.133, of the cell group for the serving cell.

In the present disclosure, the UE procedure for monitoring Type0-PDCCH CSS set is provided as follows.

If during cell search a UE determines from MIB that a CORESET for Type0-PDCCH CSS set is present, the UE determines a number of consecutive resource blocks and a number of consecutive symbols for the CORESET of the Type0-PDCCH CSS set from controlResourceSetZero in pdcch-ConfigSIB1, as described in Tables 13-0 through 13-10 of REF 3, for operation without shared spectrum channel access in FR1 and FR2-1, or as described in Tables 13-1A and 13-4A of REF 3 for operation with shared spectrum channel access in FR1, or as described in Table 13-10A of REF 3 for FR2-2, and determines PDCCH monitoring occasions from searchSpaceZero in pdcch-ConfigSIB1, included in MIB, as described in Tables 13-11 through 13-15A of REF 3. SFN_{c} and n_{c} are the SFN and slot index within a frame of the CORESET based on SCS of the CORESET and SFN_{SSB,i} and n_{SSB,i} are the SFN and slot index based on SCS of the CORESET, respectively, where the SS/PBCH block with index i overlaps in time with system frame SFN_{SSB,i} and slot n_{SSB,i}. The symbols of the CORESET associated with pdcch-ConfigSIB1 in MIB or with searchSpaceSIB1 in PDCCH-ConfigCommon have normal cyclic prefix. In Table 13-0 of REF 3, configurations with index 0 to 9 are applicable when an associated SS/PBCH block is located according to Table 5.4.3.3-2 in 3GPP TS 38.101-1, configurations with index 10 to 11 are applicable when an associated SS/PBCH block is located according to NOTE 12 of Table 5.4.3.3-1 in 3GPP TS 38.101-1, and non-interleaved CCE-to-REG mapping applies for configurations with index 6 to 9. In Table 13-1 of REF 3, the associated SS/PBCH block is not located according to NOTE 12 of Table 5.4.3.3-1 in 3GPP TS 38.101-1.

For operation with shared spectrum channel access in FR2-2 and for operation without shared spectrum channel access, a UE assumes that the offset in Tables 13-0 through 13-10A of REF 3, is defined with respect to the SCS of the CORESET for Type0-PDCCH CSS set from the smallest RB index of the CORESET for Type0-PDCCH CSS set to the smallest RB index of the common RB overlapping with the first RB of the corresponding SS/PBCH block, after puncturing if any REF 1. The SCS of the CORESET for Type0-PDCCH CSS set is provided by subCarrierSpacingCommon for FR1 and FR2-1 and same as the SCS of the corresponding SS/PBCH block for FR2-2. In Tables 13-7, 13-8, and 13-10 of REF 3, Kssp is defined in REF 1.

For operation with shared spectrum channel access in FR1, a UE determines an offset from a smallest RB index of the CORESET for Type0-PDCCH CSS set to a smallest RB index of the common RB overlapping with a first RB of the corresponding SS/PBCH block:
according to the offset in Table 13-1A or Table 13-4A of REF 3, if the frequency position of the SS/PBCH block corresponds to the GSCN of a synchronization raster entry as defined in 3GPP TS 38.101-1, and
according to a sum of a first offset and a second offset if the frequency position of the SS/PBCH block is provided by ssbFrequency in a measurement configuration associated with a reporting configuration providing reportCGI and does not correspond to the GSCN of a synchronization raster entry as defined in 3GPP TS 38.101-1, where
   the first offset is provided in Table 13-1A or Table 13-4A of REF 3, and
   the second offset is determined as the offset from a smallest RB index of the common RB overlapping with the first RB of the SS/PBCH block indicated in the measurement configuration to a smallest RB index of the common RB overlapping with the first RB of a SS/PBCH block hypothetically located at the GSCN of a synchronization raster entry, where the single synchronization raster entry is located in the same channel as the SS/PBCH block used for the shared spectrum channel access procedure, as described in REF 3,
      where the offsets are defined with respect to the SCS of the CORESET for Type0-PDCCH CSS set that is same as the SCS of the corresponding SS/PBCH block.

For operation without shared spectrum channel access and for the SS/PBCH block and CORESET multiplexing pattern 1, a UE monitors PDCCH in the Type0-PDCCH CSS set over two slots. For SS/PBCH block with index i, the UE determines an index of slot n₀ as

$${n}_{0} = ( O \cdot {2}^{μ} + ⌊ i \cdot M ⌋ ) mod {N}_{slot}^{frame , μ}$$

that is in a frame with system frame number (SFN) SFN_{C} satisfying

$${SFN}_{c} mod 2 = 0 if ⌊ ( O \cdot {2}^{μ} + ⌊ i \cdot M ⌋ ) / {N}_{slot}^{frame , μ} ⌋ mod 2 = 0 ,$$

or in a frame with SFN satisfying

$${SFN}_{c} mod 2 = 1 if ⌊ ( O \cdot {2}^{μ} + ⌊ i \cdot M ⌋ ) / {N}_{slot}^{frame , μ} ⌋ mod 2 = 1$$

where μ∈{0,1,2,3,5,6} based on the SCS for PDCCH receptions in the CORESET REF 1.
For μ∈{0, 1, 2, 3} and for a SS/PBCH block index i, the two slots including the associated Type0-PDCCH monitoring occasions are slots n₀ and n₀+1. M, O, and the index of the first symbol of the CORESET in slots n₀ and n₀+1 are provided by Table 13-11 and Table 13-12 of REF 3.
For μ=5 and for a SS/PBCH block index i, the two slots including the associated Type0-PDCCH monitoring occasions are slots n₀ and n₀+4. M, O, and the index of the first symbol of the CORESET in slots n₀ and n₀+4 are provided by Table 13-12A of REF 3, where X=1.25.
For μ=6 and for a SS/PBCH block index i, the two slots including the associated Type0-PDCCH monitoring occasions are slots n₀ and n₀+8. M, O, and the index of the first symbol of the CORESET in slots n₀ and n₀+8 are provided by Table 13-12A of REF 3, where X=0.625.

For operation with shared spectrum channel access and for the SS/PBCH block and CORESET multiplexing pattern 1, a UE monitors PDCCH in the Type0-PDCCH CSS set over slots that include Type0-PDCCH monitoring occasions associated with SS/PBCH blocks that are quasi co-located with the SS/PBCH block that provides a CORESET for Type0-PDCCH CSS set with respect to average gain, quasi co-location ‘typeA’ and ‘typeD’ properties, when applicable [REF 4]. For a candidate SS/PBCH block index ī, where 0≤ī≤L̅ₘₐₓ−1, two slots include the associated Type0-PDCCH monitoring occasions. The UE determines an index of slot n₀ as

$${n}_{0} = ( O \cdot {2}^{μ} + ⌊ \overline{ι} \cdot M ⌋ ) mod {N}_{slot}^{frame , μ}$$

that is in a frame with system frame number (SFN) SFN_{c} satisfying

$${SFN}_{c} mod 2 = 0 if ⌊ ( O \cdot {2}^{μ} + ⌊ \overline{ι} \cdot M ⌋ ) / {N}_{slot}^{frame , μ} ⌋ mod 2 = 0 ,$$

or in a frame with SFN satisfying

$${SFN}_{c} mod 2 = 1 if ⌊ ( O \cdot {2}^{μ} + ⌊ \overline{ι} \cdot M ⌋ ) / {N}_{slot}^{frame , μ} ⌋ mod 2 = 1$$

where μ∈{0, 1,3,5,6} based on the SCS for PDCCH receptions in the CORESET [REF 1].
For μ∈{0, 1} and for a candidate SS/PBCH block index ī, the two slots including the associated Type0-PDCCH monitoring occasions are slots n₀ and n₀+1. M, O, and the index of the first symbol of the CORESET in slots n₀ and n₀+1 are provided by Table 13-11 of REF 3. The UE does not expect to be configured with M=1/2, or with M=2, when

$${N}_{SSB}^{QCL} = 1 .$$

For μ=3 and for a candidate SS/PBCH block index ī, the two slots including the associated Type0-PDCCH monitoring occasions are slots n₀ and n₀+1. M, O, and the index of the first symbol of the CORESET in slots n₀ and n₀+1 are provided by Table 13-12 of REF 3.
For μ=5 and for a candidate SS/PBCH block index ī, the two slots including the associated Type0-PDCCH monitoring occasions are slots n₀ and n₀+4. M, O, and the index of the first symbol of the CORESET in slots n₀ and n₀+4 are provided by Table 13-12A of REF 3, where X=1.25.
For μ=6 and for a candidate SS/PBCH block index ī, the two slots including the associated Type0-PDCCH monitoring occasions are slots n₀ and n₀+8. M, O, and the index of the first symbol of the CORESET in slots n₀ and n₀+8 are provided by Table 13-12A of REF 3, where X=0.625.

For operation without shared spectrum channel access and for the SS/PBCH block and CORESET multiplexing patterns 2 and 3, a UE monitors PDCCH in the Type0-PDCCH CSS set over one slot with Type0-PDCCH CSS set periodicity equal to the periodicity of SS/PBCH block. For a SS/PBCH block with index i, the UE determines the slot index n_{c} and SFN_{c} based on parameters provided by Tables 13-13 through 13-15A of REF 3.

For operation with shared spectrum channel access and for SS/PBCH block and CORESET multiplexing pattern 3, a UE monitors PDCCH in the Type0-PDCCH CSS set over slots that include Type0-PDCCH monitoring occasions associated with SS/PBCH blocks that are quasi co-located with the SS/PBCH block that provides a CORESET for Type0-PDCCH CSS set with respect to average gain, quasi co-location ‘typeA’ and ‘typeD’ properties, when applicable. For a candidate SS/PBCH block index ī, where 0≤ī≤Lₘₐₓ−1, the periodicity of the slot including the associated Type0-PDCCH monitoring occasion is same as the periodicity of the candidate SS/PBCH block, and the UE determines the slot index n_{c} and SFN_{c} based on parameters provided by Tables 13-15 and 13-15A of REF 3, where i is replaced by ī for operation with shared spectrum channel access in FR2-2.

For the SS/PBCH block and CORESET multiplexing patterns 2 and 3, if the active DL BWP is the initial DL BWP, the UE is expected to be able to perform radio link monitoring, and measurements for radio resource management [3GPP TS 38.133] using a SS/PBCH block that provides a CORESET for Type0-PDCCH CSS set.

If a UE detects a first SS/PBCH block and determines that a CORESET for Type0-PDCCH CSS set is not present, and for 24≤k_{SSB}≤29 for FR1 or for 12≤k_{SSB}≤13 for FR2, the UE may determine the nearest (in the corresponding frequency direction) global synchronization channel number (GSCN) of a second SS/PBCH block having a CORESET for an associated Type0-PDCCH CSS set as

$${N}_{GSCN}^{Reference} + {N}_{GSCN}^{Size} \cdot {N}_{GSCN}^{Offset} \cdot {N}_{GSCN}^{Reference}$$

is the GSCN of the first SS/PBCH block,

$${N}_{GSCN}^{Size} = 1 in FR 1$$

### and FR2-1,

$${N}_{GSCN}^{Size} = 3$$

### in FR2-2, and

$${N}_{GSCN}^{Offset}$$

is a GSCN offset provided by Table 13-16 of REF 3 for FR1 and Table 13-17 of REF 3 for FR2. If the UE detects the second SS/PBCH block and the second SS/PBCH block does not provide a CORESET for Type0-PDCCH CSS set, the UE may ignore the information related to GSCN of SS/PBCH block locations for performing cell search.

If a UE detects a SS/PBCH block and determines that a CORESET for Type0-PDCCH CSS set is not present, and for k_{SSB}=31 for FR1 or for k_{SSB}=15 for FR2, the UE determines that there is no SS/PBCH block having an associated Type0-PDCCH CSS set within a GSCN range

$$[ {N}_{GSCN}^{Reference} - {N}_{GSCN}^{Start} , {N}_{GSCN}^{Reference} + {N}_{GSCN}^{End} ] . {N}_{GSCN}^{Start} and {N}_{GSCN}^{End}$$

are respectively determined by controlResourceSetZero and searchSpaceZero in pdcch-ConfigSIB1. If the GSCN range is

$$[ {N}_{GSCN}^{Reference} , {N}_{GSCN}^{Reference} ] ,$$

the UE determines that there is no information for a second SS/PBCH block with a CORESET for an associated Type0-PDCCH CSS set on the detected SS/PBCH block.

If a UE does not detect any SS/PBCH block providing a CORESET for Type0-PDCCH CSS set, within a time period determined by the UE, the UE may ignore the information related to GSCN of SS/PBCH locations in performing cell search.

Paging allows the network to reach UEs in RRC_IDLE and in RRC_INACTIVE state through Paging messages, and to notify UEs in RRC_IDLE, RRC_INACTIVE and RRC_CONNECTED state of system information change and ETWS/CMAS indications through Short Messages. Both Paging messages and Short Messages are addressed with P-RNTI on PDCCH, but while the former is sent on PCCH, the latter is sent over PDCCH directly (see clause 6.5 of REF 7).

While in RRC_IDLE the UE monitors the paging channels for core network (CN)-initiated paging. While in RRC_INACTIVE with no ongoing SDT procedure, the UE monitors paging channels for RAN-initiated paging and CN-initiated paging. A UE need not monitor paging channels continuously though; Paging DRX is defined where the UE in RRC_IDLE or RRC_INACTIVE is only required to monitor paging channels during one Paging Occasion (PO) per DRX cycle (see REF 9). The Paging DRX cycles are configured by the network:
1) For CN-initiated paging, a default cycle is broadcast in system information;
2) For CN-initiated paging, a UE specific cycle can be configured via NAS signalling;
3) For RAN-initiated paging, a UE-specific cycle is configured via RRC signalling;
0 The UE uses the shortest of the DRX cycles applicable i.e. a UE in RRC_IDLE uses the shortest of the first two cycles above, while a UE in RRC_INACTIVE uses the shortest of the three.

The POs of a UE for CN-initiated and RAN-initiated paging are based on the same UE ID, resulting in overlapping POs for both. The number of different POs in a DRX cycle is configurable via system information and a network may distribute UEs to those POs based on their IDs.

While in RRC_CONNECTED and while in RRC_INACTIVE with ongoing SDT procedure, the UE monitors the paging channels in any PO signalled in system information for SI change indication and PWS notification. In the case of BA, a UE in RRC_CONNECTED only monitors paging channels on the active BWP with common search space configured.

For operation with shared spectrum channel access, a UE can be configured for an additional number of PDCCH monitoring occasions in its PO to monitor for paging. However, when the UE detects a PDCCH transmission within the UE's PO addressed with P-RNTI, the UE is not required to monitor the subsequent PDCCH monitoring occasions within this PO.

If Paging Cause is included in the Paging message, a UE in RRC_IDLE or RRC_INACTIVE state may use the Paging Cause as per 3GPP TS 23.501.

For paging optimization for UEs in CM_IDLE: at UE context release, the NG-RAN node may provide the AMF with a list of recommended cells and NG-RAN nodes as assistance info for subsequent paging. The AMF may also provide Paging Attempt Information consisting of a Paging Attempt Count and the Intended Number of Paging Attempts and may include the Next Paging Area Scope. If Paging Attempt Information is included in the Paging message, each paged NG-RAN node receives the same information during a paging attempt. The Paging Attempt Count shall be increased by one at each new paging attempt. The Next Paging Area Scope, when present, indicates whether the AMF plans to modify the paging area currently selected at next paging attempt. If the UE has changed its state to CM CONNECTED the Paging Attempt Count is reset.

For paging optimization for UEs in RRC_INACTIVE: at RAN Paging, the serving NG-RAN node provides RAN Paging area information. The serving NG-RAN node may also provide RAN Paging attempt information. Each paged NG-RAN node receives the same RAN Paging attempt information during a paging attempt with the following content: Paging Attempt Count, the intended number of paging attempts and the Next Paging Area Scope. The Paging Attempt Count shall be increased by one at each new paging attempt. The Next Paging Area Scope, when present, indicates whether the serving NG_RAN node plans to modify the RAN Paging Area currently selected at next paging attempt. If the UE leaves RRC_INACTIVE state the Paging Attempt Count is reset.

For UE power saving for paging monitoring: in order to reduce UE power consumption due to false paging alarms, the group of UEs monitoring the same PO can be further divided into multiple subgroups. With subgrouping, a UE shall monitor PDCCH in its PO for paging if the subgroup to which the UE belongs is paged as indicated via associated permanent equipment identifier (PEI). If a UE cannot find its subgroup ID with the PEI configurations in a cell or if the UE is unable to monitor the associated PEI occasion corresponding to its PO, it shall monitor the paging in its PO.

The above subgroups have the following characteristics:
They are formed based on either CN controlled subgrouping or UE ID based subgrouping;
If CN controlled subgroup ID is not provided from AMF, UE ID based subgrouping is used if supported by the UE and network;
The RRC state (RRC_IDLE or RRC_INACTIVE state) does not impact which subgroup the UE belongs to;
Subgrouping support for a cell is broadcast in the system information as one of the following: Only CN controlled subgrouping supported, only UE ID based subgrouping supported, or both CN controlled subgrouping and UE ID based subgrouping supported;
Total number of subgroups allowed in a cell is up to 8 and represents the sum of CN controlled and UE ID based subgrouping configured by the network;
A UE configured with CN controlled subgroup ID applies CN controlled subgroup ID if the cell supports CN controlled subgrouping; otherwise, it derives UE ID based subgroup ID if the cell supports only UE ID based subgrouping.

PEI associated with subgroups has the following characteristics:
If the PEI is supported by the UE, it shall at least support UE ID based subgrouping method;
   PEI monitoring can be limited via system information to the last used cell (i.e., the cell in which the UE most recently received RRCRelease without indicating that the last used cell for PEI shall not be updated);
   A PEI-capable UE shall store its last used cell information;
   gNBs supporting the PEI monitoring to the last used cell function provide the UE's last used cell information to the AMF in the NG-AP UE Context Release Complete message for PEI capable UEs, as described in 3GPP TS 38.413 [26];
   UE that expects MBS group notification shall ignore the PEI and shall monitor paging in its PO.

For CN controlled subgrouping: For CN controlled subgrouping, AMF is responsible for assigning subgroup ID to the UE. The total number of subgroups for CN controlled subgrouping which can be configured, e.g. by OAM is up to 8. It is assumed that CN controlled subgrouping support is homogeneous within an RNA.
1. The UE indicates its support of CN controlled subgrouping via NAS signaling.
2. If the UE supports CN controlled subgrouping, the AMF determines the subgroup ID assignment for the UE.
3. The AMF sends subgroup ID to the UE via NAS signaling.
4. The AMF informs the gNB about the CN assigned subgroup ID for paging the UE in RRC_IDLE/RRC_INACTIVE state.
5. When the paging message for the UE is received from the CN or is generated by the gNB, the gNB determines the PO and the associated PEI occasion for the UE.
6. Before the UE is paged in the PO, the gNB transmits the associated PEI and indicates the corresponding CN controlled subgroup of the UE that is to be paged in the PEI.

For UE ID based subgrouping: For UE ID based subgrouping, the gNB and UE can determine the subgroup ID based on the UE ID and the total number of subgroups for UE ID based subgrouping in the cell. The total number of subgroups for UE ID based subgrouping is decided by the gNB for each cell and can be different in different cells.
1. The gNB determines the total number of subgroups for UE ID based subgrouping in a cell.
2. The gNB broadcasts the total number of subgroups for UE ID based subgrouping in a cell.
3. UE determines its subgroup in a cell.
4. When paging message for the PEI capable UE is received from the CN at the gNB or is generated by the gNB, the gNB determines the PO and the associated PEI occasion for the UE.
5. Before the UE is paged in the PO, the gNB transmits the associated PEI and indicates the corresponding subgroup derived based on UE ID of the UE that is paged in the PEI.

The random access procedure is triggered by a number of events:
Initial access from RRC_IDLE;
RRC Connection Re-establishment procedure;
DL or UL data arrival, during RRC_CONNECTED or during RRC_INACTIVE while SDT procedure (see REF 8, clause 18.0) is ongoing, when UL synchronization status is “non-synchronized”;
UL data arrival, during RRC_CONNECTED or during RRC_INACTIVE while SDT procedure is ongoing, when there are no PUCCH resources for SR available;
Handover;
SR failure;
Explicit request by RRC upon synchronous reconfiguration;
RRC Connection Resume procedure from RRC_INACTIVE;
To establish time alignment for a primary or a secondary TAG;
Request for Other SI (see REF 8, clause 7.3);
Beam failure recovery;
Consistent UL LBT failure on SpCell;
SDT in RRC_INACTIVE (see REF 8, clause 18);
Positioning purpose during RRC_CONNECTED requiring random access procedure, e.g., when timing advance is needed for UE positioning;
Early UL synchronization with an LTM candidate cell;
RACH-based LTM cell switch.

Two types of random access procedure are supported: 4-step RA type with MSG1 and 2-step RA type with MSGA. Both types of RA procedure support contention-based random access (CBRA) and contention-free random access (CFRA).

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure. For CBRA, upon reception of the random access response, the UE sends MSG3 using the UL grant scheduled in the response and monitors contention resolution. If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure. For CBRA, if contention resolution is successful upon receiving the network response, the UE ends the random access procedure as shown in FIG. 9.2.6-1(b) of REF 8; while if fallback indication is received in MSGB, the UE performs MSG3 transmission using the UL grant scheduled in the fallback indication and monitors contention resolution. If contention resolution is not successful after MSG3 (re) transmission(s), the UE goes back to MSGA transmission.

If the random access procedure with 2-step RA type is not completed after a number of MSGA transmissions, the UE can be configured to switch to CBRA with 4-step RA type.

For the random access procedure towards an LTM candidate cell for early UL TA acquisition, CFRA triggered by a PDCCH order is used. The UE sends MSG1 towards the cell without monitoring for a response from it. To support UE power ramping, the UE may perform MSG1 retransmission as indicated by the network.

For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

The network can associate a set of RACH resources with feature(s) applicable to a Random Access procedure: Network Slicing, (e) RedCap, SDT, and NR coverage enhancement. A set of RACH resources associated with a feature is only valid for random access procedures applicable to at least that feature; and a set of RACH resources associated with several features is only valid for random access procedures having at least all of these features. The UE selects the set(s) of applicable RACH resources, after uplink carrier (i.e. NUL or SUL) and BWP selection and before selecting the RA type.

When carrier aggregation (CA) is configured, random access procedure with 2-step RA type is only performed on PCell while contention resolution can be cross-scheduled by the PCell.

When CA is configured, for random access procedure with 4-step RA type, the first three steps of CBRA occur on the PCell while contention resolution (step 4) can be cross-scheduled by the PCell. The three steps of a CFRA started on the PCell remain on the PCell. CFRA on SCell can only be initiated by the BS to establish timing advance for a secondary TAG: the procedure is initiated by the BS with a PDCCH order (step 0) that is sent on an activated SCell of the secondary TAG, preamble transmission (step 1) takes place on the SCell, and Random Access Response (step 2) takes place on PCell.

When two TAG IDs are configured for the serving cell, the TAG for which the TA command is applied is indicated in Random Access Response message or in MSGB.

An NG-RAN node is either:
a BS, providing NR user plane and control plane protocol terminations towards the UE; or
an ng-BS, providing E-UTRA user plane and control plane protocol terminations towards the UE.

The BSs and ng-BSs are interconnected with each other by means of the Xn interface. The BSs and ng-BSs are also connected by means of the NG interfaces to the 5GC, more specifically to the access and mobility management function (AMF) by means of the NG-C interface and to the user plane function (UPF) by means of the NG-U interface (see 3GPP TS 23.501).
NOTE: The architecture and the F1 interface for a functional split are defined in 3GPP TS 38.401.

The BS and ng-BS host the following functions:
Functions for Radio Resource Management: Radio Bearer Control, Radio Admission Control, Connection Mobility Control, Dynamic allocation of resources to UEs in uplink, downlink and sidelink (scheduling);
IP and Ethernet header compression, uplink data decompression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
   Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA;
Maintain security and radio configuration for User Plane CIOT 5GS Optimization, as defined in 3GPP TS 23.501 (ng-BS only).
NOTE 1: BLUE or UE in enhanced coverage is only supported by ng-BS, see REF 8.
NOTE 2: NB-IoT UE is only supported by ng-BS, see REF 8.

Each Cell Identity associated with a subset of PLMNs, SNPNs or PNI-NPNs identifies its serving NG-RAN node.

In the present disclosure, the following methods can apply to Physical downlink control channels.

The Physical Downlink Control Channel (PDCCH) can be used to schedule DL transmissions on PDSCH and UL transmissions on PUSCH, where the Downlink Control Information (DCI) on PDCCH includes:
Downlink assignments containing at least modulation and coding format, resource allocation, and hybrid-ARQ information related to DL-SCH;
Uplink scheduling grants containing at least modulation and coding format, resource allocation, and hybrid-ARQ information related to UL-SCH.

In addition to scheduling, PDCCH can be used to for:
Activation and deactivation of configured PUSCH transmission with configured grant;
Activation and deactivation of PDSCH semi-persistent transmission;
Notifying one or more UEs of the slot format;
Notifying one or more UEs of the PRB(s) and OFDM symbol(s) where the UE may assume no transmission is intended for the UE;
Transmission of TPC commands for PUCCH and PUSCH;
Transmission of one or more TPC commands for SRS transmissions by one or more UEs;
Switching a UE's active bandwidth part;
Initiating a random access procedure;
Indicating the UE(s) to monitor the PDCCH during the next occurrence of the DRX on-duration;
In IAB context, indicating the availability for soft symbols of an IAB-DU;
Triggering one shot HARQ-ACK codebook feedback;
For operation with shared spectrum channel access:
   Triggering search space set group switching;
   Indicating one or more UEs about the available RB sets and channel occupancy time duration;
   Indicating downlink feedback information for configured grant PUSCH (CG-DFI).

A UE monitors a set of PDCCH candidates in the configured monitoring occasions in one or more configured COntrol REsource SETs (CORESETs) according to the corresponding search space configurations.

A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET.

The PDCCH repetition is operated by using two search spaces which are explicitly linked by configuration provided by the RRC layer, and are associated with corresponding CORESETs. For PDCCH repetition, two linked search spaces are configured with the same number of candidates, and two PDCCH candidates in two search spaces are linked with the same candidate index. When PDCCH repetition is scheduled to a UE, an intra-slot repetition is allowed and each repetition has the same number of CCEs and coded bits, and corresponds to the same DCI payload.

Polar coding is used for PDCCH.

Each resource element group carrying PDCCH carries its own DMRS.

QPSK modulation is used for PDCCH.

The following describes various UE identities, for example, as used by NR connected to 5GC are listed.

For scheduling at cell level, the following identities are used.
C-RNTI: unique UE identification used as an identifier of the RRC Connection and for scheduling;
CG-SDT-CS-RNTI: unique UE identification used for Configured Grant-based SDT in the uplink;
CI-RNTI: identification of cancellation in the uplink;
CS-RNTI: unique UE identification used for Semi-Persistent Scheduling in the downlink or configured grant in the uplink;
INT-RNTI: identification of pre-emption in the downlink;
MCS-C-RNTI: unique UE identification used for indicating an alternative MCS table for PDSCH and PUSCH;
P-RNTI: identification of Paging and System Information change notification in the downlink;
SI-RNTI: identification of Broadcast and System Information in the downlink;
SP-CSI-RNTI: unique UE identification used for semi-persistent CSI reporting on PUSCH.

For power and slot format control, the following identities are used:
SFI-RNTI: identification of slot format;
TPC-PUCCH-RNTI: unique UE identification to control the power of PUCCH;
TPC-PUSCH-RNTI: unique UE identification to control the power of PUSCH;
TPC-SRS-RNTI: unique UE identification to control the power of SRS.

During the random access procedure, the following identities are also used:
RA-RNTI: identification of the Random Access Response in the downlink;
MSGB-RNTI: identification of the Random Access Response for 2-step RA type in the downlink;
Temporary C-RNTI: UE identification temporarily used for scheduling during the random access procedure;
Random value for contention resolution: UE identification temporarily used for contention resolution purposes during the random access procedure.

For NR connected to 5GC, the following UE identity is used at NG-RAN level:
I-RNTI: used to identify the UE context in RRC_INACTIVE.

For UE power saving purpose, the following identities are used:
PS-RNTI: used to determine if the UE needs to monitor PDCCH on the next occurrence of the connected mode DRX on-duration;
PEI-RNTI: used to determine if the UE needs to monitor the associated PO.

The following methods can apply to Cross Carrier Scheduling.

Cross-carrier scheduling with the Carrier Indicator Field (CIF) allows the PDCCH of a serving cell to schedule resources on another serving cell but with the following restrictions:
When cross-carrier scheduling from an SCell to PCell is not configured, PCell can only be scheduled via its PDCCH;
When cross-carrier scheduling from an SCell to PCell is configured:
   PDCCH on that SCell can schedule PCell's PDSCH and PUSCH;
   PDCCH on the PCell can schedule PCell's PDSCH and PUSCH but cannot schedule PDSCH and PUSCH on any other cell;
   Only one SCell can be configured to be used for cross-carrier scheduling to PCell.
When an SCell is configured with a PDCCH, that cell's PDSCH and PUSCH are scheduled by the PDCCH on this SCell;
When an SCell is not configured with a PDCCH, that SCell's PDSCH and PUSCH are scheduled by a PDCCH on another serving cell;
The scheduling PDCCH and the scheduled PDSCH/PUSCH can use the same or different numerologies.

The following methods apply to multi-cell scheduling by a single DCI, such as DCI format 0_3/1_3.

Multi-cell scheduling by a single DCI allows the PDCCH of a serving cell to schedule PDSCH(s)/PUSCH(s) on one or more serving cells with the single DCI but with the following restrictions:
When a serving cell is configured with a PDCCH which schedules PDSCH(s)/PUSCH(s) on a cell set, the PUSCH/PDSCH on serving cells in the cell set is scheduled by a PDCCH on the serving cell;
When PCell is configured with a PDCCH which schedules PDSCH(s)/PUSCH(s) on serving cells in a cell set, that PCell's PDSCH and PUSCH cannot be scheduled by a PDCCH on an SCell;
When an SCell is configured with a PDCCH which schedules PDSCH(s)/PUSCH(s) on serving cells in a cell set, PCell is not included in the cell set;
The scheduling PDCCH and the scheduled PDSCH(s)/PUSCH(s) can use the same or different numerologies;
The co-scheduled PDSCH(s) with a PDCCH use the same numerology;
The co-scheduled PUSCH(s) with a PDCCH use the same numerology.

The following describes methods for UE power saving.

The PDCCH monitoring activity of the UE in RRC connected mode is governed by DRX, BA, DCP and cell DTX.

When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e., not for retransmissions);
retransmission-timer: duration until a retransmission can be expected;
cycle: specifies the periodic repetition of the on-duration followed by a possible period of inactivity;
active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

When BA is configured, the UE only has to monitor PDCCH on the one active BWP i.e. it does not have to monitor PDCCH on the entire DL frequency of the cell. A BWP inactivity timer (independent from the DRX inactivity-timer described above) is used to switch the active BWP to the default one: the timer is restarted upon successful PDCCH decoding and the switch to the default BWP takes place when it expires.

In addition, the UE may be indicated, when configured accordingly, whether it is required to monitor or not the PDCCH during the next occurrence of the on-duration by a DCP monitored on the active BWP. If the UE does not detect a DCP on the active BWP, it does not monitor the PDCCH during the next occurrence of the on-duration, unless it is explicitly configured to do so in that case.

A UE can only be configured to monitor DCP when connected mode DRX is configured, and at occasion(s) at a configured offset before the on-duration. More than one monitoring occasion can be configured before the on-duration. The UE does not monitor DCP on occasions occurring during active-time, measurement gaps, BWP switching, or when it monitors response for a CFRA preamble transmission for beam failure recovery, in which case it monitors the PDCCH during the next on-duration. If no DCP is configured in the active BWP, UE follows normal DRX operation.

When CA is configured, DCP is only configured on the PCell.

One DCP can be configured to control PDCCH monitoring during on-duration for one or more UEs independently.

Power saving in RRC_IDLE and RRC_INACTIVE can also be achieved by UE relaxing neighbour cells RRM measurements when it meets the criteria determining it is in low mobility and/or not at cell edge.

UE power saving may be enabled by adapting the DL maximum number of MIMO layers by BWP switching.

Power saving is also enabled during active-time via cross-slot scheduling, which facilitates UE to achieve power saving with the assumption that it won't be scheduled to receive PDSCH, triggered to receive A-CSI or transmit a PUSCH scheduled by the PDCCH until the minimum scheduling offsets K0 and K2. Dynamic adaptation of the minimum scheduling offsets K0 and K2 is controlled by PDCCH.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are on-duration and inactivity-timer.

UE power saving in RRC_IDLE/RRC_INACTIVE may be achieved by providing the configuration for TRS with CSI-RS for tracking in TRS occasions. The TRS in TRS occasions may allow UEs in RRC_IDLE/RRC_INACTIVE to sleep longer before waking-up for its paging occasion. The TRS occasions configuration is provided in SIB17. The availability of TRS in the TRS occasions is indicated by L1 availability indication. These TRSs may also be used by the UEs configured with eDRX.

UE power saving may be achieved by UE relaxing measurements for RLM/BFD. When configured, UE determines whether it is in low mobility state and/or whether its serving cell radio link quality is better than a threshold. The configuration for low mobility and good serving cell quality criterion is provided through dedicated RRC signaling.

RLM and BFD relaxation may be enabled/disabled separately through RRC Configuration. Additionally, RLM relaxation may be enabled/disabled on per Cell Group basis while BFD relaxation may be enabled/disabled on per serving cell basis.

The UE is only allowed to perform RLM and/or BFD relaxation when relaxed measurement criterion for low mobility and/or for good serving cell quality is met. If configured to do so, the UE shall trigger reporting of its RLM and/or BFD relaxation status through UE assistance information if the UE changes its respective RLM and/or BFD relaxation status while meeting the UE minimum requirements specified in 3GPP TS 38.133.

UE power saving may also be achieved through PDCCH monitoring adaptation mechanisms when configured by the network, including skipping of PDCCH monitoring and Search space set group (SSSG) switching. In this case UE does not monitor PDCCH during the PDCCH skipping duration except for the cases as specified in REF 3, or monitors PDCCH according to the search space sets applied in SSSG.

The following methods describe network energy saving, to reduce operational expenses through energy savings.

The function allows, for example in a deployment where capacity boosters can be distinguished from cells providing basic coverage, to optimize energy consumption enabling the possibility for an E-UTRA or NR cell providing additional capacity via single or dual connectivity, to be switched off when its capacity is no longer needed and to be re-activated on a need basis, or to support various adaptation techniques in time, frequency, spatial and power domains.

The solution for Intra-system energy saving builds upon the possibility for the NG-RAN node owning a capacity booster cell to autonomously decide to switch-off such cell to lower energy consumption (inactive state). The decision is typically based on cell load information, consistently with configured information. The switch-off decision may also be taken by O&M.

The NG-RAN node may initiate handover actions in order to off-load the cell being switched off and may indicate the reason for handover with an appropriate cause value to support the target node in taking subsequent actions, e.g. when selecting the target cell for subsequent handovers.

All neighbor NG-RAN nodes are informed by the NG-RAN node owning the concerned cell about the switch-off actions over the Xn interface, by means of the NG-RAN node Configuration Update procedure.

All informed nodes maintain the cell configuration data, e.g., neighbour relationship configuration, also when a certain cell is inactive. If basic coverage is ensured by NG-RAN node cells, NG-RAN node owning non-capacity boosting cells may request a re-activation over the Xn interface if capacity needs in such cells demand to do so. This is achieved via the Cell Activation procedure. During switch off time period of the boost cell, the NG-RAN node may prevent idle mode UEs from camping on this cell and may prevent incoming handovers to the same cell.

The NG-RAN node receiving a request should act accordingly. The switch-on decision may also be taken by O&M. All peer NG-RAN nodes are informed by the NG-RAN node owning the concerned cell about the re-activation by an indication on the Xn interface.

The solution also builds upon the possibility for the NG-RAN node owning a coverage cell to request neighboring NG-RAN node(s) owning a capacity booster cell to switch on some SSB beams within the cell which are deactivated. The receiving NG-RAN node should act accordingly.

The solution also builds upon the possibility for an NG-RAN node to page certain UEs (e.g., stationary UEs) in RRC_INACTIVE state on a limited set of beams, instead of paging on all the beams within the cell. It is up to the gNB's implementation to select the UEs in RRC_INACTIVE for which paging in limited set of beams applies. If the paging over the limited set of beams fails, the gNB performs subsequent paging by implementation, e.g., by ensuring the same paging message is repeated in all the transmitted SSB beams.

The solution for Inter-system energy saving builds upon the possibility for the NG-RAN node owning a capacity booster cell to autonomously decide to switch-off such cell to dormant state. The decision is typically based on cell load information, consistently with configured information. The switch-off decision may also be taken by O&M. The NG-RAN node indicates the switch-off action to the eNB over NG interface and S1 interface. The NG-RAN node could also indicate the switch-on action to the eNB over NG interface and S1 interface.

The eNB providing basic coverage may request a NG-RAN node's cell re-activation based on its own cell load information or neighbour cell load information, the switch-on decision may also be taken by O&M. The eNB requests a NG-RAN node's cell re-activation and receives the NG-RAN node's cell re-activation reply from the NG-RAN node over the S1 interface and NG interface. Upon reception of the re-activation request, the NG-RAN node's cell should remain switched on at least until expiration of the minimum activation time. The minimum activation time may be configured by O&M or be left to the NG-RAN node's implementation.

The following methods describe Cell DTX/DRX. To facilitate reducing gNB downlink transmission/uplink reception active time, UE can be configured with a periodic cell DTX/DRX pattern (i.e. active and non-active periods). The pattern configuration for cell DTX/DRX is common for the UEs configured with this feature in the cell. The cell DTX and cell DRX patterns can be configured and activated separately. A maximum of two cell DTX/DRX patterns can be configured per MAC entity for different serving cells. When cell DTX is configured and activated for the concerned cell, the UE may not monitor PDCCH in selected cases or does not monitor SPS occasions during cell DTX non-active duration. When cell DRX is configured and activated for the concerned cell, the UE does not transmit on CG resources or does not transmit a SR during cell DRX non-active duration. This feature is only applicable to UEs in RRC_CONNECTED state and it does not impact Random Access procedure, SSB transmission, paging, and system information broadcasting. Cell DTX/DRX operation is only supported for single TRP scenario. Cell DTX/DRX can be activated/deactivated by RRC signaling or L1 group common signaling. Cell DTX/DRX is characterized by the following:
active duration: duration that the UE waits for to receive PDCCHs or SPS occasions, and transmit SR or CG. In this duration, the gNB transmission/reception of PDCCH, SPS, SR, CG, periodic and semi-persistent CSI report are not impacted for the purpose of network energy saving;
cycle: specifies the periodic repetition of the active-duration followed by a period of non-active duration.

Active duration and cycle parameters are common between cell DTX and cell DRX, when both are configured.

Once the gNB recognizes there is an emergency call or public safety related service (e.g. MPS or MCS), the network should ensure that there is no impact to that service (e.g. it may release or deactivate cell DTX/DRX configuration). The network should also ensure that there is at least partial overlapping between UE's connected mode DRX on-duration and cell DTX/DRX active duration, i.e. the UE's connected mode DRX periodicity is a multiple of cell DTX/DRX periodicity or vice versa.

A same prinCIple as for Conditional Handover of “normal” cells applies to conditional handover in case the source cell is using a network energy saving solution (e.g., the cell is activating cell DTX/DRX or turning off), unless hereunder specified. In this case, the following additional triggering conditions are supported, upon which UE may use NES-specific CHO event for executing CHO to a candidate cell, as defined in REF 7:
The UE may be notified via DCI to enable CHO conditions(s) configured with NES event indication.

The following methods describe Camping Restrictions. If a cell is activating or going to activate NES cell DTX/DRX, the cell can allow the access of UEs capable of NES cell DTX/DRX via a single bit in SIB1 but prevent the access of UEs not capable of cell DTX/DRX using barring mechanisms.

The following methods describe SSB-less SCell. For an intra-band or inter-band CA SCell, a UE may obtain timing reference and AGC source from another serving cell in case the UE is not provided with SSB nor SMTC configuration for this SCell, as described in REF 7.

The following methods describe Spatial and power domain adaptation. To assist the gNB on muting transceivers and/or adapting transmission power, the UE can be configured to report multiple CSI entries in a CSI report based on two or more sub-configurations, as specified in clause 5.2.1.6 in REF 4. Each sub-configuration corresponds to a spatial domain adaptation pattern (subsets of available spatial elements) and/or a power offset between PDSCH and CSI-RS.

The following describes a UE procedure for receiving control information.

If the UE is configured with a SCG, the UE shall apply the procedures described in this clause for both MCG and SCG except for PDCCH monitoring in Type0/0A/0B/2/2A-PDCCH CSS sets where the UE is not required to apply the procedures in this clause for the SCG.
When the procedures are applied for MCG, the terms ‘secondary cell’, ‘secondary cells’, ‘serving cell’, ‘serving cells’ in this clause refer to secondary cell, secondary cells, serving cell, serving cells belonging to the MCG respectively.
When the procedures are applied for SCG, the terms ‘secondary cell’, ‘secondary cells’, ‘serving cell’, ‘serving cells’ in this clause refer to secondary cell, secondary cells (not including PSCell), serving cell, serving cells belonging to the SCG respectively. The term ‘primary cell’ in this clause refers to the PSCell of the SCG.

A UE monitors a set of PDCCH candidates in one or more CORESETs on the active DL BWP on each activated serving cell configured with PDCCH monitoring according to corresponding search space sets where monitoring implies receiving each PDCCH candidate and decoding according to the monitored DCI formats.

A set of PDCCH candidates for a UE to monitor is defined in terms of PDCCH search space sets. A search space set can be a CSS set or a USS set. A UE monitors PDCCH candidates in one or more of the following search spaces sets:
a Type0-PDCCH CSS set on the primary cell of the MCG configured by
   pdcch-ConfigSIB1 in MIB or by searchSpaceSIB1 in PDCCH-ConfigCommon or by searchSpaceZero in PDCCH-ConfigCommon for a DCI format 1_0 with CRC scrambled by a SI-RNTI, or
   searchSpaceZero by providing searchSpaceID=0 for searchSpaceMCCH or searchSpaceMTCH for a DCI format 4_0 with CRC scrambled by a MCCH-RNTI or a G-RNTI for broadcast, or
   searchSpaceZero by providing searchSpaceID=0 for searchspaceMulticastMCCH for a DCI format 4_0 with CRC scrambled by a multicast-MCCH-RNTI, or by searchSpaceMulticastMTCH for a DCI format 4_1 with CRC scrambled by a G-RNTI for multicast in RRC_INACTIVE state
a Type0A-PDCCH CSS set configured by searchSpaceOtherSystemInformation in PDCCH-ConfigCommon for a DCI format 1_0 with CRC scrambled by a SI-RNTI on the primary cell of the MCG
a Type0B-PDCCH CSS set configured by
   searchSpaceMCCH and searchSpaceMTCH for a DCI format 4_0 with CRC scrambled by a MCCH-RNTI or a G-RNTI for broadcast, on the primary cell of the MCG
   searchspaceMulticastMCCH for a DCI format 4_0 with CRC scrambled by a multicast-MCCH-RNTI, or by searchSpaceMulticastMTCH for a DCI format 4_1 with CRC scrambled by a G-RNTI for PDCCH receptions in RRC_INACTIVE state
a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell
a Type1A-PDCCH CSS set configured by sdt-SearchSpace in PDCCH-ConfigCommon for a DCI format with CRC scrambled by a C-RNTI or a CS-RNTI on the primary cell as described in clause 19.1 of REF 3.
a Type2-PDCCH CSS set configured by pagingSearchSpace in PDCCH-ConfigCommon for a DCI format 1_0 with CRC scrambled by a P-RNTI on the primary cell of the MCG
a Type2A-PDCCH CSS set configured by pei-SearchSpace in pei-ConfigBWP for a DCI format 2_7 with CRC scrambled by a PEI-RNTI on the primary cell of the MCG
a Type3-PDCCH CSS set configured by
   SearchSpace in PDCCH-Config with searchSpace Type=common for DCI formats with CRC scrambled by INT-RNTI, SFI-RNTI, TPC-PUSCH-RNTI, TPC-PUCCH-RNTI, TPC-SRS-RNTI, CI-RNTI, or cellDTRX-RNTI and, only for the primary cell, C-RNTI, MCS-C-RNTI, CS-RNTI(s), or PS-RNTI, or
   SearchSpace in pdcch-ConfigMulticast for DCI formats with CRC scrambled by G-RNTI, or G-CS-RNTI, or
   searchSpaceMCCH and searchSpaceMTCH on a secondary cell for a DCI format 4_0 with CRC scrambled by a MCCH-RNTI or a G-RNTI for broadcast, and
a USS set configured by
   SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, SL Semi-Persistent Scheduling V-RNTI, or NCR-RNTI

In the following, DCI formats with CRC scrambled by C-RNTI or CS-RNTI or MCS-C-RNTI are also referred to as unicast DCI formats, DCI formats with CRC scrambled by G-RNTI for multicast or G-CS-RNTI are also referred to as multicast DCI formats, and DCI formats with CRC scrambled by MCCH-RNTI or G-RNTI for broadcast scheduling PDSCH receptions are also referred to as broadcast DCI formats, and DCI formats with CRC scrambled by multicast-MCCH-RNTI or G-RNTI for multicast scheduling PDSCH receptions in RRC_INACTIVE state are also referred as multicast DCI formats for RRC_INACTIVE state.

For a DL BWP, if a UE is not provided searchSpaceSIB1 for Type0-PDCCH CSS set by PDCCH-ConfigCommon, the UE does not monitor PDCCH candidates for a Type0-PDCCH CSS set on the DL BWP. The Type0-PDCCH CSS set is defined by the CCE aggregation levels and the number of PDCCH candidates per CCE aggregation level given in Table 10.1-1.

For a DL BWP, if a UE is not provided searchSpaceOtherSystemInformation for Type0A-PDCCH CSS set, the UE does not monitor PDCCH for Type0A-PDCCH CSS set on the DL BWP. The CCE aggregation levels and the number of PDCCH candidates per CCE aggregation level for Type0A-PDCCH CSS set are given in Table 10.1-1 of REF 3.

For a DL BWP, if a UE is not provided ra-SearchSpace for Type1-PDCCH CSS set, the UE does not monitor PDCCH for Type1-PDCCH CSS set on the DL BWP. If the UE has not been provided a Type3-PDCCH CSS set, or a Type1A-PDCCH CSS set, or a USS set and the UE has received a C-RNTI and has been provided a Type1-PDCCH CSS set, the UE monitors PDCCH candidates for DCI format 0_0 and DCI format 1_0 with CRC scrambled by the C-RNTI in the Type1-PDCCH CSS set.

If a UE is not provided pagingSearchSpace for Type2-PDCCH CSS set, the UE does not monitor PDCCH for Type2-PDCCH CSS set on the DL BWP. The CCE aggregation levels and the number of PDCCH candidates per CCE aggregation level for Type2-PDCCH CSS set are given in Table 10.1-1 of REF 3.

If a UE is not provided pei-SearchSpace for Type2A-PDCCH CSS set, the UE does not monitor PDCCH for Type2A-PDCCH CSS set on the DL BWP. The CCE aggregation levels and the maximum number of PDCCH candidates per CCE aggregation level for Type2A-PDCCH CSS set are given in Table 10.1-1 of REF 3. If the UE is provided pei-SearchSpace with zero value for the Type2A-PDCCH CSS set index, and for the SS/PBCH block and CORESET multiplexing patterns 2 and 3, the UE determines PDCCH monitoring occasions as described in clause 13 and the CCE aggregation levels and the number of PDCCH candidates per CCE aggregation level for Type2A-PDCCH CSS set are given in Table 10.1-1 of REF 3.

If a UE is provided a zero value for searchSpaceID in PDCCH-ConfigCommon for a Type0/0A/1A/2-PDCCH CSS set, the UE determines monitoring occasions for PDCCH candidates of the Type0/0A/1A/2-PDCCH CSS set as described in clause 13 of REF 3, and the UE is provided a C-RNTI, the UE monitors PDCCH candidates only at monitoring occasions associated with a SS/PBCH block, where the SS/PBCH block is determined by the most recent of
a MAC CE activation command indicating a TCI state of the active BWP that includes a CORESET with index 0, as described in REF 4, where the TCI-state includes a CSI-RS which is quasi-co-located with the SS/PBCH block, or
a random access procedure that is not initiated by a PDCCH order that triggers a contention-free random access procedure, or
configured-grant based PUSCH transmission in RRC_INACTIVE state as described in clause 19.1 of REF 3.

If a UE monitors PDCCH candidates for DCI formats with CRC scrambled by a C-RNTI and the UE is provided a non-zero value for searchSpaceID in PDCCH-ConfigCommon for a Type0/0A/1A/2-PDCCH CSS set, or monitors PDCCH candidates for DCI formats with CRC scrambled by a MCCH-RNTI or a G-RNTI for broadcast and the UE is provided a non-zero value for searchSpaceMCCH and searchSpaceMTCH in PDCCH-ConfigCommon for a Type0B-PDCCH CSS set, or monitors PDCCH candidates for DCI formats with CRC scrambled by a multicast-MCCH-RNTI or a G-RNTI for multicast in RRC_INACTIVE state and the UE is provided a non-zero value for searchSpaceMulticastMCCH and searchSpaceMulticastMTCH in PDCCH-ConfigCommon for a Type0B-PDCCH CSS set, the UE determines monitoring occasions for PDCCH candidates of the Type0/0A/1A/2-PDCCH CSS set, or of the Type0B-PDCCH CSS set, respectively, based on the search space set associated with the value of searchSpaceID.

The UE may assume that the DM-RS antenna port associated with PDCCH receptions in the CORESET configured by pdcch-ConfigSIB1 in MIB, the DM-RS antenna port associated with corresponding PDSCH receptions, and the corresponding SS/PBCH block are quasi co-located with respect to average gain, quasi co-location ‘typeA’ and ‘typeD’ properties, when applicable [REF 4], if the UE is not provided a TCI state indicating quasi co-location information of the DM-RS antenna port for PDCCH reception in the CORESET. The value for the DM-RS scrambling sequence initialization is the cell ID. For operation without shared spectrum channel access in FR1 and FR2-1, a SCS is provided by subCarrierSpacingCommon in MIB. For operation with shared spectrum channel access in FR1 and for operation in FR2-2, a SCS is same as the SCS of a corresponding SS/PBCH block.

TABLE 10.1-1 of REF 3: CCE aggregation levels and maximum number
of PDCCH candidates per CCE aggregation level for CSS sets
configured by searchSpaceSIB1

| CCE Aggregation Level | Number of Candidates |
|---|---|
| 4 | 4 |
| 8 | 2 |
| 16 | 1 |

For each DL BWP configured to a UE in a serving cell, the UE can be provided by higher layer signaling with
P≤3 CORESETs if coresetPoolIndex is not provided, or if a value of coresetPoolIndex is same for all CORESETs if coresetPoolIndex is provided
P≤5 CORESETs if coresetPoolIndex is not provided for a first CORESET, or is provided and has a value 0 for a first CORESET, and is provided and has a value 1 for a second CORESET

For each CORESET, the UE is provided the following by ControlResourceSet:
a CORESET index p, by controlResourceSetId or by controlResourceSetId-v1610, where
   0<p<12 if coresetPoolIndex is not provided, or if a value of coresetPoolIndex is same for all CORESETs if coresetPoolIndex is provided;
   0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity,
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceld
an association between the search space set s and a CORESET p by controlResourceSetId or by controlResourceSetId-v1610
a PDCCH monitoring periodicity of kₛ slots and a PDCCH monitoring offset of os slots, by monitoringSlotPeriodicityAndOffset or by monitoringSlotPeriodicityAndOffset-r17
a PDCCH monitoring pattern within a slot, indicating first symbol(s) of the CORESET for PDCCH monitoring within each slot where the UE monitors PDCCH, by monitoringSymbolsWithinSlot
a duration of Tₛ<kₛ indicating a number of slots that the search space set s exists by duration, or a number of slots in consecutive groups of slots where the search space set s can exist by duration-r17
a bitmap, by monitoringSlotsWithinSlotGroup, that applies per group of slots and provides a PDCCH monitoring pattern indicating slots in a group of slots for PDCCH monitoring
   a size of the group of slots is same as a size of monitoringSlotsWithinSlotGroup
   for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ
   for a Type1-PDCCH CSS set provided by ra-SearchSpace in SIB1, the PDCCH monitoring pattern indicates only up to 1 slot in the group of slots for PDCCH monitoring
   for a Type0-PDCCH CSS set or for a Type0A-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlotsWithinSlotGroup
a number of PDCCH candiates

$${M}_{s}^{( L )}$$

per CCE aggregation level L by aggregationLevel1,
   aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpace Type
if search space set s is a CSS set
   an indication by dci-Format0-0-AndFormat1-0 to monitor PDCCH candidates for DCI format 0_0 and DCI format 1_0
   an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level
   an indication by dci-Format2-1 to monitor PDCCH candidates for DCI format 2_1
   an indication by dci-Format2-2 to monitor PDCCH candidates for DCI format 2_2
   an indication by dci-Format2-3 to monitor PDCCH candidates for DCI format 2_3
   an indication by dci-Format2-4 to monitor PDCCH candidates for DCI format 2_4
   an indication by dci-Format2-6 to monitor PDCCH candidates for DCI format 2_6
   an indication by dci-Format2-9 to monitor PDCCH candidates for DCI format 2_9
   an indication by dci-Format4-0 to monitor PDCCH candidates for DCI format 4_0
   an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively
an indication by searchSpaceLinkingId that search space set s is linked to another search space set for which is provided a same value for searchSpaceLinkingId
if search space set s is a USS set,
   an indication by dci-Formats to monitor PDCCH candidates either for DCI format 0_0 and DCI format 1_0, or for DCI format 0_1 and DCI format 1_1, or
   an indication by dci-FormatsExt to monitor PDCCH candidates for DCI format 0_2 and DCI format 1_2, or for DCI format 0_1, DCI format 1_1, DCI format 0_2, and DCI format 1_2, or
   an indication by dci-FormatsMC to monitor PDCCH candidates for one or both of DCI format 0_3 and DCI format 1_3, or
   an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1, on an indication by dci-Format-NCR to monitor PDCCH candidates for DCI format 2_8
a bitmap by freqMonitorLocations, if provided, to indicate an index of one or more RB sets for the search space set s, where the MSB k in the bitmap corresponds to RB set k−1 in the DL BWP. For RB set k indicated in the bitmap, the first PRB of the frequency domain monitoring location confined within the RB set is given by

$${RB}_{s 0 + k , DL}^{start , μ} + {N}_{RB}^{offset} ,$$

where

$${RB}_{s 0 + k , DL}^{start , μ}$$

is the index of first common RB of the RB set k [6, REF 4], and

$${N}_{RB}^{offset}$$

is provided by rb-Offset or

$${N}_{RB}^{offset} = 0$$

if rb-Offset is not provided. For each RB set with a corresponding value of 1 in the bitmap, the frequency domain resource allocation pattern for the monitoring location is determined based on the first

$${N}_{RBG , set 0}^{size}$$

bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number

$${n}_{s , f}^{μ}$$

REF 1] in a frame with number n_{f} if

$$( {n}_{f} {N}_{slot}^{frame , μ} + {n}_{s , f}^{μ} - {o}_{s} ) {mod k}_{s} = 0 .$$

The UE monitors PDCCH candidates for search space set s for Tₛ consecutive slots, starting from slot

$${n}_{s , f}^{μ}$$

and does not monitor PDCCH candidates for search space set s for the next kₛ-Tₛ consecutive slots. If monitoringSlotsWithinSlotGroup is provided, for search space set s, the UE determines that the slot with number

$${n}_{s , f}^{μ}$$

[REP 1] in a frame with number n_{f} satisfying

$$( {n}_{f} {N}_{slot}^{frame , μ} + {n}_{s , f}^{μ} - {o}_{s} ) {mod k}_{s} = 0 .$$

is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlotsWithinSlotGroup, starting from slot

$${n}_{s , f}^{μ}$$

and does not monitor PDCCH candidates for search space set s for the next kₛ-Tₛ consecutive slots.

A USS at CCE aggregation level L∈{1, 2, 4, 8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

For an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

A UE does not expect to monitor PDCCH candidates on an active DL BWP of a secondary cell if the UE is configured to monitor PDCCH candidates for detection of DCI formats scheduling on that secondary cell in another serving cell. For a serving cell included in MC-DCI-SetofCells, if provided, the UE does not expect to monitor PDCCH candidates on more than one scheduling cell for detection of DCI formats scheduling on the serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value n_{CI} of nCI-Value associated with a set of serving cells MC-DCI-SetofCells, are given by

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where
for any CSS,

$${Y}_{p , {n}_{s , f}^{μ}} = 0 ;$$

for a USS,

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, and D=65537;
i=0, . . . , L−1;
N_{CCE,p} is the number of CCEs, numbered from 0 to N_{CCE,p}−1, in CORESET p and, if any, per RB set
   for CORESET 0, the CCEs are obtained prior to puncturing, if any, of corresponding RBs [REF 1];
n_{CI} is
   the carrier indicator field value, if provided by cif-InSchedulingCell in CrossCarrierSchedulingConfig for the serving cell on which PDCCH is monitored, except for scheduling of the serving cell from the same serving cell in which case n_{CI}=0;
   the n_{CI}-Value provided for the set of serving cells MC-DCI-SetofCells, if MC-DCI-SetofCells is provided;
   otherwise, including for any CSS, n_{CI}=0

$${m}_{s , {n}_{CI}}^{( L )} = 0 , … , {M}_{s , {n}_{CI}}^{( L )} - 1 , where {M}_{s , {n}_{CI}}^{( L )}$$

is the number of PDCCH candidates the UE is configured to monitor for aggregation level L of a search space set s for a serving cell corresponding to n_{CI};
for any CSS,

$${M}_{s , max}^{( L )} = {M}_{s , 0}^{( L )} ;$$

for a USS,

$${M}_{s , max}^{( L )}$$

is the maximum of

$${M}_{s , {n}_{CI}}^{( L )}$$

over all configured n_{CI} values for a CCE aggregation level L of search space set s;
the RNTI value used for n_{RNTI} is the C-RNTI.

If a UE:
is configured to monitor a first PDCCH candidate for a DCI format 0_0 and a DCI format 1_0 from a CSS set and a second PDCCH candidate for a DCI format 0_0 and a DCI format 1_0 from a USS set, where the CSS set and the USS set do not include searchSpaceLinkingId, in a CORESET with index zero on an active DL BWP, and
the DCI formats 0_0/1_0 associated with the first PDCCH candidate and the DCI formats 0_0/1_0 associated with the second PDCCH candidate have same size, and
the UE receives the first PDCCH candidate and the second PDCCH candidate over a same set of CCEs, and
the first PDCCH candidate and the second PDCCH candidate have identical scrambling, and
the DCI formats 0_0/1_0 for the first PDCCH candidate and the DCI formats 0_0/1_0 for the second PDCCH candidate have CRC scrambled by either C-RNTI, or MCS-C-RNTI, or CS-RNTI
   the UE decodes only the DCI formats 0_0/1_0 associated with the first PDCCH candidate.

If a UE detects a DCI format with inconsistent information, the UE discards all the information in the DCI format.

A UE configured with a bandwidth part indicator in a DCI format determines, in case of an active DL BWP or of an active UL BWP change, that the information in the DCI format is applicable to the new active DL BWP or UL BWP, respectively.

In 5G NR the following UE procedures are supported:
Rel-18 LTM based on candidate cells that have always-one SSB,
Rel-19 on-demand SSB only for SCell (not PCell), and
Rel-19 on-demand SIB1 on a PCell with always-on SSB and based on UL WUS from UE (without NW trigger).

The following UE procedures may apply to on-demand SSB on SCells.
PCell with Always-ON SSB (AO-SSB) & SCell without SSB or with AO-SSB
On-demand SSB (OD-SSB) at least for configured SCell: (i) before SCell activation; or (ii) when receiving SCell activation
OD-SSB for SCell is configured by RRC
OD-SSB is activated by RRC or MAC-CE
   OD-SSB is periodically transmitted upon activation
   RRC can configure multiple values for periodicity, and MAC-CE selects one value
OD-SSB can be deactivated by RRC or MAC-CE or based on a configured/indicated number N of OD-SSB bursts
Several combinations for AO-SSB and OD-SSB on SCell
   When AO-SSB is present on SCell, OD-SSB has same or smaller periodicity, and same SSB indexes as AO-SSB
   At least, OD-SSB is an NCD-OD-SSB outside sync raster
L1/L3 P/SP/AP measurement based on OD-SSB

The following apply to Activation/deactivation of SS/PBCH block transmissions on a secondary cell.

A UE can be indicated transmission of first SS/PBCH blocks with frequency location provided by absoluteFrequencySSB on an SCell. The UE can be indicated, by od-ssb-config or by a MAC CE, activation of transmission for second SS/PBCH blocks in a configured DL BWP of the SCell. The UE can be indicated, by a MAC CE, adaptation of parameters for the activated transmission of the second SS/PBCH blocks when the SCell is activated. A number of half frames with transmission of the second SS/PBCH blocks is indicated by a MAC CE from values provided by od-ssb-nrofBurst, if provided; otherwise, the transmission of the second SS/PBCH blocks occurs until it is deactivated by od-ssb-config or a MAC CE, where:
the physical cell identity of the second SS/PBCH blocks is indicated by od-ssb-physCellId, if provided; otherwise, by physCellId in ServingCellConfigCommon
the indexes of transmitted second SS/PBCH blocks are indicated by a MAC CE from candidate values provided by od-ssb-PositionsInBurst, if provided; otherwise, by ssb-PositionsInBurst
the frequency location of the second SS/PBCH blocks is indicated by od-absolute FrequencySSB, if provided; otherwise, by absolute FrequencySSB
the SCS configuration of the second SS/PBCH blocks is indicated by od-ssbSubcarrierSpacing, if provided; otherwise, by ssbSubcarrierSpacing
the power of the second SS/PBCH blocks is indicated by od-ss-PBCH-BlockPower, if provided; otherwise, by ss-PBCH-BlockPower
the periodicity of the transmission of the second SS/PBCH blocks are indicated by a MAC CE from candidate values by od-ssb-Periodicity
the half frames for the transmission of the second SS/PBCH blocks are determined based on an indication by a MAC CE
   the transmission of the second SS/PBCH blocks is in frames with SFN determined from (SFN+SFN_offset)·10 mod P=0, where P is the periodicity for the transmission of the second SS/PBCH blocks, and SFN_offset is the indicated SFN offset by the MAC CE from candidate values by od-ssb-sfn-Offset, if provided; else, SFN_{offset}=0. An index of a half frame with transmission of the second SS/PBCH blocks in a corresponding frame is indicated by the MAC CE from candidate values by od-ssb-halfFrameIndex, if provided; else the index is 0

When the activation or adaptation of the second SS/PBCH blocks transmission is by a MAC CE, respectively, and with reference to slots for PUCCH transmission, the UE expects that the transmission of the second SS/PBCH blocks according to the indicated parameters starts from a first slot including the candidate SS/PBCH block occasion corresponding to the first transmitted second SS/PBCH block index and located in a first half frame within the half frames for the transmissions of the second SS/PBCH blocks, that is at least

$$m + 3 {N}_{slot}^{subframe , μ} + 1$$

slots after slot n, where n is a slot when a PDSCH reception providing the MAC CE ends, respectively, n+m is a slot indicated for PUCCH transmission with HARQ-ACK information for the PDSCH reception as described in clause 9.2.3, and

$${N}_{slot}^{subframe , μ}$$

is a number of slots per subframe for the SCS configuration μ of the PUCCH transmission as defined in.

When the deactivation of the second SS/PBCH blocks transmission is by a MAC CE, and with reference to slots for PUCCH transmission, the UE expects that the transmission of the second SS/PBCH blocks according to the indicated parameters terminates from the end of:
a slot n+T, if the slot n+T is not within a first slot to a last slot with activated transmission of second SS/PBCH blocks in a half frame, where

$$T = m + 3 {N}_{slot}^{subframe , μ} + 1 ,$$

n is a slot when a PDSCH reception providing the MAC CE ends, n+m is a slot indicated for PUCCH transmission with HARQ-ACK information for the PDSCH reception as described in clause 9.2.3, and

$${N}_{slot}^{subframe , μ}$$

is a number of slots per subframe for the SCS configuration u of the PUCCH transmission as defined in.

the first slot including the candidate SS/PBCH block corresponding to the index of the last transmitted second SS/PBCH block that is not earlier than the slot n+T, if the slot n+T is within a first slot to a last slot with activated transmission of second SS/PBCH blocks in a half frame.

When the UE is not provided absoluteFrequencySSB for the SCell, the UE does not expect the transmission of the second SS/PBCH blocks provided by od-ssb-config to be deactivated while the SCell is activated.

When the first SS/PBCH blocks in a configured DL BWP can be used to obtain SIB1 and the frequency location of the first SS/PBCH blocks corresponds to the GSCN of a synchronization raster entry, the UE expects
a frequency location of the second SS/PBCH blocks to be different from the frequency location of the first SS/PBCH blocks and not to correspond to the GSCN of a synchronization raster entry
frequency resources of the second SS/PBCH blocks not to overlap with frequency resources of the first SS/PBCH blocks
the second SS/PBCH blocks to be within the configured DL BWP as the first SS/PBCH blocks
the second SS/PBCH blocks are not used to obtain SIB1.

When the first SS/PBCH blocks in a configured DL BWP cannot be used to obtain SIB1, the UE expects
a same frequency location for the second SS/PBCH blocks and for the first SS/PBCH blocks,
a same PBCH payload, other than the SFN index and the half frame index, for a first SS/PBCH block, from the first SS/PBCH blocks, and for a second SS/PBCH block, from the second SS/PBCH blocks, with same SS/PBCH block index as the first SS/PBCH block.

The UE may assume that a first SS/PBCH block from the first SS/PBCH blocks and a second SS/PBCH block from the second SS/PBCH blocks are quasi co-located with respect to Doppler shift, Doppler spread, average gain, average delay, delay spread and, when applicable, spatial RX parameters, when they have a same SS/PBCH block index.

The UE may assume that SS/PBCH blocks from the second SS/PBCH blocks are quasi co-located with respect to Doppler shift, Doppler spread, average gain, average delay, delay spread and, when applicable, spatial RX parameters, when they have a same SS/PBCH block index.

The following UE procedures may apply to on-demand SIB1 on PCell (for example, in IDLE/INACTIVE mode):
Cell A with always-ON SSB (AO-SSB) & periodic SIB1
NES Cell with AO-SSB & on-demand SIB1 (OD-SIB1)
   One or multiple NES Cells
   AO-SSB on NES Cell is inaccessible for initial access of UEs: either of sync raster, or on sync raster with “invalid/OOR” k_SSB
   Identification of NES cell based on UL WUS config on Cell A
UL WUS config from Cell A; transmit UL WUS to NES Cell; receive RAR & OD-SIB1 from NES Cell
   Beam for UL WUS & PDCCH/PDSCH of OD-SIB1 based on SSB
   The RACH resource association with AO-SSB on NES Cell
   UL WUS is [CFRA]; No repetition; no use for establishing RRC
RAR reception on NES Cell in response to UL WUS
   CORESET #0 of NES Cell for RAR reception
   Separate SS for RAR provided by UL WUS; otherwise SS #0
OD-SIB1 reception on NES Cell
   CORESET #0/ SS #0 config provided by UL WUS when SSB of NES Cell is on sync raster (k_SSB is then assumed invalid/OOR)
   Time window for monitoring PDCCH of OD-SIB1; starting from the start of RAR window, with offset/duration provided by UL WUS config
   PDCCH MO for OD-SIB1 is associated with SSB used for UL WUS

The following applies to UE procedure to request SIB1 reception, wherein the higher layer parameters are provided by SIB1-RequestConfig on a first cell.

A UE can be provided, by NES_CellId, a physical cell identity of a second cell and an ARFCN by ARFCN-ValueNR for SS/PBCH block receptions on the second cell. When
the UE receives an SS/PBCH block on the second cell, and
k_{SSB}>23 for FR1 or k_{SSB}>11 for FR2 is indicated by the SS/PBCH block on the second cell, and
conditions for PRACH transmission associated with the SS/PBCH block on the second cell are satisfied,
   the UE is not required to monitor PDCCH on the second cell to detect the DCI format 1_0 with CRC scrambled by the SI-RNTI and can transmit a PRACH associated with the SS/PBCH block on the second cell based on:
a timing adjustment indicated by n-TimingAdvanceOffset, if provided,
a power
a procedure based on Type-1 random access procedure
   where k_{SSB} for determining the common resource block is provided by k-ssb.

In response to the PRACH transmission, the UE monitors PDCCH on the second cell to detect a DCI format 1_0 with CRC scrambled by a corresponding RA-RNTI during a window controlled by ra_Response Window. The UE monitors PDCCH according to a Type1-PDCCH CSS set provided by ra-SearchSpace, if provided; else provided by SearchSpaceZero in a CORESET provided by controlResourceSetZero.

If the higher layers at the UE identify a RAPID associated with a corresponding PRACH transmission from the UE in a PDSCH reception scheduled by the DCI format 1_0 with CRC scrambled by the RA-RNTI, the higher layers indicate to the physical layer to monitor PDCCH on the second cell to detect a DCI format 1_0 with CRC scrambled by the SI-RNTI according to a Type0-PDCCH CSS set provided by SearchSpaceZero. If the UE is provided sib1-pdcchRestrictionToPRACHAssociatedSSBs, the UE monitors PDCCH only in monitoring occasions associated with the SS/PBCH block; otherwise, the UE assumes that PDCCH is transmitted in at least one PDCCH monitoring occasion corresponding to each transmitted SSB. The UE monitors PDCCH to detect the DCI format 1_0 with CRC scrambled by the SI-RNTI after a number of slots provided by od-sib1-windowStartOffset from the start of the first slot of the window controlled by ra_ResponseWindow, and for a number of slots provided by od-sib1-Window Duration.

After the PRACH transmission, the UE is not required to monitor PDCCH on the second cell to detect the DCI format 1_0 with CRC scrambled by the SI-RNTI prior to a reception of a PDSCH providing a RAPID associated with a corresponding PRACH transmission scheduled by the DCI format 1_0 with CRC scrambled by the RA-RNTI.

The following UE procedures may apply to L1/L2-triggered mobility (LTM):
Configure candidate cells and SSB per candidate cell
Prep: DL Synchronize; beamform (activated TCI/PL); and early TA acquisition for candidate cells
   Same TA as serving cell, or N_TA=0 (no early TA)
   Cell switch command to indicate valid TA (no early TA)
   Early TA via PDCCH-ordered PRACH→no RAR; candidate cell informs the serving cell, and serving cell indicates the TA in the Cell Switch command
   Early TA via (RRC-enabled) UE-based TA measurement
Measure and report LTM CSI (L1-RSRP)
   reporting for up to 4 cells, up to 4 SSBs per cell
Receive LTM Cell Switch Command MAC CE
   Indicates an LTM candidate configuration, TCI
   Indicates a Valid TA or no valid TA
Access the target cell
   RACH-based LTM: if no valid TA in Cell Switch command
   RACH-less LTM: if valid TA is provided; use CG or DG

The following applies to L1/L2-triggered mobility (LTM) procedures.

A UE can be indicated, by LIM-Config, candidate cells and SS/PBCH blocks or CSI-RS resources per candidate cell for the UE to obtain synchronization and/or measure corresponding L1-RSRPs. A Candidate Cell TCI States Activation/Deactivation MAC CE can activate TCI states, provided by CandidateTCI-State or/and CandidateTCI-UL-State, associated with SS/PBCH blocks, or CSI-RS resources in a CSI-RS resource set configured with repetition, or TRS of corresponding candidate cells. The RS index for obtaining the candidate cell downlink pathloss estimate is provided by pathlossReferenceRS-Id in the CandidateTCI-State or Candidate TCI-UL-State. If the Candidate Cell TCI States Activation/Deactivation MAC CE activates TCI states, an LTM Cell Switch Command MAC CE can indicate a TCI state from the activated TCI states; otherwise, the LTM Cell Switch Command MAC CE can activate and indicate a TCI state, provided by Candidate TCI-State or/and CandidateTCI-UL-State. After reception of the LTM Cell Switch Command MAC CE, activated TCI states that are not indicated by the MAC CE are deactivated. The UE is provided configurations by ltm-CSI-ReportConfigToAddModList for reporting L1-RSRP measurementsthat include a number of candidate cells and a number of SS/PBCH blocks or CSI-RS resources per candidate cell from the number of candidate cells.

If ltm-UE-MeasuredTA-ID of a candidate cell and Itm-ServingCellUE-MeasuredTA-ID of the serving cell are provided to a UE and have same value, the UE estimates based on the UE implementation a timing advance to apply from a first transmission on the candidate cell that is after the reception of a cell switch command for the candidate cell when a predetermined condition is satisfied.

A UE can be provided configurations, by EarlyUL-SyncConfig, for PRACH transmission parameters for each of the candidate cells. The UE can be triggered a PRACH transmission on a candidate cell by a PDCCH order that the UE receives on a serving cell and includes an indication of the candidate cell for the PRACH transmission. If the serving cell and the candidate cell operate in a same frequency range and the UE would have transmissions that overlap in time, or that are in a same slot with respect to the smallest SCS configuration between the SCS configuration for the UL BWP with the PRACH and the SCS configuration for the UL BWP with the PUSCH/PUCCH/SRS transmissions when the serving cell and the candidate cell operate in a same frequency band, or when a gap between a first or last symbol of a PRACH transmission to the candidate cell is less than N symbols from a last or first symbol, respectively, of an UL transmission to the serving cell, the UE
drops the transmissions on the serving cell when the UE does not support transmissions that overlap in time, or are in the same slot when the serving cell and the candidate cell operate in a same frequency band, or are separated by less than the gap on the serving cell and the candidate cell and the UL transmission to the serving cell is other than a RACH Msg 1, Msg A, or Msg 3 transmission.
prioritizes power allocation to the PRACH transmission on the candidate cell when the UE supports transmissions that overlap in time or are separated by less than the gap, and a total UE transmit power in the frequency range would exceed PCMAX.

The UE transmits the PRACH on the candidate cell with a power.

A UE can be provided by an LTM Cell Switch Command MAC CE in a PDSCH reception on the serving cell a TCI state ID and/or an UL TCI state ID indicating a Candidate TCI-State and/or Candidate TCI-UL-State from Itm-DL-OrJointTCI-State ToAddModList and/or Itm-UL-TCI-State ToAddModList for applicable receptions or transmissions on a candidate cell from the number of candidate cells. The UE may assume that DM-RS antenna ports for PDCCH receptions and for PDSCH receptions are quasi co-located either with the SS/PBCH block or the TRS in the TCI state with respect to quasi co-location ‘typeA’ and ‘typeD’ properties, when applicable, or with the TRS and the CSI-RS resources in the CSI-RS resource set configured with repetition in the TCI state with respect to quasi co-location ‘typeA’ and ‘typeD’ properties, respectively, when applicable.

The UE does not expect to be indicated quasi co-location ‘typeA’ properties when a SS/PBCH block is configured as a source RS of the TCI state. The UE applies the Candidate TCI-State and/or CandidateTCI-UL-State, if indicated by the MAC CE, no later than T_{LTM-RRC-processing}+T_{LTM-processing}+T_{first-RS}+T_{RS-proc}+3 msec after the last symbol of a PUCCH or PUSCH with HARQ-ACK information for the PDSCH providing the MAC CE, where T_{LTM-RRC-processing}, T_{LTM-processing}, T_{first-RS} and T_{RS-proc} are defined in [TS 38.133]. For RACH-based LTM cell switch, the UE applies the Candidate TCI-State for receptions on the candidate cell, and applies a spatial domain filter corresponding to the Candidate TCI-State or the CandidateTCI-UL-State for transmissions on the candidate cell, that are after the completion of the random access procedure associated with the PRACH transmission on the candidate cell and before a new TCI state is applied for the candidate cell. For RACH-less LTM cell switch, the UE applies the Candidate TCI-State for receptions on the candidate cell and applies a spatial domain filter corresponding to the CandidateTCI-State or the CandidateTCI-UL-State for transmissions on the candidate cell before a new TCI state is applied for the candidate cell.

The following applies to Configured-grant PUSCH transmission in RACH-less LTM cell switch.

A UE configured to perform PUSCH transmission in RACH-less LTM cell switch can be provided one or more configurations by respective one or more ConfiguredGrantConfig, for configured grant Type 1 PUSCH transmissions on the active UL BWP. For the remaining of this clause, PUSCH transmissions refer to configured grant Type-1 PUSCH transmissions for a configuration provided by ConfiguredGrantConfig.

A UE can be provided by rrc-SSB-Subset in cg-LTM-Configuration a number of SS/PBCH block indexes

$${N}_{PUSCH}^{SS / PBCH}$$

to map to a number of valid PUSCH occasions for PUSCH transmissions over an association period. If the UE is not provided rrc-SSB-Subset in cg-LTM-Configuration, the UE determines

$${N}_{PUSCH}^{SS / PBCH}$$

from the value of ssb-PositionsInBurst in ServingCellConfigCommon. A PUSCH occasion for a PUSCH transmission is defined by a time resource and a frequency resource and is associated with a DM-RS provided by cg-DMRS-Configuration for the configuration of PUSCH transmissions. A UE can be provided a number of repetitions for a PUSCH transmission by repK or numberOfRepetitions. If the number of repetitions is provided and larger than 1, all the PUSCH occasions of the repetitions for the PUSCH transmission are mapped to the same SS/PBCH block index(es). For the initial transmission or autonomous retransmission of an initial transport block provided for PUSCH transmission, the UE encodes the transport block using redundancy version number 0 if the UE is not provided repK-RV.

An association period, starting from frame with SFN 0, for mapping

$${N}_{PUSCH}^{SS / PBCH}$$

SS/PBCH block indexes, from the number of SS/PBCH block indexes, to valid PUSCH occasions and associated DM-RS resources is the smallest value in the set determined by the PUSCH configuration period provided by periodicity in ConfiguredGrantConfig such that

$${N}_{PUSCH}^{SS / PBCH}$$

SS/PBCH block indexes are mapped at least once to valid PUSCH occasions and associated DM-RS resources within the association period. A UE is provided a number of SS/PBCH block indexes associated with a PUSCH occasion and a DM-RS resource by rrc-SSB-PerCG-PUSCH in cg-LIM-Configuration. If after an integer number of SS/PBCH block indexes to PUSCH occasions and associated DMRS resources mapping cycles within the association period there is a set of PUSCH occasions and associated DMRS resources that are not mapped to

$${N}_{PUSCH}^{SS / PBCH}$$

SS/PBCH block indexes, no SS/PBCH block indexes are mapped to the set of PUSCH occasions and associated DMRS resources. An association pattern period includes one or more association periods and is determined so that a pattern between PUSCH occasions with associated DMRS resources and SS/PBCH block indexes repeats at most every 640 msec. PUSCH occasions and associated DMRS resources not associated with SS/PBCH block indexes after an integer number of association periods, if any, are not used for PUSCH transmissions.

Each N of

$${N}_{PUSCH}^{SS / PBCH}$$

SS/PBCH block indexes in increasing order are mapped to valid

PUSCH occasions and associated DMRS resources in the following order:
first, in increasing order of DMRS resource indexes within a PUSCH occasion, where a DMRS resource index DMRS_{id} is determined first in an ascending order of a DMRS port index and second in an ascending order of a DMRS sequence index
second, in increasing order of PUSCH configuration period indexes where N is provided by rrc-SSB-PerCG-PUSCH in cg-LTM-Configuration.

A PUSCH occasion is valid if it does not overlap with a valid PRACH occasion.

For unpaired spectrum and for SS/PBCH blocks with indexes provided by rrc-SSB-Subset in cg-LTM-Configuration, or ssb-PositionsInBurst in ServingCellConfigCommon if rrc-SSB-Subset is not provided
if a UE is provided tdd-UL-DL-ConfigurationCommon, a PUSCH occasion is valid if the PUSCH occasion
   is within UL symbols
   starts at least N_{gap} symbols after a last downlink symbol, and at least N_{gap} symbols after a last SS/PBCH block symbol, where N_{gap} is provided in a predetermined Table

If the UE is provided cg-LTM-Configuration, the UE performs configured grant Type 1 PUSCH transmission on the valid PUSCH occasions associated with the SS/PBCH block indexes same as the SS/PBCH block indexes provided by or associated with QCL RS of the Candidate TCI-State or Candidate TCI-UL-State indicated by the LTM Cell Switch Command MAC CE.

A UE determines a power of a PUSCH transmission, where the UE obtains PLb,f.c (qa) using a RS resource from pathlossReferenceRS-Id included in the Candidate TCI-State or Candidate TCI-UL-State indicated by the LTM Cell Switch Command MAC CE.

Based on the above, there may be a need for the following:
to enable NES based on NW trigger,
to enable mobility/LTM based on NES cells (such as cells without periodic SSB, and with only on-demand SSB or discovery signal such as DL WUS, for example, sequence-based DL WUS).

The following may be considered:
SSB activation on a cell based on NW decision, after UE reporting of OD-SSB measurements
   Connected mode UE
   OD-SSB on SCell
   OD-SSB on PCell—no-mobility offloading via multi-cell NES (also, for mobility)
For Initial Access and/or IDLE/INACTIVE mode UE
   OD-SSB for PCell—for cell reselection via multi-cell NES
   OD-SSB for PCell—for initial access via single-cell NES
Different modes of UE involvement are provided
   No UL WUS, wherein the NW decision/trigger for SSB transmission is not in response to UL WUS transmission from UE(s);
   UL WUS after NW trigger

The present disclosure provides methods and apparatus for mobility or cell selection/reselection/addition in association with network energy saving (NES), and for NES operations, such as on-demand signals or channels to be based on network (NW) trigger.

The methods are motivated by network energy saving, mobility enhancements, multi-cell or multi-carrier enhancements.

The embodiments may apply to any deployments, verticals, or scenarios including in FR1, FR2 (or FR2-1), FR3, FR4 (or FR2-2), with eMBB, URLLC and IIoT, mMTC and IoT including LTE BS-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multicast broadcast services (MBS), with integrated sensing and communication (ISAC) operation, and so on.

Embodiments of the disclosure are summarized in the following and are fully elaborated further below. Combinations of the embodiments are also applicable but are not described in detail for brevity.

Various embodiments, method, or examples throughout the present disclosure are described with respect to certain settings, such as “SSB”, or “cells” or “SSB-less cells” and so on.

Such embodiments, methods, and examples can also apply for broader settings without restriction to such attributes.

Various embodiments, methods and examples are described in terms of SSB. Such embodiments, methods and examples can apply to other signals or channels, including different anchor signals or essential channels, or different reference signals (RS), such as a simplified/light SSB, for example, only PSS, or only PSS/SSS without PBCH, or an SSB constructed with different sequences, or low-power variations based on different waveforms such as LP-SS or LP-WUS based on OOK or FSK or PSK, or a new synchronization signal such as 6GR Sync Signal, or a discovery signal, such as a sequence-based DL WUS, or a CSI-RS, or an SRS, or a TRS, or a PRS, and so on.

Various embodiments, methods and examples are described in terms of cells without SSB transmission (e.g., SSB-less cell) and cells with SSB transmission (e.g., SSB-cells). Such embodiments, methods and examples, can also apply to various cells in general, regardless of transmission or no transmission of SSB or other (anchor) signal or (essential) channel/information. For example, one or more of: reception of system information (MIB/SIB1/OSI) or SI update or paging or RACH/RAR or RRM/RLF/BFR measurements for a cell such as a primary/camped cell from a different cell including non-primary/non-serving/non-camped cell, as subsequently described, can also apply when the primary/camped cell transmits SSB. For example, similar methods can apply to SIB1-less cells.

Various embodiments, methods and examples are described in terms of cells, using terms such as a primary cell (PCell) and a secondary cell (SCell). The notion of a primary cell (PCell), and consequently of a secondary cell (SCell), is not necessary for the embodiments of the disclosure and is only used for brevity to denote associated cell functionalities at a given time, wherein a cell providing those functionalities can change based on L1/L2 signaling. Such cell functionalities can include one or more of: receiving NAS signaling or messages, or receiving higher layer signaling or messages, such as system information or paging or other broadcast or groupcast messages or signals or channels. For example, the UE can be configured or indicated to receive such functionalities on any cell from the configured cells, or on more than one cell including all serving cells, or possibly by one or more non-serving cells. For example, L1/L2 signaling indicate or update the corresponding one or more cells. For example, such functionalities can be distributed across different cells. For example, the UE can be configured or indicated that first functionalities are provided on first one or more cells, and second functionalities are provided on second one or more cells. Various embodiments, methods and examples may also apply regardless of any association of cells with any such functionalities.

Various embodiments, methods and examples are described in terms of different cells, such as a first cell and a second cell. Such embodiments, methods and examples, can also apply when replacing ‘cells’ with different frequency-domain notions or entities, such as carriers, BWPs, sub-bands, bands, band combinations, cell/carrier combinations, and so on, or with different network entities such as TRPs, RUs, DUs, CUs, AUs, RRHs, and so on, including various physical or virtual or architectural entities, such as those considered or supported in open-RAN (O-RAN). For example, such methods can apply to a first carrier/BWP/sub-band/band and a second carrier/BWP/sub-band/band of a same cell, wherein a UE/gNB can operate in both the first carrier/BWP/sub-band/band of the cell and the second carrier/BWP/sub-band/band of the cell at same/overlapping times, or at different/separate times. For example, such methods can apply to multi-carrier single-cell (i.e., a cell that operates on multiple frequency carriers/bands/ranges).

In the present disclosure, handover/LTM/cell reselection for CONNECTED mode UEs to cells without periodic SSB and with network-triggered on-demand discovery RS is provided.

In one embodiment, an RRC_CONNECTED mode UE can operate on a first cell, such as an anchor cell or a primary cell (PCell), with a (possibly periodic) anchor signal, such as a periodic discovery RS/DL WUS or a periodic SSB or variants thereof, and the UE can be triggered to perform handover or mobility, including L1/L2-triggered mobility (LTM), to a second cell without a periodic anchor signal, such as no periodic discovery RS/DL WUS or no periodic SSB or variants thereof. The second cell can transmit an aperiodic or on-demand discovery/measurement RS, such as an on-demand SSB or variants thereof, that is initiated by a first NW trigger, such as a DCI or a MAC CE, to facilitate corresponding UE measurement and reporting. The UE can perform handover or cell reselection based on a second/different NW trigger that can follow/be in response to such measurements reporting by the UE of the respective discovery/measurement RSs on the configured list of NES cells.

The second cell can be from a list of candidate cells, for example referred to as a list of candidate NES cells, that are configured to the UE by higher layers, while the first cell can also be referred to as a “Cell A”. The second/NES cell can be non-collocated with the first cell (Cell A), thereby be associated with a UE mobility/LTM procedure, or can be collocated with the first cell (Cell A), thereby supporting an offloading/cell reselection operation from the first cell/Cell A to the second/NES cell that can be in the same frequency band/range as, or in a different frequency band/range than, the first cell/Cell A.

The measurements can be based on information provided to a UE for candidate NES cells, discovery/measurement RS associated with the candidate NES cells, a transmission power for the discovery/measurement RS, and so on. Corresponding RS measurement information from the UE can include a subset of {PCI, on-demand SSB index, RSRP} such as for a predetermined or configured number M of largest RSRP measurements. In this disclosure, discovery RS (DRS) index or, in general, RS index, can be used instead of on-demand SSB index. Additionally, or alternatively, the measurement can be related to absolute or relative location of UE, such as whether the UE is within a certain distance from a certain candidate NES cell, that can be based on reception of the discovery/measurement RS or based on geographical information of the respective candidate NES cell. Additionally, or alternatively, the UE can report pathloss (PL) measurement results based on the OD-SSB/OD-RS on the candidate NES cells.

The UE can transmit such measurement reports on resources, such as PUCCH or PUSCH resources, that are configured by higher layers or indicated by DCI/MAC CE via the second NW trigger (that indicates cell reselection or handover), or using Msg3/MsgA PUSCH that is associated with a Msg1/MsgA PRACH used for early TA/TCI/PL-RS determination, as subsequently described.

Upon transmission of such measurement reports, the UE may stop receiving or measuring the on-demand discovery RS on the candidate cells, or upon transmission of such measurement report, the gNB may stop transmitting the on-demand discovery RS on the candidate cells, with or without any indication or signaling to the UE, possibly including UE/gNB processing time.

Either or both of the first NW trigger for indicating to a UE transmission and associated measurements for discovery/measurement RS on the list of NES cells (or a subset thereof) and the second NW trigger for indicating to the UE a cell reselection or mobility to the second/NES cell can be based on a group-common DCI format, or a cell-specific DCI format, such as a DCI format with associated PDCCH that the UE monitors according to a common search space, a UE-specific DCI format such as a DCI format with associated PDCCH that the UE monitors according to a UE-specific search space, or a MAC-CE command. The second NW trigger for handover or cell re-selection to the second/NES cell (for example, as a new PCell for the UE) can also imply or indicate activation of transmission for a periodic signal, such as periodic SSB, on the second cell.

In order to perform handover or cell reselection to the second/NES cell, the UE may perform UL preparation procedures, such as early UL synchronization or early TA acquisition, TCI or pathloss determination, and so on.

Regardless of whether the UE procedure involves mobility to a non-collocated cell or only cell reselection to a collocated cell, the second NW trigger can provide similar information as a mobility trigger (such as an LTM Cell Switch command MAC CE), for example one or more of: information of the candidate NES cell (for example, cell index or configuration index), timing advance (TA) information, spatial relation information such as DL/UL/joint TCI state ID or QCL assumption information, and possibly information of (contention-based or contention-free) random access at least for the case of RACH-based cell reselection.

Alternatively, handover/cell reselection can be using a RACH-less method, such as by using a CG PUSCH configured by higher layers or using a PUSCH that is scheduled by the second NW trigger or by a separate PDCCH/DCI format.

In the present disclosure, network determination to activate on-demand discovery RS on candidate NES cells with or without UE request (UL WUS) is provided.

In one realization of the above embodiment, the gNB can transmit the first NW trigger (that activates the on-demand measurement/discovery RS on the list of candidate NES cells, or a subset thereof) based on NW implementation, such as when the gNB determines that the first cell/Cell A is congested by many UEs and an offloading of UEs from Cell A would be beneficial.

In another realization of the above embodiment, the gNB may transmit the first NW trigger in response to a UE request, such as a PRACH or other UL wake-up signal (UL WUS). For example, the UE may determine that it is in poor coverage in Cell A and transmit an UL WUS to initiate a procedure for finding a cell with good coverage. A configuration for the PRACH/UL WUS can be provided by the first cell/Cell A. The UE may transmit the PRACH/UL WUS on the Cell A or on a candidate NES cell, such as the second/NES cell. The PRACH/UL WUS transmission can be enabled or disabled by the network, such as by higher layer configuration, or by a network trigger, for example, jointly by a third NW trigger that is before the first NW trigger, [or the third NW trigger can be same as the first NW trigger].

In one example, a UE can transmit UL WUS on/for/towards a candidate NES cell (or an indicated NES cell) in order for the NES cell to subsequently respond to it. For example, the UE may determine the NES cell based on its location and information for the NES cell can include its coordinate when the PCI is configured.

In one example, When the first and third NW triggers are separate, the first NW trigger can be considered as a random access response (RAR) that is associated with a PRACH/UL WUS transmission that is initiated by the third NW trigger.

In the present disclosure, network-triggered activation of SCells based NW-triggered UE measurements of on-demand discovery RS with or without UE request (UL WUS) is provided.

In one embodiment, an RRC_CONNECTED UE that operates on a first cell, such as an anchor cell or a primary cell (PCell), can be configured a number of candidate non-serving cells (or possibly serving cells) without any [periodic] anchor signal transmission, such as no periodic discovery signal or no periodic SSB transmission. The UE can also be configured properties and resources for aperiodic or on-demand discovery RS reception, such as on-demand SSB or variants thereof, on each candidate cell. A first NW trigger, such as one provided by a DCI format or a MAC-CE command, can indicate transmission of discovery RS on the candidate cells (or a subset thereof). The first NW trigger can also indicate UE measurement and reporting based on the on-demand discovery RS receptions. A second NW trigger, such as one provided by a DCI format or a MAC-CE for SCell activation or a new MAC-CE, may indicate selection and activation of one (or some) of the candidate cells as non-anchor or secondary cells (SCells) for the UE, possibly based on the UE measurement reports.

This method differs from the above embodiment in the following:
The second cell serves as an SCell that is added/activated for the UE, instead of a new PCell for the UE in a handover or cell reselection procedure.
A RACH-based method for addition/activation of a candidate cell as an SCell may not be applicable, and the UE may receive corresponding information, such as TA value or TCI state, for such SCell as higher layer configuration or via L1/L2 signaling, that is same as or separate from the second NW trigger that selects and activates a candidate cell as an SCell for the UE; For example, a UE may be indicated or the UE may determine a respective TA based on a corresponding TAG, such as whether a candidate NES cell (or an indicated NES cell) is collocated or non-collocated with the Cell A. Similar methods can apply to TCI state determination or indication.
The second NW trigger can be a MAC-CE for SCell activation, or a variant thereof (or can be a second GC-DCI format).

This method is different from other procedures in 5G NR for SCell addition/activation (including for triggering on-demand SSB on SCell) in that:
The first NW trigger can indicate or imply that transmission/reception of on-demand discovery RS on the candidate cells stops after reception/transmission of corresponding measurement reports, possibly including UE/gNB processing time.
The second NW trigger can imply or indicate activation of periodic SSB or another on-demand RS/SSB on the selected candidate cell (that is, the new SCell).
The method can include preparation procedures, such as early UL synchronization or early TA, or identification of TCI/pathloss RS, for the configured list of candidate cells or for the one or more selected candidate cells before activation as SCell(s). For example, TA, or TCI state or pathloss RS can be based on the SSB of the Cell A or based on the on-demand RS on the candidate NES cell.

In one implementation of the above embodiment, triggering on-demand discovery RS on the candidate cells can be based on gNB implementation, such as when the gNB determines increased load on the PCell.

In another implementation of the above embodiment, triggering on-demand discovery RS on the candidate cells can be based on a UE request, such as UL WUS, that can be configured on the PCell or can be enabled/activated by a third NW trigger, such as an L1/L2 signaling, that can also possibly be considered as a group-PDCCH order. For example, the UE may determine poor coverage conditions for Cell A, such as RSRP below a threshold that can be indicated by Cell A, and request to find and connect to a new cell. The UE may transmit UL WUS on the PCell or on the candidate cell, for example, based on RSRP measurements of the SSB on the PCell or based on UE location, such as when the UE is within a certain distance from the NES cell. For example, in addition to other parameters such as the PCI, a configuration of NES cells can include corresponding locations. Accordingly, the first NW trigger (for initiating on-demand discovery RS on such candidate cells) can be in response to UL WUS transmission by the UEs, and a RAR in response to the UL WUS/PRACH may or may not be present.

In the present disclosure, cell reselection for INACTIVE/IDLE mode UEs to cells without periodic SSB/DRS and with network-triggered on-demand discovery RS is provided.

In one embodiment, a UE in INACTIVE/IDLE state that camps on a first cell with an anchor signal, such as a transmission of a periodic discovery signal or periodic SSB or variants thereof, can acquire from system information a configuration for a list of candidate NES cells without transmission of a periodic anchor signal, such as no periodic discovery RS or no periodic SSB or variants thereof, while having configurations for properties and resources of respective on-demand discovery signals, such as on-demand SSB or TRS or variants thereof.

The UE can be informed by higher layers or using a DCI format such as a first cell-specific DCI format, for example, a paging DCI format or a DCI format for PEI or for Cell DTX/DRX or the like, that such on-demand discovery RSs are activated on the candidate NES cells, or a subset thereof. Upon reception of such NW trigger, the UE measures the on-demand discovery RSs to obtain, for example, respective RSRPs and pathloss values, on the indicated candidate NES cells.

In one realization, the NW trigger (that initiates the on-demand discovery RS on the candidate NES cells) can be based on gNB implementation, for example, based on cell load due to one or more of: CONNECTED mode UEs in the cell; INACTIVE mode UEs that are in a RAN notification area that includes the cell; or IDLE mode UEs that are in a CN tracking area that includes the cell.

In another realization, the NW trigger can be in response to a UE request, such as first UL WUS from one or more UEs, for example PRACH transmission from INACTIVE/IDLE UEs or possibly a RACH-based PUSCH transmission or CG PUSCH based transmission, if provided, for INACTIVE UEs. The first UL WUS transmission can be enabled or disabled by higher layers such as by system information (SIB) or by L1/L2 signaling such as a second cell-specific DCI format for paging/PEI/Cell-DTX-DRX. The UE can transmit the first UL WUS on the first/camped cell, or on a candidate NES cell at least after a corresponding discovery RS transmission. Conditions for transmission of the first UL WUS, if any, can be as previously described in the above embodiment.

The method can then proceed as follows:
For an INACTIVE mode UE that is provided a reporting configuration, such as SDT or SDT-like resources, for example, RACH-based PUSCH resources or CG PUSCH based resources, and has a valid TA value on the first/camped cell:
   The UE transmits a PUSCH on the camped cell that includes the measurement reports.
   In another method, the UE may not be configured SDT-like PUSCH resources, and can be configured a set of PRACH resources (e.g., ROs, PRACH preambles, and so on) by higher layer configuration such as SIB, wherein the set of PRACH resources can be associated with the candidate NES cells. For example, upon NW trigger, the UE can transmit PRACH on one or more PRACH resources, from the set of PRACH resources, to indicate that the UE measurements corresponding to one or more NES cells are greater than a predetermined or higher layer configured threshold.
   In response to reception of the UE measurement report, the gNB may initiate/activate a periodic discovery signal, such as periodic SSB or periodic TRS or variants thereof, on a second candidate NES cell, from the configured list of candidate NES cells. The gNB may indicate such activation to the UE using a UE-specific DCI format or using a third cell-specific DCI format, such as a third DCI format for paging/PEI/Cell-DTX-DRX.
   The INACITVE mode UE may (autonomously decide to) reselect to the second candidate NES cell based on procedures for cell reselection, such as UE measurements or measurement events or other mobility/cell reselection UE procedures. Such measurements for cell reselection can be based on the aforementioned measurements of the on-demand discovery RS, or based on measurements of the newly activated periodic RS/SSB/TRS, or based on a combination of measurements of both the on-demand RS and the periodic RS.
For an INACTIVE mode UE that is not provided resources for such measurement reporting, or for an INACTIVE mode UE that has an invalid TA value (e.g., corresponding TA timer has expired), or for an IDLE mode UE:
   The UE does not report measurements of the on-demand discovery RS associated with candidate NES cells that are triggered/indicated by the first cell-specific DCI format;
   The UE identifies a second candidate NES cell, from the indicated candidate NES cells, for reselection based on the measurements of on-demand discovery RS, for example, using procedures for cell reselection;
   The UE transmits a second UL WUS, such as a PRACH, on the first/camped cell or on the second candidate NES cell to request for activation of periodic RS, such as periodic SSB or TRS, or to request SIB transmission on the second candidate NES cell. The UE acquires configuration information for the UL WUS from the first/camped cell, including different UL WUS configurations for different candidate NES cells;
   In response to reception of the second UL WUS, the gNB may initiate/activate transmission of a periodic RS, such as periodic SSB or periodic TRS or variants thereof, or of a SIB, on the second candidate NES cell. The gNB may indicate such activation to the UEs camped on the first cell using a third cell-specific DCI format, such as a third DCI format for paging/PEI/Cell DTX-DRX or the UE may autonomously attempt corresponding receptions on the NES cell.
   The INACTIVE/IDLE mode UE may (autonomously decide to) reselect to the second candidate NES cell based on previous measurements of the on-demand discovery RS, such as for RSRP or pathloss, or the UE may determine whether or not to (autonomously) reselect to the second candidate NES cell based on measurements of the newly activated periodic RS/SSB/TRS, or based on a combination of measurements of both the on-demand RS and the periodic RS.

In the present disclosure, initial access to a cell without periodic SSB and with network-triggered on-demand discovery RS is provided.

In one embodiment, same methods as in the above embodiment, such as those described for IDLE mode UEs, can also apply to a UE that is performing initial access, except that the first cell is not a camped cell, is instead a cell that the UE identified during a cell search procedure, and the UE has acquired the corresponding system information. Before camping on the first cell (referred to as “cell A”), the UE measures discovery RSs associated with a list of NES cells that are provided/indicated by system information of Cell A. Transmission of discovery RSs can be periodic or indicated by a SIB on Cell A. For example, the discovery RSs on NES cell can be transmitted with a larger periodicity than on Cell A wherein the periodicity is indicated by the SIB on Cell A. The UE may decide to camp on a second NES cell, from the configured list of NES cell, based on UE implementation (e.g., based on RSRP or pathloss measurement results for RS/SSB/TRS on the second NES cell). To request transmission of RS/SSB/TRS or SIB such as SIB1 on the second NES cell, the UE can receive configuration information for UL WUS associated with the second NES cell, and can transmit an UL WUS/PRACH associated with the second NES cell on Cell A or on the second NES cell. The UE may camp on the second NES cell upon determination that periodic RS/SSB/TRS is activated on the second NES cell, such as by receiving a response to the UL WUS/PRACH transmission.

In the present disclosure, on-demand SIB1 based on an UL WUS enabled by an L1/L2 NW trigger is provided.

In one embodiment, a UE operates on a first cell (also referred to as “Cell A”) with an anchor signal, such as a periodic discovery RS or periodic SSB or periodic TRS or variants thereof, and with periodic system information, such as periodic SIB1, and the UE can receive information of a second cell (also referred to as NES cell) with an anchor signal, such as a periodic discovery RS/SSB/TRS, while the second/NES cell does not transmit system information, such as periodic SIB1. The UE can be configured, by higher layer signaling such as SIB of on the first cell/Cell A, an UL WUS such as a PRACH or a RACH-based PUSCH or a CG PUSCH to request for transmission of on-demand SIB1 on the second camped/NES cell. The configured UL WUS can be enabled or disabled by higher layer signaling such as SIB or by L1/L2 signaling on the first cell/Cell A, such as by a UE-specific DCI format or a group-common DCI (GC-DCI) format or a cell-specific DCI format, for example, a DCI format for paging or PEI or Cell DTX/DRX. The UE can transmit the UL WUS on the second camped/NES cell or on the first cell/Cell A only when the transmission of UL WUS is enabled. The UE procedure may continue with reception of a response such as a RAR associated with the UL WUS transmission, and/or reception of on-demand SIB1 on the second camped/NES cell.

The method can apply to:
IDLE/INACTIVE mode UEs that camp on the first cell/Cell A, and may reselect the second/NES cell; or
CONNECTED mode UEs that have RRC connection to the first cell/Cell A, and may be handed over to the second/NES cell; or
UEs that are performing initial access, and have identified both the first cell/Cell A and the second/NES cell, and aim to camp on or establish RRC connection to the second/NES cell.

The above procedures can be, for example, due to better RSRP measurements on or closer distance to the second cell than the first cell.

In various embodiments of the present disclosure, a 6G base station (6G BS) or a 5G/4G BS can be replaced with other corresponding network nodes, such as 6G integrated access and backhaul (IAB) or 6G network-controlled repeater (NCR) or 6G reconfigurable intelligent surface (RIS) or hybrid reflection channel (HRC), or such as 5G NCR or IAB node, or a 4G relay or repeater node. For example, a 4G LTE base station is referred to as an evolved node-B (eNB). For example, a 5G NR base station is referred to as a next-generation node-B (gNB). For example, a 6G radio (6GR) base station can be referred to as a smart node-B (sNB) or an intelligent node-B (iNB) or an advanced/adaptive/AI-based node-B (aNB), and so on. In some examples, the term ‘gNB’ or simply ‘NB’ may be also used to refer to a 6GR base station.

In various embodiments, a 6G UE or a 5G/4G UE can operate in relation with one or multiple network nodes corresponding to a certain RAT (same RAT as that for the UE, or different RAT than that for the UE), such as a 6GR BS, or such as both a 6G BS and a 6G IAB/NCR/RIS, or both a 5G BS and a 5G IAB/NCR, or both a 4G BS and 4G relay/repeater node.

In various embodiments of the present disclosure, a 6G/5G BS or a 4G BS can refer to a central unit (CU) or a digital/distributed unit (DU) or a radio/remote unit (RU) or an access/antenna unit (AU) or a transmission-reception point (TRP) or other architectural units or functional/logical entities for a corresponding base station, or a variation or collection or combination thereof.

In the present disclosure, handover/LTM/cell reselection for CONNECTED mode UEs to cells without periodic SSB and with network-triggered on-demand discovery RS is provided.

In one embodiment, an RRC_CONNECTED mode UE can operate on a first cell, such as an anchor cell or a primary cell (PCell), with a (periodic or always-on or possibly on-demand) anchor signal, such as a periodic discovery RS/DL WUS or a periodic SSB or variants thereof, and the UE can be triggered to perform handover or mobility, including L1/L2-triggered mobility (LTM), to a second cell without a periodic anchor signal, such as no periodic discovery RS or no periodic SSB or variants thereof. The second cell can transmit an aperiodic or on-demand discovery/measurement RS, such as an on-demand SSB/DL WUS or variants thereof, that is initiated by a first NW trigger, such as a DCI or a MAC CE or a (sequence-based) DL WUS, to facilitate corresponding UE measurement and reporting. The UE can perform handover or cell reselection based on a second/different NW trigger that can follow/be in response to such measurements reporting by the UE of the respective discovery/measurement RSs on the configured list of NES cells.

In this disclosure, a periodic signal or channel can refer, for example, to a signal or channel that repeats based on a pattern with a certain periodicity and with an offset from a reference time, such as symbol index 0/slot index 0 of SFN index 0 or from any arbitrary SFN. A UE receives (or transmits) a periodic signal or channel after configuration by higher layers or activation by L1/L2 signaling, and continues until corresponding configuration is released by higher layers or deactivated by L1/L2 signaling. A variation of a periodic signal or channel that is activated and deactivated by L1/L2 signaling can also be referred to as a semi-persistent signal or channel.

In this disclosure, an aperiodic signal or channel can refer, for example, to a signal or channel that a UE receives (or transmits) only once or only a configured/indicated number of time instances or occasions upon trigger by L1 (or L2) signaling. For example, a periodic pattern or periodicity may not apply to aperiodic signals or channels, and a configuration release or deactivation may not be needed to stop such transmitted or reception.

Herein, an on-demand signal or channel can refer, for example, to a signal or channel that a UE receives (or transmits) upon reception of a NW trigger (or possibly a UE initiation/trigger/request) or based on an event for (possibly one, or, more typically) multiple occasions, as configured or indicated by higher layers or by L1/L2 signaling, such as the NW trigger, or until reception of another NW trigger to deactivated/disable the reception (or transmission) of the signal or channel. An on-demand signal or channel can be beneficial, for example, for overhead reduction, compared to corresponding periodic or always-on signals or channels. Examples for such an on-demand signal or channel can include OD-SS/OD-SSB, OD-RS, OD-SIB1, OD-SIBx, OD-PRACH, on-demand paging, and so on. When the on-demand signal or channel involves multiple occasions, different occasions be with a predetermined/configured/indicated periodicity or can be flexibly spaced in time domain based on higher layer configuration or L1/L2 signaling, such as the NW trigger. In various examples, an on-demand signal or channel can be a variation of an aperiodic signal or channel or a semi-persistent signal or channel.

In this disclosure, a discovery signal (DRS) can be only PSS, or only PSS and SSS. For example, a DRS can be one (or more of) low-power synchronization signal (LP-SS), or tracking reference signal (TRS), or cell-specific or UE-specific CSI-RS or SRS, or positioning reference signal (PRS), or DM-RS associated with (or not associated with) a certain signal or channel, or a sequence-based DL WUS, and so on. For example, the DRS can be periodic/semi-persistent or can be aperiodic or on-demand.

Herein, the first cell can be referred to as an “assistance cell” or “Cell A”. In one example, the first cell/Cell A operates with always-on/periodic synchronization signal (P-SS/AO-SS). For example, the UE does not expect Cell A to operate without P-SS/AO-SS. In another example, the Cell A can operate with on-demand synchronization signal (OD-SS) in combination with P-SS/AO-SS, or operate with OD-SS only without any P-SS/AO-SS.

In this disclosure, in order to perform measurements of the on-demand RS on the candidate NES cells, the UE may establish DL synchronization to one or more such candidate (or indicated) NES cells. For example, the UE determines a same time/frequency synchronization for the candidate NES cell as that for Cell A, such as when the candidate NES cells are collocated with Cell A. Such relationship can be configured by higher layers. For example, information for DL time/frequency synchronization of candidate NES cells can be provided by Cell A (e.g., relative to DL time/frequency synchronization of Cell A or the anchor/sync signal of Cell A) or the UE can determine/acquire such DL time/frequency synchronization for the candidate NES cells from the corresponding on-demand RS itself (e.g., on-demand SSB is used jointly for both DL synchronization and for measurement).

In one example, the UE receives the discovery signal such as the on-demand RS (OD-RS)/on-demand synchronization signal (OD-SS) on an active BWP of the candidate NES cell, for example, the first active DL BWP of the candidate NES cell or an initial DL BWP of the candidate NES cell. For example, higher layer signaling such as SIB can provide information of a DL BWP, such as frequency resources/location/size/RBs, for reception of such discovery signal/OD-RS/OD-SS.

The second cell can be from a list of candidate cells, for example referred to as a list of candidate NES cells, that are configured to the UE by higher layers, while the first cell can also be referred to as a “Cell A”. The second/NES cell can be non-collocated with the first cell (Cell A), thereby be associated with a UE mobility/LTM procedure, or can be collocated with the first cell (Cell A), thereby supporting an offloading/cell reselection operation from the first cell/Cell A to the second/NES cell that can be in the same frequency band/range as, or in a different frequency band/range than, the first cell/Cell A. In another example, the second/NES cell can be a configured serving cell, such as a configured and deactivated SCell, or a non-serving cell that is configured as a candidate cell for later becoming an additional cell, i.e., an SCell.

In one embodiment, the UE can be configured multiple list of cells, such as a first list including first candidate NES cells with periodic SSB and a second list including second candidate NES cells without periodic SSB. For example, different lists of cells can be separately or jointly triggered for measurement. In another embodiment, a single list can include first cells with periodic SSB and second cells without periodic SSB. In another example, different lists of cells can include cells with different OD-RS/OD-SSB configurations, such as different Tx power, different beams/TCI states/SSB indexes, different periodicities, different number of occasions, and so on.

For example, the first NW trigger can indicate one or more list of cells, from the different configured lists of cells, for which the UE reports measurements of respective OD-RSs. In a variation, the first NW trigger can indicate a subset of a list of candidate cells for such measurement reporting, wherein the subset can be indicated using a bitmap or a codepoint that indicates the cell-combination for the subset of cells. For example, the first NW trigger can indicate a subset of OD-RS/OD-SSB indexes or resources or resource sets from a number of configured OD-RS/OD-SSB indexes or resources or resource sets associated with a respective candidate NES cell.

For example, the first NW trigger can include or indicate a bitmap across configured NES cells, wherein a 1 in a bit of the bitmap indicates that OD-RS/OD-SSB is triggered on a corresponding NES cell, and a 0 in the bit of the bitmap indicates that OD-RS/OD-SSB is not triggered on the corresponding NES cell. For example, the first NW trigger can include or indicate a separate OD-RS/OD-SSB trigger for each of the NES cells indicated by the bitmap, or a joint OD-RS/OD-SSB trigger across different indicated NES cells.

For example, the first NW trigger can include or indicate a trigger state that is a codepoint, wherein each value of the codepoint refers to a set/subset of candidate NES cells, such as a first value of the codepoint/trigger indicating OD-RS/OD-SSB reception on a first set/subset of NES cells, and a second value of the codepoint/trigger indicating OD-RS/OD-SSB reception on a second set/subset of NES cells.

For example, the first NW trigger can include or indicate a bitmap or codepoint for indication of OD-RSs/OD-SSBs on the indicated list/set/subset of candidate NES cells. For example, a 1 in a bit of the bitmap indicates a trigger for reception and measurement of a respective OD-RS/OD-SSB resource or resource set or resource group on an indicated candidate NES cell (or a group/subset/set/list of NES cells), while a 0 in the bit of the bitmap indicates no (trigger for) reception and measurement of the respective OD-RS/OD-SSB resource or resource set or resource group on the indicated NES cell (or the group/subset/set/list of NES cells). For example, each value of the codepoint can refer to a respective configured list of OD-RS/OD-SS resources or resources sets or resource groups on the indicated NES cell (or the group/subset/set/list of NES cells). For example, the UE can be configured a same codepoint/codepoint values that apply to various cells in a set/subset/list of NES cells, or can be configured separate codepoints/codepoint values for each cell, from the set/subset/list of NES cells.

For example, the first NW trigger can include an indication of time occasions for OD-SS/OD-RS reception. For example, the first NW trigger can indicate, for each indicated candidate NES cell, a subset of OD-SSs from a configured set of OD-SSs, and the first NW trigger can indicate time occasions for reception of each OD-SS from the first subset of OD-SSs. For example, such time occasions can be indicated using an index of a starting occasion for the respective OD-SS, with or without an indication for a number L of OD-SS occasions. For example, the UE receives and measures such L OD-SS occasion from the indicated starting occasion. For example, the first NW trigger can indicate a bitmap to indicate the OD-SS occasions that the UE receives/measures (e.g., a 1 in the bitmap indicates that UE receives/measures a corresponding OD-SS occasion, and a 0 in the bitmap indicates that UE does not receive/measure in the corresponding OD-SS occasion). For example, the first NW trigger can indicate an occasion combo, from a number of configured occasion combos, wherein each occasion combo includes a set or group or combination of consecutive or non-consecutive OD-SS/OD-RS occasions. For example, the first NW trigger indicates a number L of OD-SS occasions that are activated on a candidate NES cell (or an a list/set/subset of NES cells), without indication of a first/starting OD-SS/OD-RS occasion. For example, such L OD-SS occasions are counted starting from a first or earliest OD-SS that is after a last symbol for reception of the first NW trigger, or that is N symbols or slots after a last symbol for reception of the first NW trigger, wherein a value of N is as previously described. In another example, the first NW trigger indicate an index of a last occasion for OD-SS/OD-SS reception and measurement on a candidate cell (or on a list/set/subset of NES cells), without indication of a first/starting OD-SS/OD-RS occasion. For example, the UE is predetermined to start receiving and measuring OD-SS/OD-RS from a last for reception of the first NW trigger, or from N symbols or slots after reception of a last symbol for reception of the first NW trigger, and the UE continues to receive and measure OD-RS/OD-SS occasions until the indicated last occasion. In various aforementioned examples, the UE can be provided a same indication for OD-SS/OD-RS occasions that applies to multiple NES cells, or the UE can be provided separate indications for OD-SS/OD-RS occasions for each cell from (or each group of cells) from the indicated list/set/subset of NES cells.

For example, the first NW trigger includes an indication of (actually transmitted) SSB indexes for OD-SSB. For example, the UE is predetermined or configured to receive the OD-SSB in a burst or collection of OD-SSB receptions corresponding to a number of OD-SSB indexes, wherein each OD-SSB reception/index includes a number of time-frequency resources, and corresponds to a potentially different spatial filter/beam.

For example, the first NW trigger can indicate other parameters for OD-SS/OD-RS reception, such as a transmit power or a periodicity or a number of occasions for the OD-SSB/OD-RS.

For example, various aforementioned parameters can be indicated separately or jointly by the first NW trigger, such as by separate fields or codepoints, or using a single joint field or codepoint that can provide values for multiple parameters (wherein corresponding mapping between codepoint indexes and values of the multiple parameters can be configured by higher layers).

There can be a time offset between reception of the first NW trigger and reception of the OD-SSB/OD-RS. For example, the UE receives (or starts to receive) the triggered discovery signals or RSs for measurement, such as OD-SS/OD-RS, no earlier than N symbols or slots after reception of a last symbol or slot of a signal or channel (e.g., PDCCH/DL WUS/PDSCH with MAC-CE) that provides the first NW trigger. For example, a value of N can be predetermined in the specifications of system operation or configured by higher layers or based on a UE capability, and wherein a value of N can depend on a corresponding frequency band/range or a corresponding SCS. For example, the UE does not expect to receive/measure an OD-SS/OD-RS occasion that is less than N symbols or slots after the reception of the first NW trigger.

The measurements can be based on information provided to a UE for candidate NES cells, discovery/measurement RS associated with the candidate NES cells, a transmission power for the discovery/measurement RS, and so on. Corresponding RS measurement information from the UE can include a subset of {PCI, on-demand RS/SSB index, RSRP} such as for a predetermined or configured number M of largest RSRP measurements. In this disclosure, discovery RS (DRS) index or DL WUS index or, in general, RS index, can be used instead of on-demand SSB index. Herein, RSRP can be with or without L1/L3 filtering, such as L1-based RSRP, or L3-filtered RSRP. Herein, instead of or in addition to RSRP, other signal quality measurements can be used, such as RSRQ, RSSI, SNR, SINR, and so on, with or without L1/L3 filtering.

In another example, higher layer configuration such as SIB or RRC can include a number of measurement configurations per candidate NES cell or across a number of NES cells, and the first NW trigger can indicate an index of a measurement configuration from the number of measurement configurations, and an index of a candidate NES cell, at least when indexes of measurement configurations are individually configured per candidate NES cell. For example, when indexes of measurement configurations are across the candidate NES cells, indicating the index of a corresponding candidate NES cell is not needed. For example, when the UE transmits an UL channel that provides a corresponding measurement report, the UE can include, as a header to or within the measurement report, an index of a corresponding measurement configuration, and if applicable, an index of a candidate NES cell.

For example, a measurement configuration can include one or more of: a group/set/list of signals for measurement, such as reference signals (RSs) or discovery signals, such as OD-RSs/OD-SSs; parameters for measurements, such as applicable measurement metric or measurement parameters or scaling factors or offset values or applicable L1/L3 filter values; and information for measurement reporting, such as PUCCH/PUSCH/CG PUSCH resources, and so on. For example, each measurement configuration can correspond to a trigger state, such as an index from 2\hat{ }N trigger states, and the first NW trigger can indicate a value from the 2\hat{ }N values, using an N-bit field.

Additionally, or alternatively, the measurement can be related to absolute or relative location of UE, such as whether the UE is within a certain distance from a certain candidate NES cell, that can be based on reception of the discovery/measurement RS or based on geographical information of the respective candidate NES cell.

Additionally, or alternatively, the measurement can be related to pathloss measurements of the discovery/measurement RS/DL WUS/SSB/sync signal from the candidate NES cells. For example, for a first RS with a first transmission power, such as from a first/macro cell, and for a second RS with a second transmission power, such as from a second/small/micro cell, with the first transmission power being larger than the second transmission power, the UE can determine a first RSRP for the first RS to be larger than a second RSRP for the second RS. The UE can also determine a first pathloss, corresponding to the difference between the first transmission power and the first RSRP, to also be larger than a second pathloss corresponding to the difference between the second transmission power and the second RSRP, for example when the UE is located closer to the second/small/micro cell. In this case, it can be more advantageous for the UE to select the second/small/micro cell. In the case that the first/macro cell decides whether to transition the UE to the second/small/micro cell and in case the first/macro cell is not aware of the transmission power of the second discovery/measurement RS from the second/small/micro cell, for example in order to avoid reliance on backhaul communication between the two cells such as when they are provided by different manufacturers or when such backhaul communication is infeasible or slow, the UE can additionally report to the first/macro-cell the pathloss measurements at least for discovery/measurement RS from other cells, such as the second/small/micro cell.

The UE can transmit such measurement reports on resources, such as PUCCH or PUSCH resources, that are configured by higher layers or indicated by DCI/MAC CE via the first NW trigger, or using Msg3/MsgA PUSCH that is associated with a Msg1/MsgA PRACH used for early TA/TCI/PL-RS determination, as subsequently described. For example, the PUCCH or PUSCH resources can be on Cell A or a reference candidate NES cell, such as a candidate NES cell with smallest cell index, or with a cell index that is configured by higher layers (e.g., SIB or RRC) or indicated by the first NW trigger. In another example, the UE can be configured by higher layers or indicated by the first NW trigger separate PUCCH or PUSCH resources on some/each of the indicated candidate NES cells to provide respective measurement reports of the corresponding candidate NES cells.

For example, the first NW trigger that triggers OD-RS/OD-SSB reception also acts as a PDCCH order to trigger PRACH on one or more of the candidate NES cells. For example, such PRACH transmission can be for early acquisition of one or more of TA/beam/TCI/pathloss reference signal (PL-RS), and so on.

For example, the PRACH order/trigger applies only to candidate NES cells that are in a different timing advance group (TAG) than a TAG that includes Cell A. For example, Cell A and a first number of candidate NES cells are included in a first TAG, while a second number of candidate NES cells are included in a second TAG. For example, the PRACH order applies only to the second number of candidate NES cells. For example, the UE does not expect the PDCCH order to trigger PRACH on a cell from the first number of cells. For example, if the PDCCH order triggers PRACH on a set/subset of candidate NES cells that includes first cells from the first number of cells, the UE does transmit a PRACH on the first cells. For example, the UE transmits PRACH only on second cells from the second number of cells that are included in the set/subset of candidate NES cells. In another example, PDCCH order overrides the TAG configuration, and the UE transmits PRACH on any cell indicated by the PDCCH order, including the first cells.

For example, a trigger state provided by the first NW trigger can be a joint codepoint for both OD-RS/OD-SSB resources and PRACH resources. In another example, the NW trigger can include separate triggers, such as a first codepoint for OD-RS/OD-SSB resources and a second codepoint for PRACH resources. For example, the first codepoint and the second codepoint can indicate a same set of candidate NES cells or can indicate different sets of candidate NES cells, such as a first OD-RS/OD-SSB trigger on a first set of candidate NES cells, and PRACH trigger on a second set of cells, that are a subset of the first set of cells. For example, the first NW trigger can be a DCI 1_0 (or another fallback DCI or a DCI for PDCCH order) that includes a CSI trigger field to indicate the set/subset of candidate NES cell and corresponding OD-RS/OD-SS, and also includes fields to trigger the PRACH, such as fields for indication of one or more of: cell index, sync signal index, preamble index, PRACH mask index, power control parameter information, and so on.

In another example, DCI 1_0 can include a first field, such as a carrier indicator field (CIF), to indicate a first number of candidate NES cells for OD-RS/OD-SS measurement. For example, the DCI can include a second CIF field to indicate a set/subset of candidate NES cells for PRACH transmission. For example, the indicated candidate NES cells for measurement (by the first CIF field) and for PRACH transmission (by the second CIF field) can be same or different. For example, the DCI can include a single CIF that indicates selected candidate NES cells for both measurement trigger and for PRACH trigger.

In a further example, a DCI for PDCCH order that triggers PRACH (e.g., for early acquisition of TA/beam/TCI/pathloss RS) can be separate from the first NW trigger. For example, the UE can receive a DCI, such as a UE-specific DCI or a GC-DCI or a cell-specific DCI to trigger PRACH for a UE or for a group of UEs to transmit PRACH for an indicated subset of the candidate NES cells, from the candidate NES cells that are indicated by the first NW trigger. For example, higher layers such as SIB or RRC configure a set of candidate NES cells; the first NW trigger indicates a number of NES cells from the configured set of candidate NES cells; and the DCI for PDCCH order indicates, for PRACH transmission, a subset of cells from the number of NES cells. For example, the UE receives such DCI for PDCCH order after the first NW trigger.

For example, the UE receives such DCI for PDCCH order after transmission of the PUSCH or PUCCH that provides the measurement reports for the number of candidate NES cells that are indicated by the first NW trigger. For example, the UE starts to monitor PDCCH for such DCI/PDCCH-order, based on a respective search space set, starting from a first symbol or slot after transmission of the PUSCH or PUCCH that provides the measurement reports, or starting from a first symbol of slot that is N symbols or slots after transmission of the PUSCH or PUCCH that provides the measurement reports. For example, a value of N can be predetermined in the specifications of system operation or configured by higher layers or based on a UE capability, and wherein a value of N can depend on a corresponding frequency band/range or a corresponding SCS.

For example, the DCI for PDCCH order can indicate different subsets of NES cells for different UEs. For example, a UE can be configured one or more separate information blocks (bits) within a DCI, for example, using higher layer parameter position-in-DCI, wherein each information block provides a separate PDCCH order for the UE to trigger PRACH transmission by the UE on respective one or more candidate NES cells.

In another example, a PDCCH order can be included in the second NW trigger that indicates cell reselection/handover, such as an RRC message for RRC reconfiguration, or a MAC-CE for handover or for cell switch command in LTM, or a MAC-CE for Cell addition or SCell activation.

For example, the RACH resources for such PDCCH order can be dedicated/contention-free (CFRA) or contention-based (CBRA) resources, such as ROs or preambles. For example, transmission of such PRACHs is aimed at early determination of TA/beam/pathloss reference information for the corresponding candidate NES cells.

For example, the UE can determine or can be configured an RS-to-RACH/SSB-to-RO association for such RACH procedure on such indicted candidate NES cells. For example, the UE can transmit a PRACH using a PRACH preamble and in an RO on a candidate NES cell, wherein the PRACH preamble/RO are associated with a first SSB (such as periodic or on-demand SSB) from Cell A, or associated with a second SSB/RS on the respective candidate NES cell, wherein the second SSB is among the OD-SSB/OD-RS that the UE is triggered to receive on the respective candidate NES cell based on the indication by the first NW trigger.

In one example, the UE does not receive (or does not expect to receive) responses, such as one or more RAR, for such PRACH transmissions to the candidate NES cells as indicated by the first NW trigger/PDCCH order. For example, the NB associated with an indicated NES cell can determine applicable TA/beam/TCI/pathloss reference for the UE, and store or pass such information to NB associated with the Cell A (can be same or different NBs). For example, such TA/beam/TCI/pathloss information can be indicated to the UE within the second NW trigger for handover/cell reselection.

In another example, the UE receives one joint RAR/MsgB associated with the one or multiple PRACH transmissions to the one or multiple candidate NES cells, or the UE receives a separate RAR/MsgB associated with each PRACH transmission from the one or multiple PRACH transmissions to the one or multiple candidate NES cells. For example, the UE receives the one joint RAR/MsgB on Cell A, or on a reference candidate NES cell (e.g., with smallest cell index), or on candidate NES cell whose index is configured by higher layers such as SIB or RRC, or indicated by the first NW trigger/PDCCH order. For example, the UE receives the separate RARs/MsgBs on respective candidate NES cells, or on Cell A. For example, the UE can be provided, using such one or more RARs/MsgBs, information of TA/beam/TCI/pathloss reference applicable for the one or multiple candidate NES cells. In another example, such RAR/MsgB can be (or can include) the second NW trigger, wherein the RAR/MsgB also provides the indication/information for which candidate NES cell to select for handover/cell reselection. For example, the UE receives only a single RAR/MsgB that is associated with a single cell that is selected by the NB for handover/offloading/cell reselection of the UE.

In one example, at least the UE can provide the measurement report(s) using a PUSCH associated with such PRACH, such as a configured PUSCH resource/MsgA PUSCH as in 2-step RACH or generally a RACH-based PUSCH (wherein a configured PUSCH resource is associated with a configured/indicated RACH resource), or a Msg3 PUSCH that is scheduled by the RAR. For example, the UE transmits a single PUSCH, such as a single Msg3 PUSCH/MsgA PUSCH, only on the Cell A, wherein the PUSCH provides measurement reports for all of the one or multiple candidate NES cells as indicated by the first NW trigger. For example, the UE transmits a separate PUSCH, such as a separate Msg3 PUSCH/MsgA PUSCH, to provide a separate measurement report for each candidate NES cell as indicated by the first NW trigger/PDCCH order. For example, the UE transmits the separate PUSCHs on Cell A, or on respective candidate NES cells, or on a reference candidate NES cell (e.g., with smallest cell index), or on candidate NES cell whose index is configured by higher layers such as SIB or RRC, or indicated by the first NW trigger/PDCCH order.

For example, the UE transmits the PUSCH(s), such as the Msg3/A PUSCH(s), on a same cell on which the UE received the corresponding RAR(s). For example, the Msg4 PDCSH can be (or can include) the second NW trigger that indicates cell reselection/handover.

In another example, the UE transmits the measurement report(s) on a PUSCH that is configured to the UE, such as CG PUSCH resources on Cell A. For example, the CG PUSCH may not be linked or associated with the PRACH, such as a MsgA PUSCH.

In another example, the first NW trigger can jointly schedule the PRACH(s) on a first number of candidate NES cells, and the PUSCH(s) on Cell A or on the first number of candidate NES cells or on a reference candidate NES cell. Such case can be considered as an extension of multi-cell scheduling using a single DCI, wherein the DCI can schedule a mixture of PDSCHs/PUSCHs and PRACHs.

Upon transmission of such measurement reports, the UE may stop receiving or measuring the on-demand discovery RS on the candidate cells, or upon transmission/reception of such measurement report, the gNB may stop transmitting the on-demand discovery RS on the candidate cells, with or without any indication or signaling to the UE, possibly including UE/gNB processing time. For example, the UE does not receive/measure (or does not expect to receive/measure) the on-demand discovery RS right after (e.g., a first symbol/slot after) transmission of the measurement report, or after N symbols or slots after the transmission of the measurement report, wherein a value of N can be predetermined in the specifications of system operation or configured by higher layers or based on a UE capability, and wherein a value of N can depend on a corresponding frequency band/range or a corresponding SCS. In another example, the UE can receive a different NW trigger, such as DCI or DL WUS or MAC-CE, to deactivate the on-demand RS, wherein such NW trigger is after transmission of the measurement report. In another example, such NW trigger is same as the second NW trigger that indicates the selected NES cell and corresponding handover/cell reselection parameters.

After transmission of the PUSCH/PUCCH with such measurement report, the UE monitors for the second NW trigger. For example, the UE can be configured by higher layers or indicated by the first NW trigger a length of monitoring window (e.g., L symbols or slots) or other parameters for reception of the second NW trigger. For example, the UE starts such monitoring window from a first symbol or slot after transmission of the PUSCH/PUCCH with the measurement reports, or from N symbols or slots after transmission of the PUSCH/PUCCH with the measurement reports, wherein a value of N can be predetermined in the specifications of system operation or configured by higher layers or based on a UE capability, and wherein a value of N can depend on a corresponding frequency band/range or a corresponding SCS. For example, the UE monitors PDCCH or (sequence-based) DL WUS, as per corresponding configurations, on Cell A or on the candidate NES cells during the monitoring window.

In another example, no monitoring window is applicable for reception of the second NW trigger. For example, the UE continues to operate on Cell A based on PCCCH monitoring or DL WUS monitoring, and it is up to gNB whether/when to transmit the second NW trigger. For example, the UE may (or may not) receive a response or confirmation after transmission of the measurement reports, without receiving the second NW trigger for handover/cell reselection.

Either or both of the first NW trigger for indicating to a UE transmission of measurements associated with discovery/measurement RS on the list of NES cells (or a subset thereof) and the second NW trigger for indicating to the UE a cell reselection or mobility to the second/NES cell can be based on a DCI such as a group-common DCI format, or a cell-specific DCI format, such as a DCI format with associated PDCCH that the UE monitors according to a common search space, or a UE-specific DCI format such as a DCI format with associated PDCCH that the UE monitors according to a UE-specific search space, or a sequence-based DL WUS, or a MAC-CE command.

For example, the DCI can be a DCI for DCP (i.e., a DCI for activation or deactivation of DRX cycles and with CRC scrambled with e.g. PS-RNTI) or a DCI for paging or for paging early indication (PEI) or a DCI for Cell discontinuous transmission/reception (Cell DTX/DRX) or Cell State indication, or a DCI for adaptation of synchronization signal/PRACH/other common signals or channels.

For example, at least the first NW trigger (or possibly also the second NW trigger) can be a sequence-based DL WUS (or possibly a PDCCH-based DL WUS) that the UE monitors in a low-power (LP)/energy-efficient (EE) operation state or in a full-power (FP)/high-efficiency (HE)/Active state. For example, the UE can monitor a DL WUS on a first cell/Cell A that triggers reception and measurement of OD-SSB/OD-RS on a set or subset of candidate NES cells. For example, the UE receives a DL WUS while the UE operates in an LP/EE state, wherein the DL WUS indicates OD-SSB/OD-RS measurement on such candidate NES cells. In one example, the UE switches to the FP/HE/Active state before reception and measurement of OD-SSB/OD-RS. In another example, the UE can receive and measure such OD-RS while the UE continues to operate in LP/EE state; while the UE switches to the FP/HE/Active state for measurement reporting. In another variation, the UE can also report the OD-SSB/OD-RS measurements in the LP/EE state. For example, such DL WUS can be UE-specific or UE-group-specific or cell-specific, wherein corresponding operates states, such as LP/EE state or FP/HP/Active state can apply to a single UE or a group of UEs or commonly to UEs in a cell.

The second NW trigger for handover or cell re-selection to the second/NES cell (for example, as a new PCell for the UE) can also imply or indicate activation of transmission of a periodic signal, such as periodic SSB, or possibly an on-demand synchronization signal/reference signal (OD-SS/OD-RS) on the second cell. For example, the UE starts to receive such periodic SSB or OD-SS/OD-RS on the second cell upon, or N symbols or slots after reception of the second NW trigger, or N symbols or slots after transmission of an ACK/HARQ-ACK feedback in response to reception of the second NW trigger. For example, a value of N can be predetermined in the specifications of system operation or configured by higher layers or indicated by the second NW trigger or based on a UE capability.

For example, a Cell DTX/DRX indication (or the UE DTX/DRX indication) can be provided together with an indication for triggering OD-RS/OD-SSB for measurement or activation of periodic RS/SSB on the candidate NES cells. For example, such Cell DTX/DRX indication can indicate to a UE (or a group of UEs or all UEs in a cell) that the first cell/Cell A is going into Cell DTX/DRX state, such as suspending or deactivation of various signals or channels on Cell A (possibly including periodic SSB/always-on SSB/OD-SSB on Cell A), while the UE is indicated to measure SSBs/RSs (such as OD-SSBs/OD-RSs) on a number of candidate NES cells, or to perform handover to one of the number of candidate NES cells. For example, when applicable, the UE can report measurement reports to a cell from the indicated number of candidate NES cells, such as a reference cell with smallest index among the indicated number of candidate NES cells. In another example, the Cell DTX/DRX on Cell A can indicate activation of periodic SSB (P-SSB) or always-on SSB (AO-SSB) on a number of candidate NES cells. For example, performing the handover to a candidate NES cell can be based on indication by a same Cell DTX/DRX indication, or by a different/second NW trigger, or can be based on UE procedures for handover for CONNECTED UEs. For example, a Cell DTX/DRX indication can be after UE reporting measurements of OD-RS/OD-SSB on the indicated candidate NES cells. For example, the Cell DTX/DRX indication can provide the second NES cell. For example, the UE can receive an indication, such as a DCI, that indicates Cell DTX/DRX on Cell A, and also indicates activation of SSB, such as P-SSB/AO-SSB (or OD-RS/OD-SSB), on a second cell/NES cell, and triggers handover/mobility/LTM to the second cell/NES cell.

In order to perform handover or cell reselection to the second/NES cell, the UE may perform UL preparation procedures, such as early UL synchronization or early TA acquisition, TCI or pathloss determination, and so on, for example as previously described.

Regardless of whether the UE procedure involves mobility to a non-collocated cell or only cell reselection to a collocated cell, the second NW trigger can provide similar information as a mobility trigger (such as an LTM Cell Switch command MAC CE), for example one or more of: information of the candidate NES cell (for example, cell index or configuration index), timing advance (TA) information, spatial relation information such as DL/UL/joint TCI state ID or QCL assumption information, and possibly information of (contention-based or contention-free) random access at least for the case of RACH-based cell reselection.

In this disclosure, information of (contention-based or contention-free) random access can include one or more of: SSB index associated with PRACH, PRACH preamble index, PRACH mask index, number of repetitions for one or more of Msg1/MsgA PRACH, Msg3/MsgB PUSCH, or PDCCH for RAR/Msg4/MsgB, and cell/carrier/BWP index for transmission of Msg1/MsgA PRACH, or Msg3/MsgB PUSCH, or for reception of PDCCH for RAR/Msg4/MsgB.

Alternatively, handover/cell reselection can be using a RACH-less method, such as by using a CG PUSCH configured by higher layers or triggered or activated by the second NW trigger or using a PUSCH that is scheduled by the second NW trigger or by a separate PDCCH/DCI format. For example, the CG PUSCH resources are on the selected/indicated NES cell for handover/cell reselection, while information of such CG PUSCH resources can be provided by the same NES cell or by Cell A. For example, for the PUSCH that is scheduled by the second NW trigger or by a separate DCI, the UE transmits the PUSCH on the selected/indicated NES cell, while the UE receives the DCI, if applicable, on the same NES cell or on Cell A. For example, the UE receives the second NW trigger on Cell A or on a reference candidate NES cell, e.g., with smallest cell index, or with a cell index that is configured by higher layers or indicated by the first NW trigger.

Various embodiments, methods, or realizations can apply to single-carrier cells (wherein a cell operates on a single frequency carrier/band) or to multi-carrier cells (wherein a cell operates on multiple frequency carriers/bands). For example, the first cell/Cell A can be a single-carrier cell or a multi-carrier cell. For example, one or more of the candidate NES cells can be single-carrier cell(s) or multi-carrier cell(s).
For example, when Cell A is a multi-carrier cell, the UE can receive the first NW trigger or the second NW trigger on certain carriers of Cell A, such as ones with a CORESET for corresponding PDCCH/DCI reception, or on any carrier of Cell A, such as any carrier of Cell A that includes monitoring occasion/resources for corresponding DL WUS reception, or any carrier on which the UE can receive a PDSCH that provides a MAC-CE for the first NW trigger or the second NW trigger. Herein, the first NW trigger or the second NW trigger is provided by a PDCCH/DCI or by a DL WUS or a MAC-CE;
For example, when a candidate NES cell is a multi-carrier cell, and the first NW trigger indicate reception or measurement of OD-RS/OD-SSB on the NES cell, the UE receives the triggered OD-RS/OD-SSB on a carrier of the NES cell, wherein the carrier index is predetermined (e.g., smallest carrier index) or configured by higher layers. In another example, the first NW trigger can also indicate a set of carriers from the multiple carriers of the NES cell on which the UE receives the OD-RS/OD-SSB;
For example, when a candidate NES cell is a multi-carrier cell, and the UE is configured/indicated to report measurements for OD-RSs/OD-SSBs on a number of carriers of the NES cell, the measurement report can include both the cell index (e.g., PCI or other cell index) and the corresponding carrier index(es) within the NES cell;
For example, when a candidate NES cell is a multi-carrier cell, and the UE is configured/indicated to transmit PRACH on the NES cell, e.g., for (early) TA/beam/TCI/pathloss RS determination, the UE can determine a carrier of the NES cell for such PRACH transmission, for example, based on random selection or arbitrary selection based on UE implementation; or the carrier can be predetermined, such as a carrier with SSB or a carrier with CORESET #0 (or with other CORESET) or a carrier with PUCCH resource configuration, or a carrier with smallest/largest carrier index; or a carrier index for PRACH transmission can be configured by higher layers or indicated by the first NW trigger or the PDCCH order that triggers the PRACH transmission; or a carrier can be associated with UE ID (e.g., using a modulo formulation or using a UE grouping based on UE ID) or associated with UE type, and so on;
For example, when Cell A is a multi-carrier cell, the UE can transmit the measurement reports on a carrier of the NES cell, wherein an index of the carrier is predetermined (e.g., carrier with smallest carrier index, possibly restricted to ones with RACH-based PUSCH resources or with CG PUSCH resources) or configured by higher layers, or indicated by the first NW trigger.
For example, when a candidate NES cell is a multi-carrier cell, and the second NW trigger indicates to the UE to perform handover/mobility/cell reselection to such NES cell, the UE starts to operate on a carrier of the NES cell, that is a predetermined carrier such as a carrier with SSB or a carrier with CORESET #0 (or with other CORESET) or a carrier with smallest/largest carrier index, or a carrier with a carrier index that is configured by higher layers or indicated by the second NW trigger. In another example, the UE operates on a carrier that the UE determines based on random selection or arbitrary based on UE implementation, or the UE operates on more than one carriers of the NES cell, such as on all carriers of the NES cell.

The aforementioned examples for a multi-carrier Cell A or a multi-carrier NES cell can also apply when replacing ‘carrier’ with ‘bandwidth part (BWP)’ or ‘sub-band’ and so on, such as a cell that operates on multiple non-consecutive frequency allocations, such as multiple active BWPs/sub-bands, or a single active BWP/sub-band with multiple non-contiguous frequency allocation chunks.

In the present disclosure, network determination to activate on-demand discovery RS on candidate NES cells with or without UE request (UL WUS) is provided.

In one implementation of the above embodiment, the gNB can transmit the first NW trigger (that activates the on-demand measurement/discovery RS on the list of candidate NES cells, or a subset thereof) based on NW implementation, such as when the gNB determines that the first cell/Cell A is congested by many UEs and an offloading of UEs from Cell A would be beneficial.

In another implementation of the above embodiment, the gNB may transmit the first NW trigger in response to a UE request, such as a PRACH or other UL wake-up signal (UL WUS). For example, the UE may determine that it is in poor coverage in Cell A and transmit an UL WUS to initiate a procedure for finding a cell with good coverage. A configuration for the PRACH/UL WUS can be provided by the first cell/Cell A. The UE may transmit the PRACH/UL WUS on the Cell A or possibly on a candidate NES cell, such as the second/NES cell, or on a reference candidate NES cell, such a candidate NES cell with smallest cell index or with a cell index that is configured by higher layers. The PRACH/UL WUS transmission can be enabled or disabled by the network, such as by higher layer configuration, or by a network trigger, for example, jointly by a third NW trigger that is before the first NW trigger, or the third NW trigger can be same as the first NW trigger. Herein, the third NW trigger can be a DCI or a MAC-CE or a DL WUS. For example, the third NW trigger can indicate a cell index for the reference candidate NES cell for UL WUS transmission.

For example, the UL WUS can a PRACH based on a separate configuration, such as a limited number of PRACH preambles or a limited number of PRACH occasions, wherein PRACH resources for UL WUS can be shared with PRACH resources used for other PRACH triggers. In another example, the UL WUS can be a sequence-based UL WUS, such as a PUCCH, or a new sequence-based UL channel (or signal).

For example, to transmit the UL WUS on Cell A, the UE can be configured an SSB-to-RO association for Cell A, wherein the UE determines an RO for UL WUS transmission on Cell A based on an SSB that the UE receives on Cell A or an SSB index on Cell A that the UE selects for RO selection (for example, with SSB RSRP above a threshold). For example, the SSB-to-RO association for UL WUS transmission can be same as an SSB-to-RO association for general PRACH transmission on Cell A for various other PRACH triggers, or the SSB-to-RO association for UL WUS can be separate, for example, based on the limited set of ROs/preambles that are configured for UL WUS transmission.

For example, the UE can be configured separate PRACH resources/parameters/preambles/ROs for a PRACH on Cell A that serves as UL WUS to request for activation of candidate NES cells (e.g., to request a trigger of OD-SSB/OD-RS on candidate NES cells) to distinguish from other PRACH transmissions on Cell A for other ‘generic’ purposes (e.g., related to operations on Cell A itself).

For example, to transmit UL WUS on a candidate NES cell, such as a reference NES cell (as previously described), the UE the UE can be configured an SSB-to-RO association for such candidate NES cell, wherein the association can be with respect to SSBs on Cell A. For example, the UE determines an RO for UL WUS transmission on the candidate NES cell based on an SSB that the UE receives on Cell A or an SSB index on Cell A that the UE selects for RO selection (for example, with SSB RSRP above a threshold; can be same or different/separate from a corresponding threshold for UL WUS/PRACH transmission on Cell A).

For PRACH transmissions, other than for UL WUS purposes, on a candidate NES cell, such as when the UE is triggered PRACH transmission for (early) acquisition of TA/beam/TCI/PL-RS by the first NW trigger or by a separate DCI/MAC-CE/RRC message after reception of the first NW trigger (or after transmission of the measurement report corresponding to OD-RSs), the UE can be configured SSB-to-RO association relative to SSB on Cell A or relative to OD-SSB on the candidate NES cell, or a combination thereof, as predetermined in the specifications of system operation, or as per configuration by higher layers.

In one example, a UE can transmit UL WUS on/for/towards a candidate NES cell (or an indicated NES cell) in order for the NES cell to subsequently respond to it. For example, the UE may determine/select the NES cell based on a location of the NES cell, such as a closest NES cell to the UE or an NES cell within a certain proximity from the UE, wherein information for the NES cell can include coordinates of the NES cell such as when the PCI is configured.

In one example, When the first and third NW triggers are separate, the first NW trigger can be considered as a random access response (RAR), such as RAR PDCCH or RAR PDSCH, that is associated with a PRACH/UL WUS transmission that is initiated by the third NW trigger.

For example, the RAR can include candidate cell/carrier index, or measurement configuration ID. For example, the RAR can include a CSI request field or an SRS request field that provides or indicates such information.

In another example, the first NW trigger can be provided in later messages after an UL WUS/third trigger, such as in a Msg4 PDCCH/PDSCH, or later (instead of RAR PDCCH/PDSCH). For example, various transmissions or receptions, such as reception of the third NW trigger/PDCCH order, or the Msg2/MsgB/RAR or the Msg4, or transmission of the PRACH/UL WUS or the Msg3/MsgA PUSCH can be on the first cell/Cell A, or on a candidate NES cell.

In one example, when the UE transmits an UL WUS on a cell, such as Cell A or a candidate NES cell, for example, a reference NES cell (with smallest/largest cell index or with a configured index), and when the cell is a multi-carrier cell, the UE can determine a carrier of the cell for such PRACH transmission, based on random selection or arbitrary selection up to UE implementation or based on RSRP measurements of SSB/RS on the carrier exceeding a threshold (at least for Cell A with P-SSB/AO-SSB, or possibly with OD-RS/OD-SSB); or the carrier can be predetermined, such as a carrier with SSB or a carrier with CORESET #0 (or with other CORESET) or a carrier with PUCCH resource configuration, or a carrier with smallest/largest carrier index; or a carrier index for UL WUS transmission can be configured by higher layers; or a carrier can be associated with UE ID (e.g., using a modulo formulation or using a UE grouping based on UE ID) or associated with UE type, and so on.

In the present disclosure, network-triggered activation of SCells based on NW-triggered UE measurements of on-demand discovery RS with or without UE request (UL WUS) is provided.

In one embodiment, an RRC_CONNECTED UE that operates on a first cell, such as an anchor cell or a primary cell (PCell), can be configured a number of candidate cells/SCells that can include non-serving cells, or possibly serving cells such as deactivated serving cells, without any [periodic] anchor signal transmission, such as no periodic discovery signal or no periodic SSB transmission. The UE can also be configured properties and resources for aperiodic or on-demand discovery RS reception, such as on-demand SSB or variants thereof, on each candidate cell. A first NW trigger, such as one provided by a DCI format or a MAC-CE command, can indicate transmission of discovery RS on the candidate cells (or a subset thereof). The first NW trigger can also indicate UE measurement and reporting based on the on-demand discovery RS receptions. A second NW trigger, such as one provided by a DCI format or a MAC-CE for SCell activation or a new MAC-CE, may indicate selection and addition/activation of one (or some) of the candidate cells as non-anchor or secondary cells (SCells) for the UE, possibly based on the UE measurement reports.

The method differs from the above embodiment in the following:
The second cell is an SCell that is added/activated for the UE, instead of a new PCell for the UE in a handover or cell reselection procedure.
A RACH-based method for addition/activation of a candidate cell as an SCell may not be applicable, and the UE may receive corresponding information, such as TA value or TCI state, for such SCell as higher layer configuration (such as an indication for a candidate cell to be in a same TAG as the PCell) or via L1/L2 signaling, that is same as or separate from the second NW trigger that selects and activates a candidate cell as an SCell for the UE; For example, a UE may be indicated or the UE may determine a respective TA based on a corresponding TAG, such as whether a candidate NES cell (or an indicated NES cell) is collocated or non-collocated with the Cell A. Similar methods can apply to TCI state determination or indication. Alternatively, the UE may perform a random access procedure to acquire UL timing/TA or TCI state for a candidate cell, such as when the candidate cell is configured to be in a different TAG than that of the PCell, for example, for a candidate cell that is non-collocated with the PCell. For example, the UE can perform CFRA based on PDCCH order or CBRA to acquire UL timing/TA/beam/TCI state for the candidate cell. For example, the UE may perform such random access procedure based on the first NW trigger for some/all candidate cells, for example, as preparation for early timing/TA/beam/TCI acquisition, or the UE can perform such random access procedure only for the indicated cells that are to be added or activated upon/after reception of the second NW trigger.
The second NW trigger can be a MAC-CE for SCell activation, or a variant thereof (or can be a second DCI format such as a UE-specific DCI format or a GC-DCI format).

The method is different from other procedures in 5G NR for SCell addition/activation (including for triggering on-demand SSB on SCell) in that:
The candidate cells may or may not be serving cells, and can be non-serving cells that are configured as candidate cells for becoming additional/non-anchor/secondary cells.
The first NW trigger can indicate or imply that transmission/reception of on-demand discovery RS on the candidate cells stops after reception/transmission of corresponding measurement reports, possibly including UE/gNB processing time.
The second NW trigger can imply or indicate activation of periodic SSB or another on-demand RS/SSB on the selected candidate cell (that is, the new SCell);
The method can include preparation procedures, such as early UL synchronization or early TA, or identification of TCI/pathloss RS, for the configured list of candidate cells or for the one or more selected candidate cells before activation as SCell(s). For example, TA, or TCI state or pathloss RS can be based on the SSB of the Cell A or based on the on-demand RS on the candidate NES cell;
The on-demand discovery RS (DRS) can be one or more of: on-demand SSB, or can be on-demand PSS only, or on-demand SSS only, or on-demand PSS/SSS only, or other on-demand RS such as TRS, low-power sync signal (LP-SS), or DL positioning RS (PRS) or a sequence-based DL WUS.

In one implementation of the above embodiment, triggering on-demand discovery RS on the candidate cells can be based on gNB implementation, such as when the gNB determines increased load on the PCell.

In another implementation of the above embodiment, triggering on-demand discovery RS on the candidate cells can be based on a UE request, such as UL WUS, that can be configured on the PCell or can be enabled/activated by a third NW trigger, such as an L1/L2 signaling, that can also possibly be considered as a group-PDCCH order, such as a PDCCH order to trigger PRACH on a group/set of cells, or a PDCCH order to trigger PRACH on one or more cells for a group of UEs, wherein the UL WUS can be for OD-RS request on the candidate cells or can be for other purposes as subsequently described. For example, the UE may determine poor coverage conditions for Cell A, such as RSRP below a threshold (that can be indicated by Cell A), and request to find and connect to a new cell. The UE may transmit UL WUS on the PCell or on the candidate cell, for example, based on RSRP measurements of the SSB on the PCell or based on UE location, such as when the UE is within a certain distance from the NES cell. For example, in addition to other parameters such as the PCI, a configuration of NES cells can include corresponding locations. Accordingly, the first NW trigger (for initiating on-demand discovery RS on such candidate cells) can be in response to UL WUS transmission by the UEs, and a RAR in response to the UL WUS/PRACH may or may not be present.

In this disclosure, the third NW trigger can be a GC-DCI in a common search space set (based on group-common RNTI or group-configured n_CI value for the corresponding CSS set) or can be a UE-specific DCI format, or can be a cell-specific DCI format such as a DCI format associated with paging or PEI or Cell DTX-DRX, or can be an LP-WUS/sequence-based DL WUS.

In this disclosure, in order for the UE to transmit UL WUS to a candidate NES cell (or an indicated NES cell), the UE determines an RO or a PRACH preamble for such UL WUS transmission in association with the SSB on the Cell A or in association with the on-demand SSB/DRS on the candidate/indicated NES cells. For example, the UE can be predetermined or configured or indicated mappings or rules for association of on-demand SSB/DRS indexes to ROs/preambles on an NES cell (that can be similar to or different from SSB-to-RO association on Cell A). For example, the UE transmits an UL WUS to an NES cell after the UE receives on-demand SSB/DRS on/from the NES cell, including after a certain processing time. In one example, the UE can transmit the UL WUS/PRACH in any RO that is associated with an OD-SSB/OD-RS. In another example, the UE can transmit the UL WUS/PRACH in an RO, associated with the OD-SSB/OD-RS, wherein the RO is at leas N symbols or slots after a reception occasion of the OD-SSB/OD-RS. For example, the N symbols or slots can be based on a UE processing timeline that is predetermined in the specifications of system operation or can be configured by higher layers or reported as a UE capability. For example, such UL WUS may be for purposes other than OD-SSB/OD-RS trigger, as subsequently described.

In this disclosure, the UE can be configured offset values or scaling factors to apply to measurements of the on-demand SS or on-demand DRS that are reported to the gNB. Such offset or scaling values can depend, for example, on a number of occasions that the UE actually receives the OD-RS, considering for example any dropped occasions that overlap with UL symbols/slots or considering for example a typical/minimum number of occasions for measurement accuracy requirements.

In one example, the third NW trigger can be same as the first NW trigger, such that a single NW trigger is used to trigger UL WUS on candidate cells, and also to trigger on-demand RS on the candidate cells. For example, the UL WUS may not be intended to request for the on-demand discovery RS. For example, the UL WUS can serve as measurement report, such as when a UE transmits a PRACH to a certain candidate cell to indicate that the UE has determined an RSRP measurement greater than a certain threshold, or the UE is requesting for selection/activation of that candidate cell, such as for reception of cell switch command and/or activation of periodic SSB on the corresponding NES cell. For example, the first NW trigger can indicate whether or not the UE may transmit a PRACH/UL WUS to: (a) indicate a preferred candidate NES cell, in addition or instead of the CSI reporting, or (b) to provide CSI report over PRACH in addition to, or instead of, PUSCH or PUCCH, or (c) for acquisition of UL timing/TA/beam/TCI state.

For example, the second NW trigger for SCell addition or activation can be a MAC-CE command or a DCI, such as UE-specific DCI according to a USS set or a GC-DCI according to a CSS set.
cell reselection/handover/cell switch, wherein the UE switches operation (e.g., RRC connection or possibly camping in IDLE/INACTVE state) from one cell to another cell, such as from the first cell/Cell A to an NES cell that is indicated by the second NW trigger, and
cell addition/activation, such as SCell addition/activation, wherein the UE starts operation (at least for RRC_CONNECTED state, or possibly also for IDLE/INACTIVE state) operation with multiple cells, such as the first cell/Cell A as well as the NES cell indicated by the second NW trigger.

For example, the same NW trigger format can refer to a same signaling format (e.g., same DCI format or same MAC-CE), or a same RNTI for scrambling CRC of the DCI, or a same LCID for a corresponding MAC-CE can apply. For example, the second NW trigger includes a field, such as a 1-bit flag, to indicate whether the NW trigger corresponds to cell reselection/handover/cell switch or to cell addition/activation.

In another example, different NW trigger formats can apply, such as a first format (signaling, LCID, CRC) when the second NW trigger indicates cell reselection/handover/cell switch, and a second format when the second NW trigger indicates cell addition/activation. For example, the second NW trigger can include different information fields for such two cases.

In various realizations, indication of a second cell by the second NW trigger can indicate a partial or full CA operation.

In one example, the second NW trigger indicates addition or activation of a second cell, wherein the UE operates with both the first cell/Cell A and the second cell/NES cell that is indicated by the second NW trigger. For example, the UE may receive PDCCH or PDSCH or SSB or CSI-RS on either or both of the first cell and the second cell. For example, the UE may transmit PUCCH or PUSCH or PRACH or SRS on either or both of the first cell and the second cell.

In another example, the second NW trigger indicates a partial offloading from the first cell to the second cell. For example, the UE may continue to operate certain limited UE behaviors on the first cell/Cell A, while the UE starts to operate various UE behaviors on the second cell/NES Cell that is indicated by the second NW trigger. For example, the UE treats the first cell/Cell A as a coverage Cell, while the UE treats the second cell/NES cell as a capacity cell. For example, the UE continues to receive synchronization signal (or SSB) and possibly also one or more of SIB/paging/RAR on the first cell (Cell A), while the UE starts to receive various other DL signals or channels (e.g., PDCCH, PDSCH, CSI-RS) or transmit various UL signals or channels (e.g., PUCCH, PUSCH, PRACH, SRS) on the second cell (NES cell indicated by the second NW trigger).

For example, the UE can provide an implicit or explicit response upon reception of the second NW trigger (for cell addition or activation, or for cell reselection/cell switch/handover) to confirm the reception of the second NW trigger.

For example, when the second NW trigger is provided by a MAC-CE or an RRC message, the UE can provide a HARQ-ACK feedback, such as an ACK, after successful reception of a PDSCH that provides the MAC-CE or the RRC message.

For example, when the second NW trigger is provided by a DCI:
In a first example, when the second NW trigger is provided by a GC-DCI or a UE-specific DCI that also triggers a PRACH transmission on the NES cell that is indicated by the second NW trigger, the UE transmission of the PRACH on the indicated NES cell can serve as an implicit ACK or confirmation for the reception of the second NW trigger;
In a second example, when the second NW trigger is provided by a GC-DCI that does not trigger any PRACH transmission, the UE can be provided PUCCH resource to provide HARQ-ACK (e.g., ACK only or ACK/DTX) in response to the GC-DCI to confirm the reception of the second NW trigger:
   For example, the PUCCH resources can be separate for different UEs that receive the same GC-DCI, wherein the gNB can retransmit the GC-DCI (or a corresponding block of the GC-DCI) only for a UE that does not transmit a respective ACK (or transmits a DTX indication) in the respective dedicated PUCCH resource;
   For example, the PUCCH resources can be shared for different UEs that receive the same GC-DCI, wherein the gNB can transmit the GC-DCI for all such UEs when at least one UE in the UE group does report an ACK (or when at least one UE in the UE group transmits a DTX indication) in the shared PUCCH resource;
   In another example, the PUCCH resource can be shared, while different UEs are configured separate PUCCH parameters, such as different cyclic shifts or phase offsets, wherein each UE can provide a respective HARQ-ACK (e.g., ACK only or ACK/DTX) using a corresponding parameter/cyclic shift/phase offset. For example, the gNB can retransmit the GC-DCI (or a corresponding block of the GC-DCI) only for a UE that does not transmit a respective ACK (or transmits a DTX indication) in the shared PUCCH resource.
O In a third example, when the second NW trigger is provided by a UE-specific DCI that does not trigger any PRACH transmission, the UE can be provided dedicated PUCCH resources to provide HARQ-ACK (e.g., ACK only or ACK/DTX) in response to the UE-specific DCI to confirm the reception of the second NW trigger. For example, the gNB can retransmit the UE-specific DCI when the UE does not transmit a respective ACK (or transmits a DTX indication) in the respective dedicated PUCCH resource.
In the second/third examples, when applicable, the UE can receive separate GC-DCI or UE-specific DCI (before or after reception of the second NW trigger) as a PDCCH order to trigger PRACH, e.g., to acquire TA/beam/TCI/pathloss RS for a candidate NES cell, such as the second cell/NES cell that is indicated by the second NW trigger.

In the present disclosure, cell reselection for INACTIVE/IDLE mode UEs to cells without periodic SSB/DRS and with network-triggered on-demand discovery RS is provided.

In one embodiment, a UE in INACTIVE/IDLE state that camps on a first cell with an anchor signal, such as a transmission of a periodic discovery signal or periodic SSB or variants thereof, can acquire from system information (or from a last RRC configuration, such as one acquired before going to IDLE/INACTIVE state) a configuration for a list of candidate NES cells without transmission of a periodic anchor signal, such as no periodic discovery RS or no periodic SSB or variants thereof, while having configurations for properties and resources of respective on-demand discovery signals, such as on-demand SSB or TRS or variants thereof.

The UE can be informed by higher layers or using a DCI format such as a first group-common DCI or a first cell-specific DCI format, for example, a paging DCI format or a DCI format for PEI or for Cell DTX/DRX or the like, that such on-demand discovery RSs are activated on the candidate NES cells, or a subset thereof. Upon reception of such NW trigger, the UE measures the on-demand discovery RSs to obtain, for example, respective RSRPs and pathloss values, on the indicated candidate NES cells.

For example, a Cell DTX/DRX indication (or the UE DTX/DRX indication) can be provided together with an indication for triggering OD-RS/OD-SSB for measurement or activation of periodic RS/SSB on the candidate NES cells. For example, such Cell DTX/DRX indication can indicate to a UE (or a group of UEs or all UEs in a cell) that first cell/Cell A is going into Cell DTX/DRX state, such as suspending or deactivation of various signals or channels on Cell A (possibly including periodic SSB/always-on SSB/OD-SSB on Cell A), while the UE is indicated to measure SSBs/RSs (such as OD-SSBs/OD-RSs) on a number of candidate NES cells, or to perform handover to one of the number of candidate NES cells. For example, when applicable, the UE can report measurement reports to a cell from the indicated number of candidate NES cells, such as a reference cell with smallest index among the indicated number of candidate NES cells. In another example, the Cell DTX/DRX on Cell A can indicate activation of periodic SSB (P-SSB) or always-on SSB (AO-SSB) on a number of candidate NES cells. For example, performing the handover to a candidate NES cell can be based on indication by a same Cell DTX/DRX indication, or by a different/second NW trigger, or can be based on legacy UE procedures for handover for IDLE/INACTIVE UEs. For example, a Cell DTX/DRX indication can be after UE reporting measurements, when applicable, of OD-RS/OD-SSB on the indicated candidate NES cells. For example, the Cell DTX/DRX indication can provide the second NES cell. For example, the UE can receive an indication, such as a DCI, that indicates Cell DTX/DRX on Cell A, and also indicates activation of SSB, such as P-SSB/AO-SSB (or OD-RS/OD-SSB), on a second cell/NES cell, and triggers handover/mobility/cell reselection to the second cell/NES cell.

For example, at least the first NW trigger (or possibly also the second NW trigger) can be a sequence-based DL WUS (or possibly a PDCCH-based DL WUS) that the UE monitors in a low-power (LP)/energy-efficient (EE) operation state, when applicable to UEs in IDLE/INACTIVE state. For example, the UE can monitor a DL WUS on a first cell/Cell A that triggers reception and measurement of OD-SSB/OD-RS on a set or subset of candidate NES cells. For example, the UE receives a DL WUS while the UE operates in an LP/EE state, wherein the DL WUS indicates OD-SSB/OD-RS measurement on such candidate NES cells. In one example, the UE switches to the FP/HE/Active state before reception and measurement of OD-SSB/OD-RS. In another example, the UE can receive and measure such OD-RS while the UE continues to operate in LP/EE state; while the UE switches to the FP/HE/Active state for measurement reporting. In another variation, the UE can also report the OD-SSB/OD-RS measurements in the LP/EE state. For example, such DL WUS can be UE-specific or UE-group-specific or cell-specific, wherein corresponding operates states, such as LP/EE state or FP/HP/Active state can apply to a single UE or a group of UEs or commonly to UEs in a cell.

For example, the first NW trigger or the second NW trigger can be UE-common or cell-specific, and apply to different/all UEs in a cell. For example, the first NW trigger or the second NW trigger can be via a DCI or a DL WUS that have a UE-common codepoint that trigger the procedure for OD-RS/OD-SSB reception and measurement or cell reselection for any UE in the cell or for any UEs in a corresponding group of UEs that monitor a corresponding PDCCH or DL WUS.

For example, at least for IDLE/INACTIVE UEs, a UE can apply the first NW trigger or the second NW trigger when certain conditions are met.
For example, the UE attempts to receive and measure OD-RS/OD-SSB when the UE determines that RSRP measurements of SSB/RS on the first cell/Cell A are below a first threshold. For example, when such measurements are above the first threshold, the UE discards the first NW trigger and does not receive or measure (or does not expect to receive or measure) the OD-RS/OD-SSB on the candidate NES cells;
For example, the UE attempts to perform cell reselection/mobility when the UE determines that OD-RS/OD-SSB measurements are above a second threshold (same as or different from the first threshold). For example, when such measurements are below the second threshold, the UE discards the second NW trigger and does not perform (or does not expect to perform) cell reselection to the candidate NES cells; For example, the first/second threshold can be predetermined or configured by higher layers.
For example, higher layers such as SIB or RRC can configure a set of UE IDs or groups of UE IDs or a set of UE types that are allowed to receive/measure OD-RS/OD-SSB on candidate NES cells or to perform cell reselection/mobility to a candidate NES cell. For example, when a UE has a UE ID or a UE type that is not allowed for such UE procedures, the UE does not perform the corresponding procedures.

In one implementation, the NW trigger (that initiates the on-demand discovery RS on the candidate NES cells) can be based on gNB implementation, for example, based on cell load that can include one or more of: CONNECTED mode UEs in the cell; INACTIVE mode UEs that are in a RAN notification area that includes the cell; or IDLE mode UEs that are in a CN tracking area that includes the cell.

In another implementation, the NW trigger can be in response to a UE request, such as first UL WUS from one or more UEs, for example PRACH transmission from INACTIVE/IDLE UEs or possibly a RACH-based PUSCH transmission or CG PUSCH based transmission, if provided, for INACTIVE UEs. The first UL WUS transmission can be enabled or disabled by higher layers such as by system information (SIB) or by L1/L2 signaling such as a second cell-specific DCI format for paging/PEI/Cell-DTX-DRX. The UE can transmit the first UL WUS on the first/camped cell, or on a candidate NES cell at least after a corresponding discovery RS transmission. Conditions for transmission of the first UL WUS, if any, can be as previously described in the above embodiment.

For example, at least for IDLE/INACTIVE UEs, the UE can transmit an UL WUS on Cell A when the UE determines that RSRP measurements of SSB/RS on the first cell/Cell A are below a first threshold. For example, such UL WUS can be additionally conditioned on the event that the UE cannot identify other cells, such as neighbor cells, with measurements above a second threshold (same as or different from the first threshold). For example, the first/second threshold can be predetermined or configured by higher layers. For example, the UE transmits the UL WUS as the candidate NES cells are (effectively) in DTX mode without SSB/RS transmission before the first NW trigger, and the UE therefore cannot identify measurements on such cells. In another example, higher layers such as SIB or RRC can configure a set of UE IDs or groups of UE IDs or a set of UE types that are allowed to transmit UL WUS. For example, when a UE has a UE ID or a UE type that is not allowed for UL WUS transmission, the UE does not transmit (or does not expect to transmit) UL WUS.

The method can then proceed as follows:
For an INACTIVE mode UE that is provided a reporting configuration, such as SDT or SDT-like resources, for example, RACH-based PUSCH resources or CG PUSCH based resources, and has a valid TA value on the first/camped cell:
   The UE transmits a PUSCH on the camped cell that includes the measurement reports. For example, a TCI state or a pathloss reference for the PUSCH transmission can be associated with the SSB (or DRS) on Cell A or can be associated with DRS, such as the on-demand SSB/DRS, on a respective NES cell. For example, the UE can transmit such PUSCH on any candidate NES cell as configured by SIB or RRC or on any candidate NES cell with OD-SSB/RS as indicated by a DCI (as previously described) up to UE implementation, or a certain candidate NES cell that is configured/indicated for measurement reporting by the SIB/RRC/DCI, or the UE can determine a candidate NES cell for measurement reporting based on a rule, such as a candidate NES cell with closer proximity to the UE or with higher signal quality such as a largest RSRP or largest SINR or with RSRP or SINR larger than a predetermined or configured threshold.
   In response to reception of the UE measurement report, the gNB may initiate/activate a periodic discovery signal, such as periodic SSB or periodic TRS or variants thereof, or another OD-SSB/RS, on a second candidate NES cell (or generally, a number of second candidate NES cells), from the configured list of candidate NES cells. The gNB may indicate such activation to the UE using a UE-specific DCI format or using a third cell-specific DCI format, such as a third DCI format for paging/PEI/Cell-DTX-DRX, or a DCI monitored in a USS set or in CSS set such as sdt-SearchSpace or Type1-PDCCH CSS set. Alternatively, the UE may autonomously attempt corresponding receptions on the NES cell, such as autonomously searching to detect such newly activated periodic SSB/RS or OD-SSB/RS, without any indication from the NB. In another example, no periodic SSB or DRS may be activated on a respective NES cell, and the UE can use an SSB or DRS, such as a periodic SSB or DRS, on Cell A or on another associated NES cell, for UE procedures on the second candidate NES cell, such as for time/frequency synchronization, or for measurements corresponding to one or more of CSI, beam management, BFD/BFR, RLF, and so on.
   The INACITVE mode UE may (autonomously decide to) reselect to the second candidate NES cell based on procedures for cell reselection, such as UE measurements or measurement events or other mobility/cell reselection UE procedures. Such measurements for cell reselection can be based on the aforementioned measurements of the on-demand discovery RS, or based on measurements of the newly activated periodic RS/SSB/TRS, or newly activated OD-SSB/RS, or based on a combination of measurements of both the on-demand RS and the periodic RS.
For an INACTIVE mode UE that is not provided resources for such measurement reporting, or for an INACTIVE mode UE that has an invalid TA value (e.g., corresponding TA timer has expired), or for an IDLE mode UE:
   The UE does not report measurements of the on-demand discovery RS associated with candidate NES cells that are triggered/indicated by the first cell-specific DCI format;
   The UE identifies a second candidate NES cell, from the indicated candidate NES cells, for reselection based on the measurements of on-demand discovery RS, for example, using procedures for cell reselection, or up to UE implementation, or based on a rule, such as a candidate NES cell with closer proximity to the UE or with higher signal quality such as a largest RSRP or largest SINR or with RSRP or SINR larger than a predetermined or configured threshold;
   The UE transmits a second UL WUS, such as a PRACH, on the first/camped cell or on the second candidate NES cell to request for activation of periodic RS, such as periodic SSB or TRS, or another OD-SSB/RS, or to request SIB (such as SIB1 or SIB-x>1) transmission on the second candidate NES cell. The UE acquires configuration information for the UL WUS from the first/camped cell, including different UL WUS configurations (such as different ROs or different PRACH preambles or different PRACH parameters, such as different cyclic shift or different root sequences indexes, and so on) for different candidate NES cells;
   For example, the UE may not be configured with SDT-like PUSCH resources, and can be configured a set of PRACH resources (e.g., ROs, PRACH preambles, and so on) by higher layer configuration such as SIB, wherein the set of PRACH resources can be associated with the candidate NES cells. For example, upon NW trigger, the UE can transmit PRACH on one or more PRACH resources, from the set of PRACH resources, to indicate that the UE measurements corresponding to one or more NES cells are greater than a predetermined or higher layer configured threshold.
   In response to reception of the second UL WUS, the gNB may initiate/activate transmission of a periodic RS, such as periodic SSB or periodic TRS or variants thereof, or another OD-SSB/RS, or of a SIB (such as SIB1 or SIB-x>1), on the second candidate NES cell. The gNB may indicate such activation to the UEs camped on the first cell using a third cell-specific DCI format, such as a third DCI format for paging/PEI/Cell DTX-DRX or the UE may autonomously attempt corresponding receptions on the NES cell, such as autonomously searching to detect such newly activated periodic SSB/RS or OD-SSB/RS, without any indication from the NB. In another example, no periodic SSB or DRS may be activated on a respective NES cell, and the UE can use an SSB or DRS, such as a periodic SSB or DRS, on Cell A or on another associated NES cell, for UE procedures on the second candidate NES cell, such as for time/frequency synchronization, or for measurements corresponding to one or more of CSI, beam management, BFD/BFR, RLF, and so on.
   The INACTIVE/IDLE mode UE may (autonomously decide to) reselect to the second candidate NES cell based on previous measurements of the on-demand discovery RS, such as for RSRP or pathloss, or the UE may determine whether or not to (autonomously) reselect to the second candidate NES cell based on measurements of the newly activated periodic RS/SSB/TRS or the newly activated on-demand RS/SSB/TRS, or based on a combination of measurements of both the (previous or newly activated) on-demand RS and the periodic RS.

In the present disclosure, initial access to a cell without periodic SSB and with network-triggered on-demand discovery RS is provided.

In one embodiment, same methods as in the above embodiment, such as those described for IDLE mode UEs, can also apply to a UE that is performing initial access, except that the first cell is not a camped cell, is instead a cell that the UE identified during a cell search procedure, and the UE has acquired the corresponding system information. Before camping on the first cell (referred to as “cell A”), the UE measures discovery RSs associated with a list of NES cells that are provided/indicated by system information of Cell A. Transmission of discovery RSs can be periodic or indicated by a SIB on Cell A. For example, the discovery RSs on NES cell can be transmitted with a larger periodicity than on Cell A wherein the periodicity is indicated by the SIB on Cell A. The UE may decide to camp on a second NES cell, from the configured list of NES cell, based on UE implementation (e.g., based on RSRP or pathloss measurement results for RS/SSB/TRS on the second NES cell). To request transmission of RS/SSB/TRS or SIB such as SIB1 on the second NES cell, the UE can receive configuration information for UL WUS associated with the second NES cell, and can transmit an UL WUS/PRACH associated with the second NES cell on Cell A or on the second NES cell. The UE may camp on the second NES cell upon determination that periodic RS/SSB/TRS is activated on the second NES cell, such as by receiving a response to the UL WUS/PRACH transmission.

In the present disclosure, on-demand SSB/SIB1 based on an UL WUS enabled or disabled by an L1/L2 NW trigger is provided.

In one embodiment, a UE operates on a first cell (also referred to as “Cell A”) with an anchor signal, such as a periodic discovery RS or periodic SSB or periodic TRS or variants thereof, and with periodic system information, such as periodic SIB1, and the UE can receive, from SIB or common RRC of the first cell, information of a second cell (also referred to as NES cell) with an anchor signal, such as a periodic discovery RS/SSB/TRS, while the second/NES cell does not transmit system information, such as periodic SIB1. In a variation, the second/NES cell may not transmit periodic SSB/RS, and may only transmit on-demand SSB/RS, or may not transmit any SSB/RS or other anchor/reference signals. The UE can be configured, by higher layer signaling such as SIB of on the first cell/Cell A, an UL WUS such as a PRACH or a RACH-based PUSCH or a CG PUSCH to request for transmission of on-demand SIB1 on the second camped/NES cell. The configured UL WUS can be enabled or disabled by higher layer signaling such as SIB or by L1/L2 signaling on the first cell/Cell A, such as by a UE-specific DCI format or a group-common DCI (GC-DCI) format or a cell-specific DCI format, for example, a DCI format for paging or PEI or Cell DTX/DRX. The UE can transmit the UL WUS on the second camped/NES cell or on the first cell/Cell A only when the transmission of UL WUS is enabled. In other variations, SIB or common RRC can configured rules or parameters thereof to disable UL WUS transmission, wherein a UE with proximity to Cell A or an NES cell less than a threshold, or a UE with serving cell measurements such as RSRP or SINR (with or without L1/L3 filtering) larger than a threshold, is not expected to transmit UL WUS. Accordingly, UL WUS transmission that is configured by SIB or common RRC for all UEs can be disabled for certain UEs or certain groups of UEs, for example, to avoid unnecessary PRACH reception at the gNB or to reduce PRACH contention for other UEs for which UL WUS is enabled. The UE procedure may continue with reception of a response such as a RAR associated with the UL WUS transmission, and/or reception of on-demand SIB1 on the second camped/NES cell. The method can apply to:
IDLE/INACTIVE mode UEs that camp on the first cell/Cell A, and may reselect the second/NES cell; or
CONNECTED mode UEs that have RRC connection to the first cell/Cell A, and may be handed over to the second/NES cell; or
UEs that are performing initial access, and have identified both the first cell/Cell A and the second/NES cell, and aim to camp on or establish RRC connection to the second/NES cell.

The above procedures can be, for example, due to better RSRP measurements on or closer distance to the second cell than the first cell.

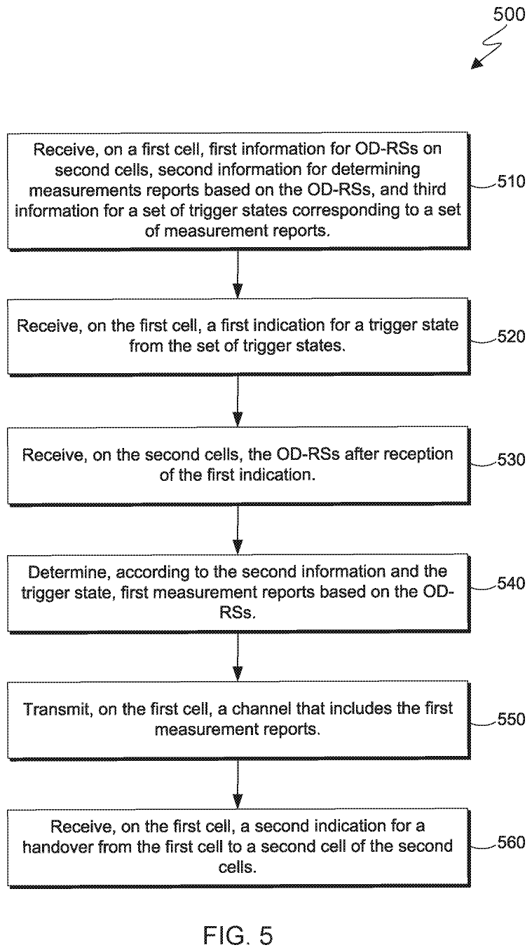

FIG. 5 illustrates an example method 500 performed by a UE according to embodiments of the present disclosure. The method 500 of FIG. 5 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 500 is for illustration only and other embodiments can be used without departing from the scope of the present disclosure.

The method 500 begins with the UE receiving, on a first cell, first information for OD-RSs on second cells, second information for determining measurements reports based on the OD-RSs, and third information for a set of trigger states corresponding to a set of measurement reports (510). In various embodiments, the second indication includes information for at least one of a cell index for the second cell, a TA for transmitting to the second cell, spatial relations for transmitting or receiving on the second cell, and parameters for transmission of a PRACH on the second cell.

The UE then receives, on the first cell, a first indication for a trigger state from the set of trigger states (520). In various embodiments, the UE receives, on the first cell, fourth information for locations of the second cells; determines a third cell, from the second cells, based on a location of the third cell, transmits, on the third cell, a PRACH, and receives, on the first cell, a RAR associated with the PRACH. The first indication is provided by the RAR. The UE then receives, on the second cells, the OD-RSs after reception of the first indication (530).

The UE then determines, according to the second information and the trigger state, first measurement reports based on the OD-RSs (540). The UE then transmits, on the first cell, a channel that includes the first measurement reports (550). In various embodiments, a measurement report, from the first measurement reports, includes a cell index for the second cell, a resource index for an OD-RS, from the OD-RSs, wherein reception of the OD-RS is on the second cell, and a RSRP for the OD-RS. In various embodiments, a measurement report, from the first measurement reports, includes a cell index for the second cell and a third indication based on a location of the UE. In various embodiments, the UE stops receipt of the OD-RSs on the second cells, after the transmission of the channel.

The UE then receives, on the first cell, a second indication for a handover from the first cell to a second cell of the second cells (560). In various embodiments, the UE receives, on the first cell, fourth information for a CG-PUSCH on the second cell and transmits the CG-PUSCH on the second cell, wherein the CG-PUSCH is activated by the second indication.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving, on a first cell:
first information for on-demand reference signals (OD-RSs) on second cells,
second information for determining measurements reports based on the OD-RSs, and
third information for a set of trigger states corresponding to a set of measurement reports;
receiving, on the first cell, a first indication for a trigger state from the set of trigger states;
receiving, on the second cells, the OD-RSs after receiving the first indication;
determining, according to the second information and the trigger state, first measurement reports based on the OD-RSs;
transmitting, on the first cell, a channel that includes the first measurement reports; and
receiving, on the first cell, a second indication for a handover from the first cell to a second cell of the second cells.

2. The method of claim 1, wherein a measurement report, from the first measurement reports, includes:
a cell index for the second cell,
a resource index for an OD-RS, from the OD-RSs, wherein receiving of the OD-RS is on the second cell, and
a reference signal received power (RSRP) for the OD-RS.

3. The method of claim 1, wherein a measurement report, from the first measurement reports, includes:
a cell index for the second cell, and
a third indication based on a location of the UE.

4. The method of claim 1, further comprising:
stopping receiving the OD-RSs on the second cells, after the transmitting of the channel.

5. The method of claim 1, further comprising:
receiving, on the first cell, fourth information for locations of the second cells;
determining a third cell, from the second cells, based on a location of the third cell;
transmitting, on the third cell, a physical random access channel (PRACH); and
receiving, on the first cell, a random access response (RAR) associated with the PRACH,
wherein the first indication is provided by the RAR.

6. The method of claim 1, wherein the second indication includes information for at least one of:
a cell index for the second cell,
a timing advance (TA) for transmitting to the second cell,
spatial relations for transmitting or receiving on the second cell, and
parameters for transmission of a physical random access channel (PRACH) on the second cell.

7. The method of claim 1, further comprising:
receiving, on the first cell, fourth information for a configured grant physical uplink shared channel (CG-PUSCH) on the second cell; and
transmitting the CG-PUSCH on the second cell, wherein the CG-PUSCH is activated by the second indication.

8. A user equipment (UE) comprising:
a transceiver configured to:
receive, on a first cell:
first information for on-demand reference signals (OD-RSs) on second cells,
second information for determining measurements reports based on the OD-RSs, and
third information for a set of trigger states corresponding to a set of measurement reports;
receive, on the first cell, a first indication for a trigger state from the set of trigger states; and
receive, on the second cells, the OD-RSs after reception of the first indication; and
a processor operably coupled to the transceiver, the processor configured to determine, according to the second information and the trigger state, first measurement reports based on the OD-RSs,
wherein the transceiver is further configured to:
transmit, on the first cell, a channel that includes the first measurement reports; and
receive, on the first cell, a second indication for a handover from the first cell to a second cell of the second cells.

9. The UE of claim 8, wherein a measurement report, from the first measurement reports, includes:
a cell index for the second cell,
a resource index for an OD-RS, from the OD-RSs, wherein reception of the OD-RS is on the second cell, and
a reference signal received power (RSRP) for the OD-RS.

10. The UE of claim 8, wherein a measurement report, from the first measurement reports, includes:
a cell index for the second cell, and
a third indication based on a location of the UE.

11. The UE of claim 8, wherein the transceiver is further configured to stop reception of the OD-RSs on the second cells, after the transmission of the channel.

12. The UE of claim 8, wherein:
the transceiver is further configured to receive, on the first cell, fourth information for locations of the second cells;
the processor is further configured to determine a third cell, from the second cells, based on a location of the third cell;
the transceiver is further configured to:
transmit, on the third cell, a physical random access channel (PRACH), and
receive, on the first cell, a random access response (RAR) associated with the PRACH; and
the first indication is provided by the RAR.

13. The UE of claim 8, wherein the second indication includes information for at least one of:
a cell index for the second cell,
a timing advance (TA) for transmitting to the second cell,
spatial relations for transmitting or receiving on the second cell, and
parameters for transmission of a physical random access channel (PRACH) on the second cell.

14. The UE of claim 8, wherein the transceiver is further configured to:
receive, on the first cell, fourth information for a configured grant physical uplink shared channel (CG-PUSCH) on the second cell, and
transmit the CG-PUSCH on the second cell, wherein the CG-PUSCH is activated by the second indication.

15. A base station comprising:
a transceiver configured to:
transmit, on a first cell:
first information for on-demand reference signals (OD-RSs) on second cells,
second information for determining measurements reports based on the OD-RSs, and
third information for a set of trigger states corresponding to a set of measurement reports;
transmit, on the first cell, a first indication for a trigger state from the set of trigger states;
transmit, on the second cells, the OD-RSs after transmission of the first indication; and
receive, on the first cell from a user equipment (UE), a channel that includes first measurement reports, wherein the first measurement reports are based on the OD-RSs; and
a processor operably coupled to the transceiver, the processor configured to determine, according to the second information and the trigger state, the first measurement reports,
wherein the transceiver is further configured to transmit, on the first cell, a second indication for a handover from the first cell to a second cell of the second cells.

16. The base station of claim 15, wherein a measurement report, from the first measurement reports, includes:
a cell index for the second cell,
a resource index for an OD-RS, from the OD-RSs, wherein transmission of the OD-RS is on the second cell, and
a reference signal received power (RSRP) for the OD-RS.

17. The base station of claim 15, wherein a measurement report, from the first measurement reports, includes:
a cell index for the second cell, and
a third indication based on a location of the UE.

18. The base station of claim 15, wherein the transceiver is further configured to stop transmission of the OD-RSs on the second cells, after the reception of the channel.

19. The base station of claim 15, wherein:
the transceiver is further configured to transmit, on the first cell, fourth information for locations of the second cells;
the processor is further configured to determine a third cell, from the second cells, based on a location of the third cell;
the transceiver is further configured to:
receive, on the third cell, a physical random access channel (PRACH), and
transmit, on the first cell, a random access response (RAR) associated with the PRACH; and
the first indication is provided by the RAR.

20. The base station of claim 15, wherein the second indication includes information for at least one of:
a cell index for the second cell,
a timing advance (TA) for transmitting to the second cell,
spatial relations for transmitting or receiving on the second cell, and
parameters for reception of a physical random access channel (PRACH) on the second cell.
